(19) United States
(12) Patent Application Publication
(10) Pub. No.: US 2007/0111251 A1
(43) Pub. Date: May 17, 2007

(54) Chemical address tags

(76) Inventors: Gustavo R. Rosania, Ann Arbor, MI (US); Kerby A. Shedden, Ann Arbor, MI (US)

Correspondence Address: MEDLEN & CARROLL, LLP, 101 HOWARD STREET, SUITE 350, SAN FRANCISCO, CA, 94105, US

(21) Appl. No.: 10/570,416

(22) PCT Filed: Sep. 2, 2004
(86) PCT No.: PCT/US04/28558

§ 371 Date: Jan. 8, 2007

Related U.S. Application Data
(60) Provisional application No. 60/499,626, filed on Sep. 2, 2003.

(51) Int. Cl. C40B 30/06; C40B 40/04

(52) U.S. Cl. 435/7.1; 546/181; 546/347

(57) ABSTRACT

The present invention provides methods and compositions related to the fields of chemoinformatics, chemogenomics, drug discovery and development, and drug targeting. In particular, the present invention provides subcellular localization signals (e.g., chemical address tags) that influence (e.g., direct) subcellular and organelle level localization of associated compounds (e.g., drugs and small molecule therapeutics, radioactive species, dyes and imagining agents, proapoptotic agents, antibiotics, etc) in target cells and tissues. The compositions of the present invention modulate the pharmacological profiles of associated compounds by influencing the compound's accumulation, or exclusion, from subcellular loci such as mitochondria, endoplasmic reticulum, cytoplasm, vesicles, granules, nuclei and nucleoli and other subcellular organelles and compartments. The present invention also provides methods for identifying chemical address tags, predicting their targeting characteristics, and for rational designing chemical libraries comprising chemical address tags.

This application claims priority to U.S. Provisional Patent Application No. 60/499,626, filed Sep. 2, 2003, which is herein incorporated by reference in its entirety.

### FIELD OF THE INVENTION

The present invention provides methods and compositions related to the fields of chemoinformatics, chemogenomics, drug discovery and development, and drug targeting. In particular, the present invention provides subcellular localization signals (e.g., chemical address tags) that influence (e.g., direct) subcellular and organelle level localization of associated compounds (e.g., drugs and small molecule therapeutics, radioactive species, dyes and imagining agents, proapoptotic agents, antibiotics, etc) in target cells and tissues. The compositions of the present invention modulate the pharmacological profiles of associated compounds by influencing the compound's accumulation, or exclusion, from subcellular loci such as mitochondria, endoplasmic reticulum, cytoplasm, vesicles, granules, nuclei and nucleoli and other subcellular organelles and compartments. The present invention also provides methods for identifying chemical address tags, predicting their targeting characteristics, and for rational designing chemical libraries comprising chemical address tags.

### BACKGROUND OF THE INVENTION

The mechanisms of drug activity and toxicity are often related to the localization and distribution of those drugs within the cells of the organism. Chemical reactions in living organisms are structurally and functionally organized down to the level of individual cells. Just as different processes in an organism are associated with specific organs, tissues, and cell types, most biochemical metabolic reactions occurring inside cells are localized to specific subcellular compartments. For example, respiratory function is associated with mitochondria; secretory function is associated with the endoplasmic reticulum and the Golgi bodies; DNA replication, transcription and RNA splicing is associated with the cell nucleus. Biochemical signal transduction mechanisms are also compartmentalized, and the localization of cellular components to localized macromolecular complexes or subcellular compartments plays an important regulatory role in many biochemical signaling mechanisms. For example, at the plasma membrane, the internalization of cell surface receptors into intracellular vesicles is a major mechanism mediating the desensitization of extracellular receptor ligands. Cell surface receptor ligation induces receptor endocytosis, which makes the receptors unresponsive to extracellular signals. (See e.g., J. Cellular Physiology, 189(3):341-55 [2001]). The activation of transcription factors and some protein kinases depends upon the translocation of these molecules into the cell's nucleus, where they are able to phosphorylate specific nuclear substrates or activate the expression of target genes. (See e.g., J. Biological Chemistry, 273:28897-28905 [1998]).

In the cytoplasm, the translocation of signaling molecules to specific signaling complexes at the intracellular leaflet of the plasma membrane is an important component of signaling pathways. In the case of the ras oncogene, for example, the shuttling of this molecule between soluble and membrane-bound forms is an important component of its signaling mechanism.

Despite the increased understanding of the localization of biochemical reactions within cells and the successful development of many potent agonists and antagonists of these reactions, traditional drug design strategies and lead optimization approaches have not addressed the problems associated with targeting drugs to particular subcellular locations. This failure is not trivial. Dangerous toxicity issues associated with many therapeutic agents are often related to the inability to target, or to exclude, the agents from certain cellular and subcellular locations. These resultant toxicity issues often limit the clinical usefulness of many otherwise potently effective drugs and therapeutic agents.

For example, Doxorubicin, a commonly prescribed anticancer drug, localizes at the subcellular level in mitochondria. Because of the high metabolic demands found in heart tissues, the concentration of mitochondrion in heart muscle far exceeds that found in other body tissues. Unfortunately, the accumulation of Doxorubicin, and other related topoisomerase inhibitors and related anthracyclines (D. Waterhouse et al., Drug Saf., 24:903-20 [2001]; A. Rahman et al., Cancer Res., 42:1817-25 [1982]; K. Jung and R. Reszka, Adv. Drug Deliv. Rev., 49:87-105 [2001] and E. Goormaghtigh et al., Biophys. Chem., 35:247-57 [1990]) in the mitochondrion of the patient's heart can lead to sever cardiotoxicity. Several commonly prescribed antiviral drugs (e.g., 2′3′-dideoxycytidine) and anti-HIV drugs (e.g., ddI, AZT, ddC) exhibit cardiotoxicity because they accumulate in the mitochondrion of the patient's heart and subsequently inhibit DNA synthesis and transcription of the mitochondrial genome. The antibiotics nalidixic acid and ciprofloxacin also show severe dose limiting cardiotoxicity. (J. W. Lawrence et al., J. Cell Biochem., 51:165-74 [1993]).

In view of the toxicity issues concomitant with many potent therapeutic agents resulting from the inability to target (e.g., direct or exclude) these agents to particular subcellular locations, what are needed are compositions and methods that alter the pharmacological profile (e.g., reducing toxicity) of associated agents by controlling the agents' cellular and subcellular distribution thus improving their biodistribution and pharmacokinetics at the organismic level.

### SUMMARY OF THE INVENTION

The present invention provides methods and compositions related to the fields of chemoinformatics, chemogenomics, drug discovery and development, and drug targeting. In particular, the present invention provides subcellular localization signals (e.g., chemical address tags) that influence (e.g., direct) subcellular and organelle level localization of associated compounds (e.g., drugs and small molecule therapeutics, radioactive species, dyes and imagining agents, proapoptotic agents, antibiotics, etc) in target cells and tissues. The compositions of the present invention modulate the pharmacological profiles of associated compounds by influencing the compound's accumulation, or exclusion, from subcellular loci such as mitochondria, endoplasmic reticulum, cytoplasm, vesicles, granules, nuclei and nucleoli and other subcellular organelles and compartments. The present invention also provides methods for identifying chemical address tags, predicting their targeting characteristics, and for rational designing chemical libraries comprising chemical address tags.

In preferred embodiments, the present invention provides chemical agents, chemical address tags, or drug delivery compositions (e.g., conjugates comprising chemical address tag(s), or a portion thereof, and a therapeutic agent(s)) that target and deliver (e.g., mediate the distribution of) therapeutic (e.g., anticancer) agents to targeted cells, tissues (e.g., cancer and tumor cells), and intracellular locations therein. In particularly preferred embodiments, the compositions of the present invention supertarget selected subcellular locations including, but limited to, mitochondria, endoplasmic reticulum, cytoplasm, vesicles, granules, nuclei and nucleoli, microsomes, synthetic organelles (e.g., micelles, liposomes, and the like) and other subcellular organelles and compartments.

In some embodiments, the present invention provides compositions, and methods of screening, designing, and evaluating compositions, that target (e.g., influence the distribution of associated molecules or the compositions themselves in, or away from specific subcellular (e.g., organelles and synthetic organelles [e.g., liposomes, micelles etc]) or cellular locations and moieties including, but not limited to, mitochondria, peroxisomes, Golgi bodies, nuclei, nucleoli, snrps, endosomes, lysosomes, exosomes, secretory vesicles, endoplasmic reticulum, phagosomes, plasma membrane, nuclear envelope, inner mitochondrial matrix, inner mitochondrial membrane, intermembrane spaces, outer mitochondrial membrane, cytoskeletal elements (e.g., microfilaments, microtubules, intermediate filaments), filopodia, ruffles, lamellipodia, sarcomeres, focal contacts, podosomes and other cellular structures important for cell motility and adhesion, parts of specific cells such as axons, dendrites, neuronal cell bodies, various types of cells types like endothelial cells, fibroblasts, epithelial cells, neurons, macrophages, T cells B cells, platelets, portions of disrupted cells (e.g., microsomes), and the like.

In some embodiments, administrations of the present compositions provide effective methods of treating (e.g., ameliorating) or arresting (e.g., prophylaxis) disease states (e.g., cancer) in a subject. In some embodiments, the drug transported by the present compositions is gelonin. Additional embodiments of the present invention provide compositions and methods for targeting and delivering many other therapeutic agents and molecules including, but not limited to: agents that induce apoptosis (e.g., Geranylgeraniol [3,7,11,15-tetramethyl-2,6,10,14-hexadecatraen-1-ol], pro-apoptotic Bcl-2 family proteins including Bax, Bak, Bid, and Bad); polynucleotides (e.g., DNA, RNA, ribozymes, RNAse, siRNAs, etc); polypeptides (e.g., enzymes); photodynamic compounds (e.g. Photofrin (II), ruthenium red compounds [e.g., Ru-diphenyl-phenanthroline and Tris(1-10-phenanthroline)ruthenium(II) chloride], tin ethyl etiopurpurin, protoporphyrin IX, chloroaluminum phthalocyanine, tetra(M-hydroxyphenyl)chlorin)); radiodynamic (i.e., scintillating) compounds (e.g., NaI-125, 2,5-diphenyloxazole (PPO); 2-(4-biphenyl)-6-phenylbenzoxazole; 2,5-bis-(5′-tert-butylbenzoxazoyl-[2′])thiophene; 2-(4-t-butylphenyl)-5-(4-biphenylyl)-1,3,4-oxadiazole; 1,6-diphenyl-1,3,5-hexatriene; trans-p,p′-diphenylstilbene; 2-(1-naphthyl)-5-phenyloxazole; 2-phenyl-5-(4-biphenylyl)-1,3,4-oxadiazole; p-terphenyl; and 1,1,4,4-tetraphenyl-1,3-butadiene); radioactive elements or compounds that emits gamma rays (e.g., ¹¹¹In-oxine, ⁵⁹Fe, ⁶⁷Cu, ¹²⁵I, ⁹⁹Te (Technetium), and ⁵¹Cr); radioactive elements or compounds that emit beta particles (e.g., ³²P, ³H, ³⁵S, ¹⁴C,); drugs; biological mimetics; alkaloids; alkylating agents; antitumor antibiotics; antimetabolites; hormones; platinum compounds; monoclonal antibodies conjugated to anticancer drugs, toxins or defensins, radionuclides; biological response modifiers (e.g., interferons [e.g., IFN-α, etc], and interleukins [e.g., IL-2]); adoptive immunotherapy agents; hematopoietic growth factors; agents that induce tumor cell differentiation (e.g., all-trans-retinoic acid, etc); gene therapy reagents (e.g., sense and antisense therapy reagents and nucleotides, siRNA); tumor vaccines; and angiogenesis inhibitors and the like. Those skilled in the art are aware of numerous additional drugs and therapeutic agents suitable for delivery by the compositions of the present invention.

In certain embodiments, the chemical address tags comprise antioxidant (e.g., bioprotectant) molecules (e.g., vitamin C) to counteract oxidizing agents (e.g., radioactive elements) associated with the chemical address tags to prevent oxidation of the composition. Suitable antioxidants or antifade agents include, but are not limited to, N-acetyl cysteine, gluthathione, ascorbic acid, vitamins C and E, beta-carotene and its derivatives and other dietary antioxidants, other sulfhydryl containing compounds, phenylalanine, azide, p-phenylenediamine, n-propylgallate, diazabicyclo[2,2,2]octane, commercial reagents such as Slowfade and Prolong (Molecular Probes, Eugene Oreg.), and antioxidants broadly defined as a compound that can be administered to the body for the purpose of quenching oxygen free radicals (e.g., peroxide, superoxide, singlet oxygen, peroxynitrite, nitric oxide, catalytyic antioxidants [e.g., salen-manganese porphyrin], prodrug forms of antioxidants [e.g., amiphostine], and the like).

In other embodiments, the compositions and methods of the present invention localize (e.g., target to specific cellular or intracellular locations) bioprotectants (e.g., antioxidant molecules).

In still other embodiments, the compositions and methods of the present invention are used to create less toxic drug formulations based on supertargeted bioprotectants conjugated to drugs, prodrugs, and therapeutic agents, and the like, having various toxicity issues. The present invention contemplates that preferred embodiments, decrease toxicity (e.g., organelle-specific) issues associated with the administration of known toxicants.

In preferred embodiments, anticancer agents associated with the chemical address tags comprise agents that induce or stimulate apoptosis including, but not limited to: kinase inhibitors (e.g., epidermal growth factor receptor kinase inhibitor [EGFR]); vascular growth factor receptor kinase inhibitor [VGFR]; fibroblast growth factor receptor kinase inhibitor [FGFR]; platelet-derived growth factor receptor kinase inhibitor [PGFR]; and Bcr-Abl kinase inhibitors such as STI-571, Gleevec, and Glivec); antisense molecules; antibodies (e.g., Herceptin and Rituxan); anti-estrogens (e.g., Raloxifene and Tamoxifen); anti-androgens (e.g., flutamide, bicalutamide, finasteride, aminoglutethamide, ketoconazole, and corticosteroids); cyclooxygenase 2 (COX-2) inhibitors (e.g., Celecoxib, Meloxicam, NS-398); non-steroidal anti-inflammatory drugs (NSAIDs); and chemotherapeutic drugs (e.g., irinotecan [Camptosar], CPT-11, fludarabine [Fludara], dacarbazine [DTIC], dexamethasone, mitoxantrone, Mylotarg, VP-16, cisplatinum, 5-FU, Doxrubicin, Taxotere or taxol); cellular signaling molecules; ceramides and cytokines; and staurosprine and the like.

In some preferred embodiments, various compositions of the present invention provide treatments for a number of conditions including, but not limited to, breast cancer, prostate cancer, lung cancer, lymphomas, skin cancer, pancreatic cancer, colon cancer, melanoma, ovarian cancer, brain cancer, head and neck cancer, liver cancer, bladder cancer, non-small lung cancer, cervical carcinoma, leukemia, neuroblastoma and glioblastoma, and T and B cell mediated autoimmune diseases and the like.

In some preferred embodiments, the chemical address tags of the present invention are optimized to target and deliver to cancer cells anticancer drugs/agents including, but not limited to: altretamine; asparaginase; bleomycin; capecitabine; carboplatin; carmustine; BCNU; cladribine; cisplatin; cyclophosphamide; cytarabine; dacarbazine; dactinomycin; actinomycin D; Docetaxel; doxorubicin; imatinib; etoposide; VP-16; fludarabine; fluorouracil; 5-FU; gemcitabine; hydroxyurea; idarubicin; ifosfamide; irinotecan; CPT-11; methotrexate; mitomycin; mitomycin-C; mitotane; mitoxantrone; paclitaxel; topotecan; vinblastine; vincristine; and vinorelbine.

In still other embodiments, the targeted cells or tissues are cancer cells, for example, topical cells (e.g., malignant melanoma cells and basal cell carcinomas), ductal cells (e.g., mammary ductal adenocarcinoma cell and bowel cancer cells), and deep tissue cells (e.g., hepatocellular carcinoma cells, CNS primary lymphoma cells, and glioma cells).

In some preferred embodiments, the chemical address tags of the present invention are optimized to target and deliver antiretroviral drugs or agents to cells that inhibit the growth and replication of the human immunodeficiency virus (HIV). Exemplary drugs and agents in this regard include, but are not limited to: nucleotide analogue reverse transcriptase inhibitors (e.g., Tenofovir Disoproxil Fumarate [DF]); nucleoside analogue reverse transcriptase inhibitors (NRTIs) (e.g., zidovudine, lamivudine, abacavir, zalcitabine, didanosine, stavudine, zidovudine+lamivudine, and abacavir+zidovudine+lamivudine); non-nucleoside reverse transcriptase inhibitors (NNRTIs) (e.g., nevirapine, delavirdine, and efavirenz); protease inhibitors (PIs) (e.g., saquinavir [SQV (HGC)], saquinavir [SQV (SGC)], ritonavir, indinavir, nelfinavir, amprenavir, and lopinavir+ritonavir); and combinations thereof (e.g., highly active anti-retroviral therapy [HAART]).

In some preferred embodiments, the chemical address tags of the present invention are linked via chemical interactions to one or more clinically approved drugs (e.g., Doxorubicin, Cisplatin, antiviral nucleosides [e.g., Zidovudine], and quinolone antibiotics [e.g., ciprofloxacin]).

In still other embodiments, the chemical address tags of the present invention provides are optimized to target and deliver drugs and other therapeutic agents to mitochondria for the treatment of number of disease and developmental problems associated with mitochondrial pathologies including, but not limited to, those of the brain (e.g., developmental delays, mental retardation, dementia, seizures, neuro-psychiatric disturbances, atypical cerebral palsy, migraines, and strokes); nerves (e.g. weakness [which may be intermittent], neuropathic pain, absent reflexes, dysautonomia, gastrointestinal problems [e.g., reflux, dysmotility, diarrhea, irritable bowel syndrome, constipation, and pseudo-obstruction], fainting, and absent or excessive sweating resulting in temperature regulation problems); muscles (e.g., weakness, hypotonia, cramping, and muscle pain); kidneys (e.g., renal tubular acidosis or wasting resulting in loss of protein, magnesium, phosphorous, calcium and other electrolytes); heart (e.g., cardiac conduction defects [heart blocks], and cardiomyopathy; liver (e.g., hypoglycemia and liver failure); eyes (e.g. vision loss and blindness); ears (e.g., hearing loss and deafness); pancreas and other glands (e.g., diabetes and exocrine pancreatic failure, parathyroid failure); and systemic issues (e.g., failure to gain weight, short stature, fatigue, respiratory problems including intermittent air hunger, vomiting, etc).

In still other embodiments, the chemical address tags of the present invention are optimized to target and deliver drugs and other therapeutic agents to cells for the treatment of diabetes (e.g., types I and II) or the symptoms that commonly arise from this disease. In this regard, certain embodiments of the present invention target and deliver the following exemplary diabetes treatments: insulin (e.g., rapid acting insulin [e.g. insulin lispro]; short acting insulin [e.g., insulin regular]; intermediate acting [e.g., insulin isophane]; long acting insulin [e.g., insulin zinc extended]; very long acting insulin [e.g., insulin glargine]); sulfonylureas (e.g., first generation sulfonylureas [e.g., acetohexamide, chlorpropamide, tolazamide, and tolbutamide]; second generation sulfonylureas [e.g., glimepiride, gipizide, glyburide]); biguanides (e.g., metformin); sulfonylurea/biguanide combination; α-glucosidase inhibitors (e.g., acarabose, and miglitol); thiazolidinediones (glitazones) (e.g., pioglitazone, rosiglitazone); and meglitinides (e.g., repaglinide, nateglinide).

In other embodiments, the chemical address tags of the present invention are optimized to target and deliver drugs and other therapeutic agents for the treatment of psychological health issues including, but not limited to, depression (e.g., minor and depressive illness). Depression is the most common mental health problem in the US. While the exact cause of depression remains unknown, depression is thought to caused by a malfunction of brain neurotransmitters. Antidepressants are often prescribed to treat depressive illnesses. The most common prescribed type of antidepressants are the selective serotonin reuptake inhibitors (SSRIs) (e.g., Prozac, Paxil, Zoloft, Celexa, Serzone, Remeron, and Effexor).

In some embodiments, the biological includes a target epitope. The range of target epitopes is practically unlimited. Indeed, any inter- or intra-biological feature (e.g., glycoprotein) of a cell or tissue is encompassed within the present invention. For example, in some embodiments, target epitopes comprise cell surface proteins, cell surface receptors, cell surface polysaccharides, extracellular matrix proteins, a viral coat protein, a bacterial cell wall protein, a viral or bacterial polysaccharide, intracellular proteins, or intracellular nucleic acids. In still other embodiments, the drug delivery composition is targeted via a signal peptide to a particular cellular organelle (e.g., mitochondria or the nucleus).

In some embodiments, the chemical address tags of the present invention are used to treat (e.g., mediate the translocation of drugs or prodrugs into) diseased cells and tissues. In this regard, various diseases are amenable to treatment using the present compositions and methods. An exemplary list of diseases includes: breast cancer; prostate cancer; lung cancer; lymphomas; skin cancer; pancreatic cancer; colon cancer; melanoma; ovarian cancer; brain cancer; head and neck cancer; liver cancer; bladder cancer; non-small lung cancer; cervical carcinoma; leukemia; neuroblastoma and glioblastoma; T and B cell mediated autoimmune diseases; inflammatory diseases; infections; hyperproliferative diseases; AIDS; degenerative conditions, vascular diseases, and the like. In some embodiments, the cancer cells are metastatic.

Still other specific compositions and methods are directed to treating cancer in a subject comprising: administering to a patient having cancer, wherein the cancer is characterized by resistance to cancer therapies (e.g., chemoresistant, radiation resistant, hormone resistant, and the like), an effective amount an anticancer drug or prodrug attached to at least a portion of a chemical address tag.

In some embodiments, the present invention provides chemical address tags and methods suitable for treating infections or for destroying infectious agents. In this regard, the present invention provides embodiments for treating infections caused by viruses, bacteria, fungi, mycoplasma, and the like. The present invention in not limited, however, to treating any particular infection or the destruction of any particular infectious agent. For example, in some embodiments, the present invention provides compositions and methods directed to treating or ameliorating diseases caused by the following exemplary pathogens: Bartonella henselae, Borrelia burgdorferi, Campylobacter jejuni, Campylobacter fetus, Chlamydia trachomatis, Chlamydia pneumoniae, Chlamydia psittaci, Simkania negevensis, Escherichia coli (e.g., O157:H7 and K88), Ehrlichia chafeensis, Clostridium botulinum, Clostridium perfringens, Clostridium tetani, Enterococcus faecalis, Haemophilius influenzae, Haemophilius ducreyi, Coccidioides immitis, Bordetella pertussis, Coxiella burnetii, Ureaplasma urealyticum, Mycoplasma genitalium, Trichomatis vaginalis, Helicobacter pylori, Helicobacter hepaticus, Legionella pneumophila, Mycobacterium tuberculosis, Mycobacterium bovis, Mycobacterium africanum, Mycobacterium leprae, Mycobacterium asiaticum, Mycobacterium avium, Mycobacterium celatum, Mycobacterium celonae, Mycobacterium fortuitum, Mycobacterium genavense, Mycobacterium haemophilum, Mycobacterium intracellulare, Mycobacterium kansasii, Mycobacterium malmoense, Mycobacterium marinum, Mycobacterium scrofulaceum, Mycobacterium simiae, Mycobacterium szulgai, Mycobacterium ulcerans, Mycobacterium xenopi, Corynebacterium diptheriae, Rhodococcus equi, Rickettsia aeschlimannii, Rickettsia africae, Rickettsia conorii, Arcanobacterium haemolyticum, Bacillus anthracis, Bacillus cereus, Lysteria monocytogenes, Yersinia pestis, Yersinia enterocolitica, Shigella dysenteriae, Neisseria meningitides, Neisseria gonorrhoeae, Streptococcus bovis, Streptococcus hemolyticus, Streptococcus mutans, Streptococcus pyogenes, Streptococcus pneumoniae, Staphylococcus aureus, Staphylococcus epidermidis, Staphylococcus pneumoniae, Staphylococcus saprophyticus, Vibrio cholerae, Vibrio parahaemolyticus, Salmonella typhi, Salmonella paratyphi, Salmonella enteritidis, Treponema pallidum, Human rhinovirus, Human coronavirus, Dengue virus, Filoviruses (e.g., Marburg and Ebola viruses), Hantavirus, Rift Valley virus, Hepatitis B, C, and E, Human Immunodeficiency Virus (e.g., HIV-1, HIV-2), HHV-8, Human papillomavirus, Herpes virus (e.g., HV-I and HV-II), Human T-cell lymphotrophic viruses (e.g., HTLV-I and HTLV-II), Bovine leukemia virus, Influenza virus, Guanarito virus, Lassa virus, Measles virus, Rubella virus, Mumps virus, Chickenpox (Varicella virus), Monkey pox, Epstein Bahr virus, Norwalk (and Norwalk-like) viruses, Rotavirus, Parvovirus B19, Hantaan virus, Sin Nombre virus, Venezuelan equine encephalitis, Sabia virus, West Nile virus, Yellow Fever virus, causative agents of transmissible spongiform encephalopathies, Creutzfeldt-Jakob disease agent, variant Creutzfeldt-Jakob disease agent, Candida, Ccryptoccus, Cryptosporidum, Giardia lamblia, Microsporidia, Plasmodium vivax, Pneumocystis carinii, Toxoplasma gondii, Trichophyton mentagrophytes, Enterocytozoon bieneusi, Cyclospora cayetanensis, Encephalitozoon hellem, Encephalitozoon cuniculi, among other viruses, bacteria, archaea, protozoa, fungi and the like).

Some other embodiments the present invention provides pharmaceutical compositions comprising: a chemical address tag, or portion thereof, as described herein; or instructions for administering a drug delivery composition to a subject, the subject characterized as having a disease state (e.g., cancer). In preferred embodiments, the instructions meet US, Food and Drug Administration (U.S.F.D.A.), or similar international agency, rules, regulations, and suggestions for the provision of therapeutic compounds, or those of similar international agencies.

Some embodiments of the present invention provide methods of determining the contribution of different chemical groups to the subcellular localization of a diverse collection of compounds to determine whether those different chemical groups behave as chemical address tags, to determine the subcellular distribution of compounds, and to measure their relative contribution to subcellular localization, by: providing a collection of compounds comprised of at least one chemical bond (or some other reference point) around which two or more different chemical building blocks (e.g., an Aₙ+Bₙ . . . +Nₙ) (or chemical properties or characteristics associated with the individual building blocks) can be identified; contacting the collection of compounds to cells under conditions such that the intracellular localization of compounds can be identified, or contacting the collection of compounds to isolated organelles (or disrupted portions of organelles and synthetic organelles) such that compounds that bind to those isolated organelles can be identified; performing additive decomposition or factorial regression analysis on the localization results obtained with each and all the individual compounds across the entire collection of compounds, so as to determine the relative contribution of each of the individual building blocks to the localization of each and all the compounds; using the relative contribution values obtain for each of the chemical building blocks so as to predict the subcellular distribution of a compound containing any of the individual building blocks (or associated chemical properties or characteristics associated with those blocks), but not used to arrive at the contribution values, as in the statistical cross-validation or “leave-one-out” method; and assessing the ability of the individual building block to act as a chemical address tag determining the localization of a compound to or from a certain cellular localization, according to the ability to predict the subcellular distribution of a compound containing any of the individual building block, but not used to arrive at the contribution values, as in the “statistical cross-correlation” or the “leave-one-out” method.

In still other embodiments, the methods of the present invention are optimized for determining the distribution or localization properties of various molecules including, but not limited to, chemical agents, small molecules, proteins, peptides, protein complexes, nucleic acids, antibodies, chemical address tags, and the like, to a variety of target sites and locations (e.g., to proteins, peptides, protein complexes, membranes, organelles, including synthetic organelles and portions of disrupted cells, subcellular compartments, cellular compartments, extracellular locations, intercellular locations, specific organ and organ systems, or any other identifiable site within subject organism (e.g., bacteria [e.g., Aquifex, OP2, Thermodesulfobacterium, Thermotoga, green nonsulfur bacteria, Deinococcus/Thermus, Spirochetes, green sulfur bacteria, Bacteroides-Flavobacteria, Planctomyces/Pirella, Chlamydia, Cynobacteria, gram-positive bacteria, gram-negative bacteria, Nitrospira, Proteobacteria], Archea [e.g., Methanopyrus, Thermococcus/Pyrococcus, Methanococcus, Methanothermus, Methanobacterium, Archaeoglobus, Thermoplasma, Methanospirillum, Methanosarcina, Halophilic methanogen, Natronococcus, Halococcus, Halobacterium, marine Eutyarchaeota, marine Crenarchaeota, Pyrodictium, Thermoproteus, Desulfurococcus, Sulfolobus, Korarchaeota], Eukarya [e.g., Diplomonads, Microsporidia, Trichomonoads, flagellates, cilates, dinoflagellates, fungi, red algae, green algae, plants, animals, Oomycetes, diatoms, brown algae]), or in in vivo or in vitro cells and portions thereof.

In some embodiments, various moieties and compositions such as small molecules, proteins, peptides, nucleic acids, antibodies, and the like, have at least a portion of the biological or pharmacological properties and functions of chemical address tags.

In some embodiments, the present compositions and methods are optimized for use in plants, plant tissues, and plant cells, both in vivo and in vitro. Indeed, in some embodiments, the present invention provides compositions, methods of screening libraries of compositions, methods of designing and testing compositions optimized to promote or inhibit the distribution of target (or payload molecules) in a variety of plant tissues (e.g., epidermis, peridermis, xylem, phloem, parenchyma, collenchyma, and sclerenchyma), specific compounds, organelles (including synthetic organelles, such as liposomes, and micelles, and portions of disrupted cellular bodies and organelles), intracellular features, regions, and storage sites (e.g., lipid globules, mitochondria, nucleus, nuclear envelope, nucleolus, ribosomes, plastids [e.g., chloroplasts, chromoplasts, leucoplasts, amyloplasts, proteinoplasts, elaioplasts, tonoplasts, and the like], vacuoles, cell walls, granules, microbodies, microtubules, paramural bodies [e.g., plasmalemmasomes, and lomasomes, and the like], dictyosomes, plasmalemma, ergastic substances, tannis, proteins [aleurone grains], fats, oils, waxes, nucleic acids, and crystals, and the like).

In some embodiments, the methods of the present invention are optimized to determine or predict the physical properties (e.g., solubility, lipophilicity, membrane permeability, stability, chemical reactivity, redox properties, etc) of chemical address tags and other molecules. In some other embodiments, the methods of the present invention are optimized to determine or predict the pharmaceutical properties (e.g., pharmacodynamics, pharmacodynamics, absorption, distribution, metabolism, excretion, toxicity and efficacy, etc) of chemical address tags and other molecules. Additional methods of the present invention are optimized to determine or predict the toxicological properties (e.g., mutagens, alkylating agents, necrotic agents, apoptosis-inducing agents, etc) of chemical address tags and other molecules. Other methods of the present invention are optimized to determine or predict the mechanisms of action (e.g., receptor agonists, receptor antagonists, enzyme inhibitors, protein ligands, DNA ligands, RNA aptamers, gene expression inhibitors, transcription inhibitors, translation inhibitors, nutrients, antioxidants, enzyme cofactors, etc) of chemical address tags and other molecules.

In still some other embodiments, the methods of the present invention are optimized to determine/predict therapeutic applications (e.g., cardiovascular, neurological, immunological, oncological, dermatological, antiviral, antibacterial, antiparasitic, antifungal, etc) of chemical address tags and other molecules (e.g., drugs, prodrugs, and the like). Yet other embodiments of the present invention provide methods optimized to determine/predict the suitability of chemical address tags and other molecules for diagnostic applications (e.g., use as NMR probes, PET probes, radiological probes, optical probes, etc).

In particularly preferred embodiments, the methods of the present invention measure (determine) the distribution of target compounds (e.g., chemical agents, chemical address tags and portions thereof, or other molecules of interest) in one ore more intracellular locations including, but not limited to organelles (including, but not limited to, portions of disrupted cellular features [e.g., microsomes], and synthetic organelles), intercellular locations, cells (e.g., Bacteria, Archaea, Eukarya cells), tissues, and organs, in vivo or in vitro.

In one preferred embodiment, the present invention provides methods of determining the contribution of chemical groups in a library of chemical agents to determine the subcellular distribution of said chemical agents, comprising: providing a library of chemical agents said library comprising a first class of chemical moieties and a second class of chemical moieties; contacting said library to cells under conditions such that said chemical agents of said library localize in said cells; determining the localization of said chemical agents in said cells to generate localization data; performing statistical analysis on the determined localization data to generate predictor values for each moiety in said first and said second classes of chemical moieties; and using said predictor values for said first and second class of chemical moieties to predict the contribution of said chemical moieties to the subcellular distribution of said chemical agents.

The present invention is not limited to providing predictive (or determinative) measurements of the contribution of different classes of chemical moieties to the localization of a chemical agent (e.g., chemical address tag). Indeed, in other embodiments, the present invention provides methods for predicting (or determining) one or more characteristics of first, second, third, . . . chemical moieties on chemical agents, including, but not limited to, chemical address tags. For example, in one embodiment, the present invention provides methods of determining the contribution of chemical groups in a library of chemical agents to determine combination of a first and a second characteristic of said chemical agents, comprising: providing a library of chemical agents said library comprising a first class of chemical moieties and a second class of chemical moieties; contacting said library to cells under conditions such that said chemical agents of said library localize in said cells; generating a first data set corresponding to said first characteristic of said chemical agents in said cells; d. performing statistical analysis on said first data set to generate a first predictor values set for each moiety in said first and said second classes of chemical moieties; generating a second data set corresponding to said second characteristic of said chemical agents in said cells; performing statistical analysis on said second data set to generate a second predictor values set for each moiety in said first and said second classes of chemical moieties; and using said predictor value sets for said first and second class of chemical moieties to predict the contribution of said chemical moieties to the characteristics of said chemical agents.

In some embodiments, the first biological property is fluorescence. In some second biological property is localization. The present invention is not limited to methods of predicting (or determining) first characteristics and second characteristics comprising fluorescence and localization, respectively. Indeed, the present invention also provides methods wherein said first characteristic is selected from the group consisting of biological activities, toxicological properties, pharmacological properties, pharmacokinetic properties, bioavailability properties, biodistribution, chemical reactivity properties, and metabolic properties. Additional embodiments of the present provide methods wherein said second characteristic is selected from the group consisting of biological activities, toxicological properties, pharmacological properties, pharmacokinetic properties, bioavailability properties, biodistribution, chemical reactivity properties, and metabolic properties.

In some embodiments, the present invention provides methods of determining the contribution of chemical groups in a library of chemical agents to determine the subcellular distribution of the chemical agent, comprising: providing a library of chemical agents the library comprising a first class of chemical moieties and a second class of chemical moieties; contacting the library to cells under conditions such that the chemical agents of the library localize in the cells; determining the localization of the chemical agents in the cells to generate localization data; performing additive decomposition on the determined localization data to generate predictor values for each moiety in the first and the second classes of chemical moieties; using the predictor values for the first and second class of chemical moieties to determine the contribution of the chemical moieties to the subcellular distribution of the chemical agents. In some preferred embodiments, the chemical agents of the library localize in one or more organelles (including synthetic organelles, and portion of organelles and other cellular and subcellular features of disrupted cells) of the cells.

In preferred embodiments, the chemical agents are therapeutic. In other preferred embodiments, the chemical agents are linked to a therapeutic molecule (e.g., drugs, pro-drugs [e.g., anticancer drugs such as Doxorubicin, and small molecule therapeutics). The present invention is not limited however to any particular payload, therapeutic molecules, drugs, prodrugs, imaging agents, and the like. In some embodiments, the therapeutic molecules comprise proapoptotic agents. In other embodiments the therapeutic molecules bind proteins. In still other embodiments, the therapeutic molecules bind intracellular proteins. In some additional embodiments, the therapeutic molecules bind nucleic acids. While in other embodiments, the therapeutic molecules bind lipids. In yet other embodiments, the therapeutic molecules bind carbohydrates.

In some embodiments, the methods of the present invention are directed to combinatorial libraries of chemical agents.

In still further embodiments, the present invention provides methods directed determining the contribution of chemical groups in a library of chemical agents to determine the subcellular distribution of the chemical agent, comprising: providing a library of chemical agents the library comprising a first class of chemical moieties and a second class of chemical moieties; contacting the library to isolated organelles under conditions such that the chemical agents of the library localize to the isolated organelles; determining the localization of the chemical agents in the cells to generate localization data; performing additive decomposition on the determined localization data to generate predictor values for each moiety in the first and the second classes of chemical moieties; and using the predictor values for the first and second class of chemical moieties to determine the contribution of the chemical groups of the chemical moieties to the subcellular distribution of the chemical agents.

Additional embodiments of the present invention are directed to methods of determining a contribution of chemical groups in a library of chemical agents to determine a subcellular distribution of the chemical agent, comprising: providing a library of chemical agents the library comprising a first class of chemical moieties and a second class of chemical moieties; contacting the library to cells under conditions such that the chemical agents of the library localize in the cells; determining the localization of the chemical agents in the cells to generate localization data; performing factorial regression on the determined localization data to generate predictor values for each moiety in the first and the second classes of chemical moieties; and using the predictor values for the first and second class of chemical moieties to determine the contribution of the chemical groups of the chemical moieties to the subcellular distribution of the chemical agents.

Still further embodiments provide methods determining the contribution of chemical properties associated with chemical groups in a library of chemical agents to determine the subcellular distribution of the chemical agent, comprising: providing a library of chemical agents the library comprising a first class of chemical moieties and a second class of chemical moieties; contacting the library to cells under conditions such that the chemical agents of the library localize in the cells; determining the localization of the chemical agents in the cells to generate localization data; performing additive decomposition on the determined localization data to generate predictor values for each moiety in the first and the second classes of chemical moieties; and using the predictor values for the first and second class of chemical moieties to determine the contribution of the chemical properties of the chemical groups of the chemical moieties to the subcellular distribution of the chemical agents.

Still further embodiments, provide libraries of chemical agents (and chemical address tags) wherein the subcellular distribution of the chemical agents is determined by the method of the present invention. In some of these embodiments, the chemical agents are linked to payload molecules (e.g., therapeutic molecules).

Yet another embodiment of the present invention provides a method of determining the contribution of chemical groups in a library of chemical agents to determine the subcellular distribution of the chemical agent, comprising: providing a library of chemical agents the library comprising a first class of chemical moieties and a second class of chemical moieties; contacting the library to cells under conditions such that the chemical agents of the library localize in the cells; determining the affects of the chemical agents on biological activities in the cells to generate biological activities data; performing additive decomposition on the biological activities data to generate predictor values for each moiety in the first and the second classes of chemical moieties; and using the predictor values for the first and second class of chemical moieties to determine the contribution of the chemical moieties to the subcellular distribution of the chemical agents.

Some embodiments provide methods of determining the contribution of chemical groups in a library of chemical agents to determine the subcellular distribution of the chemical agent, comprising: providing a library of chemical agents the library comprising a first class of chemical moieties and a second class of chemical moieties; contacting the library to cells under conditions such that the chemical agents of the library localize in the cells; determining the toxicological properties of the chemical agents in the cells to generate toxicological properties data; performing additive decomposition on the toxicological properties data to generate predictor values for each moiety in the first and the second classes of chemical moieties; and using the predictor values for the first and second class of chemical moieties to determine the contribution of the chemical moieties to the subcellular distribution of the chemical agents.

Additional embodiments of the present invention provide methods of determining the contribution of chemical groups in a library of chemical agents to determine the subcellular distribution of the chemical agent, comprising: providing a library of chemical agents the library comprising a first class of chemical moieties and a second class of chemical moieties; contacting the library to cells under conditions such that the chemical agents of the library localize in the cells; determining the pharmacological properties of the chemical agents in the cells to generate pharmacological properties data; performing additive decomposition on the pharmacological properties data to generate predictor values for each moiety in the first and the second classes of chemical moieties; and using the predictor values for the first and second class of chemical moieties to determine the contribution of the chemical moieties to the subcellular distribution of the chemical agents.

Other embodiments are directed to providing methods of determining the contribution of chemical groups in a library of chemical agents to determine the subcellular distribution of the chemical agent, comprising: providing a library of chemical agents the library comprising a first class of chemical moieties and a second class of chemical moieties; contacting the library to cells under conditions such that the chemical agents of the library localize in the cells; determining the pharmacokinetic properties of the chemical agents in the cells to generate pharmacokinetic properties data; performing additive decomposition on the pharmacokinetic properties data to generate predictor values for each moiety in the first and the second classes of chemical moieties; and using the predictor values for the first and second class of chemical moieties to determine the contribution of the chemical moieties to the subcellular distribution of the chemical agents.

Still other embodiments of the present invention provide methods of determining the contribution of chemical groups in a library of chemical agents to determine the subcellular distribution of the chemical agent, comprising: providing a library of chemical agents the library comprising a first class of chemical moieties and a second class of chemical moieties; contacting the library to cells under conditions such that the chemical agents of the library localize in the cells; determining the bioavailability properties of the chemical agents in the cells to generate bioavailability data; performing additive decomposition on the bioavailability data to generate predictor values for each moiety in the first and the second classes of chemical moieties; and using the predictor values for the first and second class of chemical moieties to determine the contribution of the chemical moieties to the subcellular distribution of the chemical agents.

The present invention further provides method of determining the contribution of chemical groups in a library of chemical agents to determine the subcellular distribution of the chemical agent, comprising: providing a library of chemical agents the library comprising a first class of chemical moieties and a second class of chemical moieties; contacting the library to cells under conditions such that the chemical agents of the library localize in the cells; determining the biodistribution properties of the chemical agents in the cells to generate biodistribution properties data; performing additive decomposition on the biodistribution properties data to generate predictor values for each moiety in the first and the second classes of chemical moieties; and using the predictor values for the first and second class of chemical moieties to determine the contribution of the chemical moieties to the subcellular distribution of the chemical agents.

Methods for determining the contribution of chemical groups in a library of chemical agents to determine the subcellular distribution of the chemical agent, comprising: providing a library of chemical agents the library comprising a first class of chemical moieties and a second class of chemical moieties; contacting the library to cells under conditions such that the chemical agents of the library localize in the cells; determining the metabolic properties of the chemical agents in the cells to generate metabolic properties data; performing additive decomposition on the metabolic properties data to generate predictor values for each moiety in the first and the second classes of chemical moieties; and using the predictor values for the first and second class of chemical moieties to determine the contribution of the chemical moieties to the subcellular distribution of the chemical agents, are also provide in some additional embodiments.

In yet another embodiment, the present invention provides methods of determining the contribution of chemical groups in a library of chemical agents to determine the subcellular distribution of the chemical agent, comprising: providing a library of chemical agents the library comprising a first class of chemical moieties and a second class of chemical moieties; contacting the library to cells under conditions such that the chemical agents of the library localize in the cells; determining the chemical reactivity properties of the chemical agents in the cells to generate chemical reactivity properties data; performing additive decomposition on the chemical reactivity properties data to generate predictor values for each moiety in the first and the second classes of chemical moieties; and using the predictor values for the first and second class of chemical moieties to determine the contribution of the chemical moieties to the subcellular distribution of the chemical agents.

In some other embodiments, the methods of the present invention comprises determining a relative contribution value for each chemical moiety in the first class of chemical moieties, and of each of chemical moiety in the second class of chemical moieties. The present invention also provides methods comprising predicting the distribution of the chemical agents and chemical address tags based on the relative contribution values for each of the chemical moiety in the first class of chemical moieties, and the chemical moiety in the second class of chemical moieties. Additionally, some embodiments of the present invention the one or more of the determining steps comprise using the relative contribution values to predict the subcellular distribution of the chemical agents and address tags containing any of the chemical moieties in the first class of chemical moieties, and the chemical moieties in the second class of chemical moieties.

In preferred embodiments, the first class of chemical moieties comprises lipophilic pyridinium or quinolinium cation molecule cationic molecules, and wherein the second class of chemical moieties comprises an aromatic molecule. In particularly, preferred embodiments, the first class of chemical moieties and the second or more class of chemical moieties are linked (e.g., via chemical interactions). In some of the embodiments, the links comprises a carbon polymethine bridge.

In some preferred embodiments, the present invention provides lipophilic pyridinium or quinolinium cation molecule cationic molecules linked to aromatic molecule which are fluorescent, or have some other distinguishing and detectable chemical, biological, or physical feature or function.

In some embodiments, the present invention provides methods optimized for use in human cells. In some of these embodiments, the human cells comprise cancer cells (e.g., melanoma cells). In still other embodiments, the human melanoma cells comprise UACC-62 human melanoma cells.

The present invention comprises chemical agents and chemical address tags, and portions thereof, linked to payload molecules. The present invention also comprises chemical agents and chemical address tags, and portions thereof, linked to one or more therapeutic molecules (e.g., drugs, pro-drugs, and small molecules therapeutics). In some embodiments, preferred drug molecules have anticancer biological or pharmacological properties (e.g., promote apoptosis, inhibit cellular invasion, inhibit angiogenesis, inhibit cellular proliferation, inhibit nucleic acid replication, etc). In yet other embodiments, the anticancer drug comprises Doxorubicin. The present invention also provides chemical address tags, or portion thereof, linked to agents that bind intracellular proteins, or to agents that bind nucleic acids.

In some of embodiments, the chemical agents and chemical address tags of the combinatorial library localize in one or more isolated organelles in vivo or in vitro cells.

In some embodiments, the present invention provides methods of determining the contribution of chemical groups in a library (e.g., combinatorial) of chemical address tags to determine the subcellular distribution of the chemical address tag, comprising: providing a library of chemical address tags the library comprising a first class of chemical moieties and a second class of chemical moieties; contacting the combinatorial library to a population of cells under conditions such that the chemical address tags of the combinatorial library localize in the cells; determining the localization of the chemical address tags in the cells; determining peak excitation and emission wavelength values of the chemical address tags; fitting peak excitation and emission wavelength values of the chemical address tags into a matrix; summing the excitation and emission wavelength values of the chemical address tags in the matrix; performing additive decomposition on the summed matrix values; and using the matrix values for the first and second class of chemical moieties to determine the contribution of the chemical moieties to the subcellular distribution of the chemical address tags.

In still further embodiments, the methods comprise determining the peak excitation wavelength comprises determining the peak fluorescence excitation wavelength of the chemical address tags. Similarly, in other embodiments, the methods comprise determining the peak fluorescence emission wavelength of the chemical address tags.

The present invention also provides methods of determining the contribution of chemical groups in a combinatorial library of chemical address tags to determine the subcellular distribution of the chemical address tag, comprising: providing a combinatorial library of chemical address tags the library comprising a first class of chemical moieties and a second class of chemical moieties; contacting the combinatorial library to isolated organelles under conditions such that the chemical address tags of the combinatorial library localize to the isolated organelles; determining the localization of the chemical address tags in the isolated organelles; determining peak excitation and emission wavelength values of the chemical address tags; fitting peak excitation and emission wavelength values of the chemical address tags into a matrix; summing the excitation and emission wavelength values of the chemical address tags in the matrix; performing additive decomposition on the summed matrix values; and using the matrix values for the first and second class of chemical moieties to determine the contribution of the chemical moieties to the subcellular distribution of the chemical address tag.

Still further embodiments, provide methods of determining a contribution of chemical groups in a combinatorial library of chemical address tags to determine a subcellular distribution of the chemical address tag, comprising: providing a combinatorial library of chemical address tags the library comprising a first class of chemical moieties and a second class of chemical moieties; contacting the combinatorial library to a population of cells under conditions such that the chemical address tags of the combinatorial library localize in the cells; determining the localization of the chemical address tags in the cells; determining peak excitation and emission wavelength values of the chemical address tags; fitting peak excitation and emission wavelength values of the chemical address tags into a matrix; summing the excitation and emission wavelength values of the chemical address tags in the matrix; performing factorial regression on the summed matrix values; and using the matrix values for the first and second class of chemical moieties to determine the contribution of the chemical moieties to the subcellular distribution of the chemical address tag.

Also provide by the preset invention in some other embodiments are methods of determining the contribution of chemical properties associated with chemical groups in a combinatorial library of chemical address tags to determine the subcellular distribution of the chemical address tag, comprising: providing a combinatorial library of chemical address tags the library comprising a first class of chemical moieties and a second class of chemical moieties; contacting the combinatorial library to a population of cells under conditions such that the chemical address tags of the combinatorial library localize in the cells; determining the localization of the chemical address tags in the cells; determining peak excitation and emission wavelength values of the chemical address tags; fitting peak excitation and emission wavelength values of the chemical address tags into a matrix; summing the excitation and emission wavelength values of the chemical address tags in the matrix; performing additive decomposition on the summed matrix values; and using the matrix values for the first and second class of chemical moieties to determine the contribution of the chemical properties associated with chemical groups of the chemical moieties to the subcellular distribution of the chemical address tag.

In some chemical address tags, the linking group comprises a carbon polymethine bridge. In still some other chemical address tags, the chemical address tag is fluorescent. In preferred embodiments, the chemical address tag is linked to payload molecule. In still other preferred embodiments, the chemical address tag is linked to a therapeutic molecule. The present invention is not intended to be limited however to any particular payload molecules or particular therapeutic molecules. For instance, therapeutic molecules may be selected from drugs (e.g., anticancer drugs, such as, but not limited to, Doxorubicin), prodrugs, and small molecule therapeutics, proapoptotic agents, agents that bind intracellular proteins, agents that bind nucleic acids, agents that bind lipids, or agents that bind carbohydrates, and the like.

In particularly preferred embodiments, the present invention encompasses libraries (combinatorial) of chemical address tags, or libraries (combinatorial) of portions of chemical address tags linked to payload molecules.

In some other preferred embodiments, the present invention provides libraries (e.g., combinatorial libraries) of chemical address tags, or libraries (e.g., combinatorial libraries) of portions of chemical address tags linked to payload molecules that are selected (e.g., analysis of cellular or subcellular distribution), screened, or modified (e.g., chemical modifications) using the methods of the present invention.

Still further embodiments provide methods of determining the contribution of chemical groups in a combinatorial library of chemical address tags to determine the subcellular distribution of the chemical address tag, comprising: providing a combinatorial library of chemical address tags the library comprising a first class of chemical moieties and a second class of chemical moieties; contacting the combinatorial library to a population of cells under conditions such that the chemical address tags of the combinatorial library localize in the cells; determining the affect of the chemical address tags on biological activities in the cells; determining peak values for the affects on the cells; fitting the peak values of the affects into a matrix; summing the peak values of the affects; performing additive decomposition on the summed matrix values; and using the matrix values for the first and second class of chemical moieties to determine the contribution of the chemical moieties to the biological affects of the chemical address tags.

Other embodiments provide methods of determining the contribution of chemical groups in a combinatorial library of chemical address tags to determine the subcellular distribution of the chemical address tag, comprising: providing a combinatorial library of chemical address tags the library comprising a first class of chemical moieties and a second class of chemical moieties; contacting the combinatorial library to a population of cells under conditions such that the chemical address tags of the combinatorial library localize in the cells; determining the toxicological properties of the chemical address tags in the cells; determining peak values for the toxicological properties in the cells; fitting the peak values of the affects into a matrix; summing the peak values of the affects; performing additive decomposition on the summed matrix values; and using the matrix values for the first and second class of chemical moieties to determine the contribution of the chemical moieties to the toxicological properties of the chemical address tags.

Still other embodiments provide methods of determining the contribution of chemical groups in a combinatorial library of chemical address tags to determine the subcellular distribution of the chemical address tag, comprising: providing a combinatorial library of chemical address tags the library comprising a first class of chemical moieties and a second class of chemical moieties; contacting the combinatorial library to a population of cells under conditions such that the chemical address tags of the combinatorial library localize in the cells; determining the pharmacological properties of the chemical address tags in the cells; determining peak values for the pharmacological properties in the cells; fitting the peak values of the affects into a matrix; summing the peak values of the affects; performing additive decomposition on the summed matrix values; and using the matrix values for the first and second class of chemical moieties to determine the contribution of the chemical moieties to the pharmacological properties of the chemical address tags.

The present invention, in some embodiments, provides methods of determining the contribution of chemical groups in a combinatorial library of chemical address tags to determine the subcellular distribution of the chemical address tag, comprising: providing a combinatorial library of chemical address tags the library comprising a first class of chemical moieties and a second class of chemical moieties; contacting the combinatorial library to a population of cells under conditions such that the chemical address tags of the combinatorial library localize in the cells; determining the pharmacokinetic properties of the chemical address tags in the cells; determining peak values for the pharmacokinetic properties in the cells; fitting the peak values of the affects into a matrix; summing the peak values of the affects; performing additive decomposition on the summed matrix values; and using the matrix values for the first and second class of chemical moieties to determine the contribution of the chemical moieties to the pharmacokinetic properties of the chemical address tags.

Also provided in some additional embodiments of the present invention are methods of determining the contribution of chemical groups in a combinatorial library of chemical address tags to determine the subcellular distribution of the chemical address tag, comprising: providing a combinatorial library of chemical address tags the library comprising a first class of chemical moieties and a second class of chemical moieties; contacting the combinatorial library to a population of cells under conditions such that the chemical address tags of the combinatorial library localize in the cells; determining the bioavailability properties of the chemical address tags in the cells; determining peak values for the bioavailability properties in the cells; fitting the peak values of the affects into a matrix; summing the peak values of the affects; performing additive decomposition on the summed matrix values; and using the matrix values for the first and second class of chemical moieties to determine the contribution of the chemical moieties to the bioavailability properties of the chemical address tags.

Biological targets contemplated by the present invention include, but are not limited to, cell surface proteins, cell surface receptors, cell surface polysaccharides, extracellular matrix proteins, intracellular proteins, intracellular nucleic acids, and the like. In some embodiments, the biological target is located on the surface of a diseased cell (e.g., cancerous).

A variety of subject types are contemplated for treatment by certain embodiments of the compositions and methods of the present invention. For example, in some embodiments, the subjects are mammals (e.g., humans). In preferred embodiments, the present compositions and methods are optimized to treat humans, however, the present invention is not limited to treating humans. Indeed, the present invention contemplates effective drug delivery compositions and treatment methods for a variety of vertebrate animals including, but not limited to, cows, pigs, sheep, goats, horses, cats, dogs, rodents, birds, fish, and the like.

Other embodiments of the present invention specifically contemplate chemical intermediates, and formulations of compounds (e.g., chemical agents, chemical address tags, and other molecules) used in medicaments, in the manufacture of medicaments, kits for the administration of medicaments or diagnostic test and other applications related thereto, and other beneficial formulations.

The present invention further provides novel processes for the preparation of the compositions described herein and others that are manufactured by the methods and process of the present invention. In some of these embodiments, the compositions are formulated (manufactured) by reaction one or more chemical intermediates of the present invention.

The present invention provides chemical address tag compositions characterized in that they promote or inhibit the accumulation of linked chemical species into intracellular organelles (including, but not limited to, synthetic organelles, and portions of disrupted cells and organelles) and other intracellular locations of interest as well as intercellular locations, cells, tissues, and organs in vivo and in vitro.

Also provided are uses of the compositions and methods of the present invention for the preparation of therapeutics, medicaments, and other therapeutic applications. The present invention provides compositions useful as chemical address tags.

Further embodiments provide uses of the compositions of the present invention, and compositions prepared by use of the methods of the present invention, for the treatment of disease (e.g., cancer, mitochondrial maladies, and other diseases and pathologies).

Still further embodiments of the present invention provide systems for the automated or semi-automated implementation of the methods of the present invention. Some of these embodiments comprise processors having one or more computer readable memory devices (e.g., RAM, ROM, DVDs, CDs, magnetic tapes, and the like). Still other related embodiments comprise communications means (e.g., the Internet).

In yet other embodiments, the present invention provides methods according to any of the claims (e.g., Claim 1) substantially as described in any of the examples or various embodiments disclosed herein.

Other advantages, benefits, and valuable embodiments of the present invention will be apparent to those skilled in the art.

In certain embodiments, the present invention provides a composition comprising an agent attached to a targeting moiety selected from the group consisting of: A3-B9, A3-B8, A3-B10, A7-B7, A8-B7, A9-B8, A9-B10, A9-B11, A9-B7, A11-B2, A22-B2, A30-B9, A31-B9, A31-B8, A31-B10, A31-B2, A31-B7, A32-B9, A32-B8, A32-B10, A32-B1, A32-B2, A32-B11, A32-B13, A32-B12, A32-B7, A33-B9, A33-B8, A33-B10, A33-B1, A33-B11, A33-B13, A33-B12, A33-B7, A36-B2, A10-B8, A10-B10, A10-B11, A10-B12, A21-B8, A21-B7, A18-B8, A18-B7, A39-B10, A39-B2, A39-B11, A39-B13, A19-B10, A19-B1, A19-B2, A19-B11, A19-B5, A19-B13, A19-B12, A19-B7, A19-B3, A1-B9, A1-B8, A1-B10, A27-B8, A27-B2, A27-B11, A27-B13, A27-B7, A15-B8, A37-B14, A37-B2, A37-B5, A37-B4, A14-B1, A14-B11, A14-B13, A14-B12, A14-B7, A38-B10, A38-B2, A24-B2, A24-B11, A24-B7, A35-B12, A16-B2, A20-B7, A12-B1, A12-B7, A12-B3, and A23-B1, wherein the targeting moiety induces mitochondrial localization of the composition. In preferred embodiments, the agent is a selected from the group consisting of drugs, pro-drugs, and small molecule therapeutics. In other embodiments, the drugs comprise anticancer drugs. In other embodiments, the anticancer drug is Doxorubicin.

In preferred embodiments, the small molecule therapeutic comprises a proapoptotic agent. In other preferred embodiments, the small molecule therapeutic binds intracellular proteins. In yet other preferred embodiments, the small molecule therapeutic binds nucleic acids. In other embodiments, the small molecule therapeutic binds lipids. In still other preferred embodiments, the small molecule therapeutic binds carbohydrates.

In certain embodiments, the present invention provides a composition comprising an agent attached to a targeting moiety selected from the group consisting of: A1-B1, A23-B1, A24-B1, A27-B1, A32-B1, A1-B2, A23-B2, A24-B2, A33-B2, A23-B3, A23-B4, A23-B5, A33-B7, A38-B7, A24-B8, A33-B8, A39-B8, A10-B9, A31-B9, A35-B9, A37-B9, A38-B9, A35-B10, A23-B11, A23-B12, A23-B13, A24-B14, wherein the targeting moiety induces cytoplasmic localization of the composition. In preferred embodiments, the agent is a selected from the group consisting of drugs, pro-drugs, and small molecule therapeutics. In other embodiments, the drugs comprise anticancer drugs. In other embodiments, the anticancer drug is Doxorubicin.

In preferred embodiments, the small molecule therapeutic comprises a proapoptotic agent. In other preferred embodiments, the small molecule therapeutic binds intracellular proteins. In yet other preferred embodiments, the small molecule therapeutic binds nucleic acids. In other embodiments, the small molecule therapeutic binds lipids. In still other preferred embodiments, the small molecule therapeutic binds carbohydrates.

In certain embodiments, the present invention provides a composition comprising an agent attached to a targeting moiety selected from the group consisting of: A19-B1, A37-B5, A12-B7, A31-B7, A16-B8, A17-B8, A18-8, A19-B8, A20-B8, A21-B8, A23-B8, A32-B8, A16-B9, A18-B9, A19-B9, A20-B9, A21-B9, A27-B9, A28-B9, A32-B9, A9-B14, A20-B14, A37-B14, wherein the targeting moiety induces nucleoli localization of the composition. In preferred embodiments, the agent is a selected from the group consisting of drugs, pro-drugs, and small molecule therapeutics. In other embodiments, the drugs comprise anticancer drugs. In other embodiments, the anticancer drug is Doxorubicin.

In preferred embodiments, the small molecule therapeutic comprises a proapoptotic agent. In other preferred embodiments, the small molecule therapeutic binds intracellular proteins. In yet other preferred embodiments, the small molecule therapeutic binds nucleic acids. In other embodiments, the small molecule therapeutic binds lipids. In still other preferred embodiments, the small molecule therapeutic binds carbohydrates.

In certain embodiments, the present invention provides a composition comprising an agent attached to a targeting moiety selected from the group consisting of: A32-B1, A33-B2, A12-B5, A24-B6, A23-B7, A38-B7, A12-A8, A14-B8, A17-B8, A23-B8, A10-B9, A12-B9, A14-B9, A17-B9, A21-B9, A33-B9, A12-B10, A15-B10, A16-B10, A20-B10, A37-B11, wherein the targeting moiety induces vesicular uptake of the composition. In preferred embodiments, the agent is a selected from the group consisting of drugs, pro-drugs, and small molecule therapeutics. In other embodiments, the drugs comprise anticancer drugs. In other embodiments, the anticancer drug is Doxorubicin.

In preferred embodiments, the small molecule therapeutic comprises a proapoptotic agent. In other preferred embodiments, the small molecule therapeutic binds intracellular proteins. In yet other preferred embodiments, the small molecule therapeutic binds nucleic acids. In other embodiments, the small molecule therapeutic binds lipids. In still other preferred embodiments, the small molecule therapeutic binds carbohydrates.

In certain embodiments, the present invention provides a composition comprising an agent attached to a targeting moiety selected from the group consisting of: A12-B2, A14-B2, A19-B2, A27-B2, A12-B5, A37-B10, A12-B11, A17-B11, A12-B12, A14-B12, A17-B12, A12-B13, A17-B13, wherein the targeting moiety induces endoplasmic reticulum localization of the composition. In preferred embodiments, the agent is a selected from the group consisting of drugs, pro-drugs, and small molecule therapeutics. In other embodiments, the drugs comprise anticancer drugs. In other embodiments, the anticancer drug is Doxorubicin.

In preferred embodiments, the small molecule therapeutic comprises a proapoptotic agent. In other preferred embodiments, the small molecule therapeutic binds intracellular proteins. In yet other preferred embodiments, the small molecule therapeutic binds nucleic acids. In other embodiments, the small molecule therapeutic binds lipids. In still other preferred embodiments, the small molecule therapeutic binds carbohydrates.

In certain embodiments, the present invention provides a composition comprising an agent attached to a targeting moiety selected from the group consisting of: A38-B2, A38-B7, A28-B8, A31-B8, A33-B8, A31-B9, A32-B9, A33-B9, wherein the targeting moiety induces nuclear localization of the composition. In preferred embodiments, the agent is a selected from the group consisting of drugs, pro-drugs, and small molecule therapeutics. In other embodiments, the drugs comprise anticancer drugs. In other embodiments, the anticancer drug is Doxorubicin.

In preferred embodiments, the small molecule therapeutic comprises a proapoptotic agent. In other preferred embodiments, the small molecule therapeutic binds intracellular proteins. In yet other preferred embodiments, the small molecule therapeutic binds nucleic acids. In other embodiments, the small molecule therapeutic binds lipids. In still other preferred embodiments, the small molecule therapeutic binds carbohydrates.

In certain embodiments, the present invention provides a composition comprising an agent and a probe moiety selected from the group consisting of D10, G9, H3, B8, H6, E4, B4, A4, A8, B7, G7, D8, C2, E8, E9, B10, G8, H1, B3, E7, C6, G6, A1, C1, C3, D4, A10, D6, A9, E3, A7, B6, A9, E3, A7, B6, C7, A3, F9, G5, G4, C8, C4, E6, A6, B1, D1, D2, G2, H8, B5, D3, E10, F3, A5, F5, F4, C5, E5, D5, C9, D7, B9, G1, G3, H5, F10, E2, F8, F2, A2, B2, H2, D9, F6, and F7, wherein the probe moiety induces in vivo vesicle uptake of the composition. In preferred embodiments, the vesicle uptake is cytoplasmic vesicle uptake. In other preferred embodiments, the vesicle uptake is perinuclear vesicle uptake.

In preferred embodiments, the agent is a selected from the group consisting of drugs, pro-drugs, and small molecule therapeutics. In other embodiments, the drugs comprise anticancer drugs. In other embodiments, the anticancer drug is Doxorubicin.

In preferred embodiments, the small molecule therapeutic comprises a proapoptotic agent. In other preferred embodiments, the small molecule therapeutic binds intracellular proteins. In yet other preferred embodiments, the small molecule therapeutic binds nucleic acids. In other embodiments, the small molecule therapeutic binds lipids. In still other preferred embodiments, the small molecule therapeutic binds carbohydrates.

### DESCRIPTION OF THE FIGURES

FIG. 1 shows various exemplary amino acid sequences contemplated foe use in certain embodiments of the present invention.

FIG. 2 provides a schematic illustration of the synthesis of one contemplated polyrotaxane containing hydrolysable Doxorubicin drug delivery composition.

FIG. 3 shows one contemplated synthesis scheme for a fluorescent combinatorial library of molecules based on a styryl scaffold.

FIG. 4 shows the emission colors and wavelengths of one contemplated library of fluorescent compounds.

FIG. 5 shows results from a library of fluorescent compounds incubated with live UACC-62 human melanoma cells growing on glass bottom 96-well plates.

FIG. 6 shows the and distribution of the organelle specific styryl dyes ([#] Nuclear, [*] Nucleolar, [♦] Mitochondria, [●] Cytosolic, [x] Endoplasmic Reticular [ER], [▪] Vesicular, [▴] Granular; row a is aldehyde only) in one contemplated embodiment.

FIG. 7 provides a schematic representation of three alternative models that could explain mitochondrial localization. The A and B moieties are represented by geometrical shape (triangle, square, or otherwise). Mitochondria are represented by the inner green circle. Localization is ascribed to specific binding interaction between the A or B moieties and localization determinants present in the mitochondria.

FIGS. 8A-8B shows predicted versus experimentally-determined values for peak excitation (FIG. 8A) and emission FIG. 8B) wavelengths in one contemplated library of styryl compounds.

FIGS. 9A-9B show the experimental and predicted peak emission (FIG. 9A) and excitation (FIG. 9B) wavelengths for compounds with complex spectra along with the experimentally determined peak wavelengths (each vertical band represents a single compound, the experimental data are shown as either a vertical error bar for a poorly-defined broad peak, or as multiple empty squares for several localized peaks) in one contemplated embodiment of the present invention.

FIGS. 10A-10B show the clustered peak experimental wavelengths for peak excitation (FIG. 10A) and emission (FIG. 10B), respectively, in certain embodiments.

FIG. 11 shows clustered mitochondrial (M) and non-mitochondrial (O) localizations for particular compounds of the present invention.

FIG. 12 provides a bivariate plot of excitation and emission peak wavelength distribution of styryl products, indicating different localizations.

FIGS. 13A-13F provide bivariate plots of excitation/emission (FIGS. 13A and 13D), mitochondrial affinity/emission (FIGS. 13B and 13E), and mitochondrial affinity/excitation (FIGS. 13C and 13F) for the individual A (FIGS. 13A-13C) and B FIGS. 13D-13F) groups. For clarity, each quadrant in the plot is indicated with roman numerals.

FIG. 14 shows an epifluorescence microscopy analysis of selected styryl products selected from the excitation table from FIGS. 10A-10B.

FIGS. 15A and 15B show the resonance structure of (N,N) dimethylammonium phenyl (FIG. 15A) and nitrophenyl (FIG. 15B) styryl derivatives.

FIG. 16 shows various chemical moieties used in certain embodiments of the present invention.

FIG. 17 shows the fluorometric titration of compound 1 with dsDNA in a buffer solution (λₑₓ=394 nm, compound 1 [5 μM]).

FIGS. 18A-18C show the absorption and fluorescence spectra of compounds 1, 2, and 3 (Dye 1, 2, 3 [50 μM], dsDNA [50 μg mL⁻¹]).

FIG. 19 shows the nuclear staining of compounds 1, 2, and 3 (500 μM).

FIG. 20 shows an NBD-tagged library of subcellular transport probes. Probes incorporate an NBD linker attached to a triazine scaffold derivatized at the R₁ position with groups 1-10 and R₂ position with groups A-H.

FIG. 21 shows system dynamics of subcellular transport. A) A nested, two-compartment model was used to parameterize the subcellular transport properties of the probes in terms of four kinetic parameters: k(cyto)ᵢₙ, the rate at which probe enters the cytosol; k(cyto)ₒᵤₜ, the rate at which probe leaves the cytosol; k(ves)ᵢₙ, the rate at which the probe enters the vesicles; and, k(ves)ₒᵤₜ, the rate at which the probe leaves the vesicles. In the illustration, a yellow line represents the plasma membrane, and grey represents the cytosol. Arrows with question marks indicate hypothetical endocytic origin of intracellular sites of probe sequestration. The time evolution of the system is described by influx functions Cᵢ′(t) (cytoplasm), Vᵢ′(t) (vesicles), and Mᵢ′(t) (medium); and, efflux functions Cₑ′(t) (cytoplasm), Vₑ′(t) (vesicles), and Mₑ′(t) (medium). B) Plotting the log ratio of the partition coefficients of the probes examined reveals a strong, negative correlation between Pₐₚ(cyto) and Pₐₚ(ves). Filled boxes indicate molecules derivatized with the R₁=3 group, exhibiting some of the strongest affinities for intracellular vesicles.

FIG. 22 shows images of cells showing cytoplasmic probe sequestration. A) Most probes are sequestered as soon as 10 min after beginning of probe incubation, with a few probes showing progressive sequestration during the time course of the experiment. An asterisk indicates the location of the cell nucleus. Ten different, representative probes are shown, incorporating the indicated group at the R₁ position, with the R₂ position held constant. Two images are shown, corresponding to the probe distribution 10 and 120 min after beginning of incubation.

FIG. 23 shows images of cells showing retention of sequestered probe. A) In the absence of extracellular probes, probes derivatized with R₁=3 exhibit the greatest retention in intracellular compartments, as monitored 10 and 25 min after removal of probe from extracellular medium. Most other sequestered probes exhibit little retention, as soon as 10 min after removal of probe from extracellular medium. B) The CVs of cells treated with R₁=3 derivatized probes 25 minutes after probe removal were consistently higher than the other R₁ groups regardless of the R₂ group present. C) Independent of the initial degree of probe sequestration, R₁=3 probes display greater retention than other probes in the library. Solid curve represents the values that would be expected if probe had completely leaked from the cell, for different degrees of sequestration immediately prior to removal of extracellular probe.

FIG. 24 shows the synthesis scheme of NBD-tagged triazine library. (a) Synthesis of NBDLinker; (b) Orthogonal synthetic pathway utilized for synthesis of the library compounds.

FIG. 25 shows a Flow diagram of image analysis algorithm used to measure perinuclear NBD pixel intensity distributions.

### DEFINITIONS

To facilitate an understanding of the present invention, a number of terms and phrases are defined below:

As used herein, the term “chemical address tag” refers to at least a portion of a chemical compound that non-randomly localizes to particular regions or locations within a cell (e.g., organelles, synthetic organelles, such as liposomes and micelles, and portions of disrupted cells and organelles, such as microsomes, and other intracellular sites), tissue, or organ. The “chemical address tags” of the present invention can comprise a one (first), two (second), or more, classes of chemical moieties linked together via chemical interactions (e.g., covalent, noncovalent, ionic, nonionic, single bond, double bond, triple bond, ene-yne, amine bond, amide, thiol bond, and aldehyde bonds).

As used herein, the term “response variable” refers to a measurable physical (e.g., biological, including bioavailability, pharmacological, pharmacokinetic, toxicological), or mathematical property of an object (e.g., chemical compound, molecule, ion, atom, aggregate of atoms or molecules, electromagnetic radiation systems, mathematical systems, and any other form of measurable physical matter or energy, energy or structural or behavioral organization, and the like).

As used herein, the term “predictor variable” refers to a measurable or non-measurable mathematical (e.g., numerically quantifiable property associated with an object or portion of an object) that can be used to predict a response variable associated with that object (e.g., chemical compound, molecule, ion, atom, aggregate of atoms or molecules, electromagnetic radiation, mathematical systems, and any other form of measurable physical matter or energy, energy or structural or behavioral organization, and the like).

As used herein, the term “mathematical model” refers to a mathematical function together with numerical values associated with each variable in the function relating to an experimentally observed set of response variables (e.g., Y₁, Y₂, Y₃, . . . Yₙ) to one or more sets of predictor variables (e.g., A₁, A₂, A₃, . . . Aₙ; B₁, B₂, B₃, . . . Bₙ; C₁, C₂, C₃, . . . Cₙ, etc).

As used herein, the term “predict” refers to the ability or act of projecting, inferring, or otherwise estimating a value for measured or unmeasured objects (e.g., data referring to the intracellular localization of a chemical agent, drug, prodrug, chemical address tag, etc) at an accuracy greater than that afforded by guessing or random chance.

As used herein, the term “determine” refers to the ability or act of projecting, inferring, or otherwise estimating a value for measured objects (e.g., data referring to the intracellular localization of a chemical agent, drug, prodrug, chemical address tag, etc) at an accuracy greater than that afforded by guessing or random chance.

As used herein, the term “statistical analysis” refers to any mathematical method that can be used to determine or predict measurements obtained from a large number of objects, based on measurements obtained using a smaller number of related objects. “Additive decomposition” and “factorial regression” are two of a number of types of statistical analysis techniques and tools contemplated for use in certain embodiments of the present invention.

As used herein, the term “additive decomposition” refers to a mathematical method for representing a set of response variable (e.g., Y₁, Y₂, Y₃, . . . Yₙ) relating to a measure of interest (e.g., subcellular localization of different chemical address tag molecules) as a sum of two or more predictor variables (e.g., A₁, A₂, A₃, . . . Aₙ; B₁, B₂, B₃, . . . Bₙ; C₁, C₂, C₃, . . . Cₙ, etc). The “additive decomposition” is fit empirically to the experimental data by minimizing the difference between the sum of the predictor variables and the measured response variables across a large number of predictor variable combinations.

A used herein, the term “factorial regression” refers to a mathematical technique for representing a set of response variables (e.g., Y₁, Y₂, Y₃, . . . Yₙ) as a linear function of a set of a predictor variables (e.g., A₁, A₂, A₃, . . . Aₙ; B₁, B₂, B₃, . . . Bₙ; C₁, C₂, C₃, . . . Cₙ, etc). When the set of predictor variables is qualitative, such as the identity of an A or B group in a styryl library, then the set of variables is dichotomized as a “factor variable” taking on the value 1 when a certain condition is present (e.g., when a certain functional group is part of the molecule) and 0 when the condition is not present (e.g., when the functional group is not present). A regression containing factor variables is called “factorial regression.”

As used herein, the term “matrix” refers to a set of numbers (or variables) that can be obtained by applying some mathematical function to combinations of two or more sets of numbers (or variables). In the case of the styryl compounds, the localization matrix is represented by the subcellular localization of all the compounds obtained by combining each different chemical group (e.g., A, B, C, . . . N). In the case where the localization of the matrix is dependent on an additive function, the localization of each compound is determined by the sum (addition) of the individual contributions of each group (e.g., A and B) to the localization.

As used herein, the term “peak excitation” refers to the property of fluorescent compounds describing the wavelength (i.e., color) of light in which the compound is able to absorb the greatest number of photons. As used herein, the term “peak emission” refers to the property of fluorescent compounds describing the wavelength (i.e., color) of light in which the compound is able to emit the greatest number of photons.

As used herein, the term “leave-one-out method,” also known as “cross-validation,” refers to mathematical technique used to test the ability of a mathematical model to predict a set of response variables (e.g., Y₁, Y₂, Y₃, . . . Yₙ) from one or more predictor variables (e.g., A₁, A₂, A₃, . . . Aₙ; B₁, B₂, B₃, . . . Bₙ; C₁, C₂ C₃, . . . Cₙ etc). To test whether a function is predictive, each experimentally measured response variable is left out in sequence, and the model is fit using the remaining experimental points. This fitted model is then used to predict the response variable at the held-out point. The prediction rates for each held out point are averaged to get an unbiased estimate of the prediction accuracy for the model.

As used herein, the term “organelle” refers to a localized subcellular compartment, whether it be found inside a living cell (e.g., mitochondria, lysosomes, and the like), isolated from a cell (e.g., microsomal fractions obtained after cellular homogenization, or chemically synthesized [e.g., synthetic liposomes made of lipid bilayers]). “Organelles” can be membrane bound structures (e.g., mitochondria, lysosomes, endoplasmic reticulum, etc), and macromolecular complexes (e.g., ribosomes, nucleoli, etc), or any other type of identifiable subcellular organization associated with a particular cellular location (e.g., plasma membrane, nucleus, glycocalyx, nuclear lamina, proteasome, cytoskeleton, and the like).

As used herein, the term “biological activities” refers to any measurable effect of a molecule on the natural function (e.g., catalytic activity of an enzyme, transport of an ion through a membrane, heart rate, etc) of a physiological system.

As used herein, the term “toxicological properties” refers to an undesirable (e.g., physiologically detrimental) characteristic or biological activity of an agent (e.g., chemical agent) upon administration to a physiological system.

As used herein, the term “pharmacological properties” refers to any desirable or favorable biological activities or physicochemical characteristics of a molecule administered to a physiological system.

As used herein, the term “pharmacokinetic properties” refers to the concentration of a molecule in different compartments (e.g., subcellular, cellular, organs, etc) at different times after the molecule is administered to a physiological system.

As used herein, the term “bioavailability” refers to any measure of the ability of a molecule to be absorbed into the systemic circulation (e.g., blood) after administration to a physiological system.

As used herein, the term “biodistribution” refers to the location of an agent (e.g., drug, prodrug, chemical agents, therapeutic molecules, etc) in organelles, cells (e.g., in vivo or in vitro), tissues, organs, organisms, after administration to a physiological system.

As used herein, the term “metabolic properties” refers to the ability of a physiological system to interact (e.g., bind, sequester, etc) with an administered agent or to directly or indirectly transform the chemical nature (e.g., degrade, oxidize, hydrolyze, ionize, etc), or physicochemical properties (e.g., solubility, lipophilicity, etc) of the administered agent.

As used herein, the term “chemical reactivity properties” refers to the characteristic abilities of a chemical agent to interact with another chemical agent (e.g., ions, solvents, radiation, etc) in physiological, or non-physiological systems.

As used herein, the term “physiological system” refers to natural or artificial (e.g., synthetic) organizations encompassing, derived from, or synthesized to mimic a biological entity (e.g., subject, cells, tissues, organs, and organ systems in vivo or in vitro, and cellular and subcellular components thereof) or parts thereof.

As used herein, the term “antigen binding protein” refers to proteins that bind to a specific antigen. “Antigen binding proteins” include, but are not limited to, immunoglobulins, including polyclonal, monoclonal, chimeric, single chain, and humanized antibodies, Fab fragments, F(ab′)2 fragments, and Fab expression libraries. Various procedures known in the art are used for the production of polyclonal antibodies. For the production of antibody, various host animals can be immunized by injection with the peptide corresponding to the desired epitope including but not limited to rabbits, mice, rats, sheep, goats, etc In a preferred embodiment, the peptide is conjugated to an immunogenic carrier (e.g., diphtheria toxoid, bovine serum albumin [BSA], or keyhole limpet hemocyanin [KLH]). Various adjuvants are used to increase the immunological response, depending on the host species, including but not limited to Freund's (complete and incomplete), mineral gels such as aluminum hydroxide, surface active substances such as lysolecithin, pluronic polyols, polyanions, peptides, oil emulsions, keyhole limpet hemocyanins, dinitrophenol, and potentially useful human adjuvants such as BCG (Bacille Calmette-Guerin) and Corynebacterium parvum.

For preparation of monoclonal antibodies, any technique that provides production of antibody molecules by continuous cell lines in culture may be used. (See e.g., Harlow and Lane, Antibodies: A Laboratory Manual, Cold Spring Harbor Laboratory Press, Cold Spring Harbor, N.Y.). These include, but are not limited to, the hybridoma technique originally developed by Köhler and Milstein (Köhler and Milstein, Nature, 256:495-497 [1975]), as well as the trioma technique, the human B-cell hybridoma technique (See e.g., Kozbor et al., Immunol. Today, 4:72 [1983]), and the EBV-hybridoma technique to produce human monoclonal antibodies (Cole et al., in Monoclonal Antibodies and Cancer Therapy, Alan R. Liss, Inc., pp. 77-96 [1985]). In other embodiments, suitable monoclonal antibodies, including recombinant chimeric monoclonal antibodies and chimeric monoclonal antibody fusion proteins are prepared as described herein.

Techniques described for the production of single chain antibodies (U.S. Pat. No. 4,946,778; herein incorporated by reference) can be adapted to produce specific single chain antibodies as desired. An additional embodiment of the invention utilizes the techniques known in the art for the construction of Fab expression libraries (Huse et al., Science, 246:1275-1281 [1989]) to allow rapid and easy identification of monoclonal Fab fragments with the desired specificity.

Antibody fragments that contain the idiotype (antigen binding region) of the antibody molecule can be generated by known techniques. For example, such fragments include but are not limited to: the F(ab′)2 fragment that can be produced by pepsin digestion of an antibody molecule; the Fab′ fragments that can be generated by reducing the disulfide bridges of an F(ab′)2 fragment, and the Fab fragments that can be generated by treating an antibody molecule with papain and a reducing agent.

As used herein the term “antibody” refers to a glycoprotein evoked in an animal by an immunogen (antigen). An antibody demonstrates specificity to the immunogen, or, more specifically, to one or more epitopes contained in the immunogen. Native antibody comprises at least two light polypeptide chains and at least two heavy polypeptide chains. Each of the heavy and light polypeptide chains contains at the amino terminal portion of the polypeptide chain a variable region (i.e., V_{H} and V_{L} respectively), which contains a binding domain that interacts with antigen. Each of the heavy and light polypeptide chains also comprises a constant region of the polypeptide chains (generally the carboxy terminal portion) which may mediate the binding of the immunoglobulin to host tissues or factors influencing various cells of the immune system, some phagocytic cells and the first component (C1q) of the classical complement system. The constant region of the light chains is referred to as the “CL region,” and the constant region of the heavy chain is referred to as the “CH region.” The constant region of the heavy chain comprises a CH1 region, a CH2 region, and a CH3 region. A portion of the heavy chain between the CH1 and CH2 regions is referred to as the hinge region (i.e., the “H region”). The constant region of the heavy chain of the cell surface form of an antibody further comprises a spacer-transmembranal region (M1) and a cytoplasmic region (M2) of the membrane carboxy terminus. The secreted form of an antibody generally lacks the M1 and M2 regions.

As used herein, the term “antigen” refers to any molecule or molecular group that is recognized by at least one antibody. By definition, an antigen contains at least one epitope (i.e., the specific biochemical unit capable of being recognized by the antibody). The term “immunogen” refers to any molecule, compound, or aggregate that induces the production of antibodies. By definition, an immunogen contains at least one epitope.

As used herein the term “biological target” refers to any organism, cell, microorganism, bacteria, virus, fungus, plant, prion, protozoa, or pathogen or portion of an organism, cell, microorganism, bacteria, virus, fungus, plant, prion, protozoa or pathogen.

As used herein, the terms “peptide” or “polypeptide” refer to a chain of amino acids (i.e., two or more amino acids) linked through peptide bonds between the -carboxyl carbon of one amino acid residue and the -nitrogen of the next. A “peptide” or “polypeptide” may comprise an entire protein or a portion of protein. “Peptides” and “polypeptides” may be produced by a variety of methods including, but not limited to chemical synthesis, translation from a messenger RNA, expression in a host cell, expression in a cell free translation system, and digestion of another polypeptide.

As used herein the term “protein” is used in its broadest sense to refer to all molecules or molecular assemblies containing two or more amino acids. Such molecules include, but are not limited to, proteins, peptides, enzymes, antibodies, receptors, lipoproteins, and glycoproteins.

As used herein, the term “enzyme” refers to molecules or molecule aggregates that are responsible for catalyzing chemical and biological reactions. Such molecules are typically proteins, but can also comprise short peptides, RNAs, ribozymes, antibodies, and other molecules.

As used herein, the terms “nucleic acid” or “nucleic acid molecules” refer to any nucleic acid containing molecule including, but not limited to, DNA or RNA. The term encompasses sequences that include any of the known base analogs of DNA and RNA including, but not limited to, 4-acetylcytosine, 8-hydroxy-N6-methyladenosine, aziridinylcytosine, pseudoisocytosine, 5-(carboxyhydroxylmethyl) uracil, 5-fluorouracil, 5-bromouracil, 5-carboxymethylaminomethyl-2-thiouracil, 5-carboxymethyl-aminomethyluracil, dihydrouracil, inosine, N6-isopentenyladenine, 1-methyladenine, 1-methylpseudouracil, 1-methylguanine, 1-methylinosine, 2,2-dimethylguanine, 2-methyladenine, 2-methylguanine, 3-methylcytosine, 5-methylcytosine, N6-methyladenine, 7-methylguanine, 5-methylaminomethyluracil, 5-methoxyamino-methyl-2-thiouracil, beta-D-mannosylqueosine, 5′-methoxycarbonylmethyluracil, 5-methoxyuracil, 2-methylthio-N6-isopentenyladenine, uracil-5-oxyacetic acid methylester, uracil-5-oxyacetic acid, oxybutoxosine, pseudouracil, queosine, 2-thiocytosine, 5-methyl-2-thiouracil, 2-thiouracil, 4-thiouracil, 5-methyluracil, N-uracil-5-oxyacetic acid methylester, uracil-5-oxyacetic acid, pseudouracil, queosine, 2-thiocytosine, and 2,6-diaminopurine.

Nucleic acid molecules are said to have “5′ ends” and “3′ ends” because mononucleotides are reacted to make oligonucleotides or polynucleotides in a manner such that the 5′ phosphate of one mononucleotide pentose ring is attached to the 3′ oxygen of its neighbor in one direction via a phosphodiester linkage. Therefore, an end of an oligonucleotides or polynucleotide, referred to as the “5′ end” if its 5′ phosphate is not linked to the 3′ oxygen of a mononucleotide pentose ring and as the “3′ end” if its 3′ oxygen is not linked to a 5′ phosphate of a subsequent mononucleotide pentose ring. As used herein, a nucleic acid sequence, even if internal to a larger oligonucleotide or polynucleotide, also may be said to have 5′ and 3′ ends. In either a linear or circular DNA molecule, discrete elements are referred to as being “upstream” or 5′ of the “downstream” or 3′ elements. This terminology reflects the fact that transcription proceeds in a 5′ to 3′ fashion along the DNA strand. The promoter and enhancer elements that direct transcription of a linked gene are generally located 5′ or upstream of the coding region. However, enhancer elements can exert their effect even when located 3′ of the promoter element and the coding region. Transcription termination and polyadenylation signals are located 3′ or downstream of the coding region.

As used herein, the terms “material” and “materials” refer to, in their broadest sense, any composition of matter.

As used herein, the term “pathogen” refers to disease causing organisms, microorganisms, or agents including, but not limited to, viruses, bacteria, parasites (including, but not limited to, organisms within the phyla Protozoa, Platyhelminthes, Aschelminithes, Acanthocephala, and Arthropoda), fungi, and prions.

The terms “bacteria” and “bacterium” refer to all prokaryotic organisms, including those within all of the phyla in the Kingdom Procaryotae. It is intended that the term encompass all microorganisms considered to be bacteria including Mycoplasma, Chlamydia, Actinomyces, Streptomyces, and Rickettsia. All forms of bacteria are included within this definition including cocci, bacilli, spirochetes, spheroplasts, protoplasts, etc Also included within this term are prokaryotic organisms that are gram negative or gram positive. “Gram negative” and “gram positive” refer to staining patterns with the Gram-staining process that is well known in the art. (See e.g. Finegold and Martin, Diagnostic Microbiology, 6th Ed., CV Mosby St. Louis, pp. 13-15 [1982]). “Gram positive bacteria” are bacteria that retain the primary dye used in the Gram stain, causing the stained cells to appear dark blue to purple under the microscope. “Gram negative bacteria” do not retain the primary dye used in the Gram stain, but are stained by the counterstain. Thus, gram negative bacteria appear red.

As used herein, the term “virus” refers to infectious agents, which with certain exceptions, are not observable by light microscopy, lack independent metabolism, and are able to replicate only within a host cell. The individual particles (i.e., virions) consist of nucleic acid and a protein shell or coat; some virions also have a lipid containing membrane. The term “virus” encompasses all types of viruses, including animal, plant, phage, and other viruses.

As used herein, the term “membrane receptors” refers to constituents of membranes that are capable of interacting with other molecules or materials. Such constituents can include, but are not limited to, proteins, lipids, carbohydrates, and combinations thereof.

As used herein, the term “macromolecule” refers to any large molecule such as proteins, polysaccharides, nucleic acids, and multiple subunit proteins. Examples of macromolecules include, but are not limited to verotoxin I, verotoxin II, Shiga-toxin, botulinum toxin, snake venoms, insect venoms, alpha-bungarotoxin, and tetrodotoxin).

As used herein, the term “carbohydrate” refers to a class of molecules including, but not limited to, sugars, starches, cellulose, chitin, glycogen, and similar structures. Carbohydrates can also exist as components of glycolipids and glycoproteins.

As used herein, the term “ligands” refers to any ion, molecule, molecular group, or other substance that binds to another entity to form a larger complex. Examples of ligands include, but are not limited to, peptides, carbohydrates, nucleic acids (e.g., DNA and RNA), antibodies, or any molecules that bind to receptors.

As used herein, the terms “head group” and “head group functionality” refer to the molecular groups present at the ends of molecules (e.g., the primary amine group at the end of peptides).

As used herein, the term “linker” or “spacer molecule” refers to material that links one entity to another. In one sense, a molecule or molecular group can be a linker that is covalently attached two or more other molecules (e.g., liking a ligand to a self-assembling monomer). As used herein, the term “linked” refers to any interactions, including chemical, electrical, electromagnetic, or otherwise, between atoms, molecules, compounds, or groups of these.

As used herein, the term “homobifunctional,” refers to a linker molecule with two functional groups that both react with the same chemical group (e.g., primary amines, esters or aledehydes).

As used herein, the term “hetrobifunctional,” refers to a linker molecule with two functional groups that react with different chemical groups (e.g., primary amines, esters or aledehydes).

As used herein, the term “bond” refers to the linkage between atoms in molecules and between ions and molecules in crystals. The term “single bond” refers to a bond with two electrons occupying the bonding orbital. Single bonds between atoms in molecular notations are represented by a single line drawn between two atoms (e.g., C₈-C₉). The term “double bond” refers to a bond that shares two electron pairs. Double bonds are stronger than single bonds and are more reactive. The term “triple bond” refers to the sharing of three electron pairs. As used herein, the term “ene-yne” refers to alternating double and triple bonds. As used herein the terms “amine bond,” “thiol bond,” and “aldehyde bond” refer to any bond formed between an amine group (i.e., a chemical group derived from ammonia by replacement of one or more of its hydrogen atoms by hydrocarbon groups), a thiol group (i.e., sulfur analogs of alcohols), and an aldehyde group (i.e., the chemical group —CHO joined directly onto another carbon atom), respectively, and another atom or molecule.

As used herein, the term “covalent bond” refers to the linkage of two atoms by the sharing of at least one electron, contributed by each of the atoms.

As used herein, the term “host cell” refers to any eukaryotic cell (e.g., mammalian cells, avian cells, amphibian cells, plant cells, fish cells, and insect cells), whether located in vitro or in vivo (e.g., in a transgenic organism or in a subject).

As used herein, the term “cell culture” refers to any in vitro culture of cells. Included within this term are continuous cell lines (e.g., with an immortal phenotype), primary cell cultures, finite cell lines (e.g., non-transformed cells), and any other cell population maintained in vitro, including oocytes and embryos.

As used herein, the term “genome” refers to the genetic material (e.g., chromosomes) of an organism or a host cell.

As used herein, the term “vector” refers to any genetic element, such as a plasmid, phage, transposon, cosmid, chromosome, retrovirus, virion, etc, which is capable of replication when associated with the proper control elements and which can transfer gene sequences between cells. Thus, the term includes cloning and expression vehicles, as well as viral vectors.

The term “nucleotide sequence of interest” refers to any nucleotide sequence (e.g., RNA or DNA), the manipulation of which may be deemed desirable for any reason (e.g., treat disease, confer improved qualities, etc), by one of ordinary skill in the art. Such nucleotide sequences include, but are not limited to, coding sequences, or portions thereof, of structural genes (e.g., reporter genes, selection marker genes, oncogenes, drug resistance genes, growth factors, etc), and non-coding regulatory sequences that do not encode an mRNA or protein product (e.g., promoter sequence, polyadenylation sequence, termination sequence, enhancer sequence, etc).

The term “gene” refers to a nucleic acid (e.g., DNA or RNA) sequence that comprises coding sequences necessary for the production of a polypeptide or precursor (e.g., proinsulin). The polypeptide can be encoded by a full length coding sequence or by any portion of the coding sequence so long as the desired activity or functional properties (e.g., enzymatic activity, ligand binding, signal transduction, etc) of the full-length or fragment are retained. The term also encompasses the coding region of a structural gene and includes sequences located adjacent to the coding region on both the 5′ and 3′ ends for a distance of about 1 kb or more on either end such that the gene corresponds to the length of the full-length mRNA. The sequences that are located 5′ of the coding region and which are present on the mRNA are referred to as 5′ untranslated sequences. The sequences that are located 3′ or downstream of the coding region and which are present on the mRNA are referred to as 3′ untranslated sequences. The term “gene” encompasses both cDNA and genomic forms of a gene. A genomic form or clone of a gene contains the coding region interrupted with non-coding sequences termed “introns” or “intervening regions” or “intervening sequences.” Introns are segments of a gene that are transcribed into nuclear RNA (hnRNA); introns may contain regulatory elements such as enhancers. Introns are removed or “spliced out” from the nuclear or primary transcript; introns therefore are absent in the messenger RNA (mRNA) transcript. The mRNA functions during translation to specify the sequence or order of amino acids in a nascent polypeptide.

As used herein, the term “exogenous gene” refers to a gene that is not naturally present in a host organism or cell, or is artificially introduced into a host organism or cell.

As used herein, the term “gene expression” refers to the process of converting genetic information encoded in a gene into RNA (e.g., mRNA, rRNA, tRNA, or snRNA) through “transcription” of the gene (i.e., via the enzymatic action of an RNA polymerase), and for protein encoding genes, into protein through “translation” of mRNA. Gene expression can be regulated at many stages in the process. “Up-regulation” or “activation” refers to regulation that increases the production of gene expression products (i.e., RNA or protein), while “down-regulation” or “repression” refers to regulation that decrease production. Molecules (e.g., transcription factors) that are involved in up-regulation or down-regulation are often called “activators” and “repressors,” respectively.

As used herein, the term “protein of interest” refers to a protein encoded by a nucleic acid of interest.

As used herein, the terms “nucleic acid molecule encoding,” “DNA sequence encoding,” “DNA encoding,” “RNA sequence encoding,” and “RNA encoding” refer to the order or sequence of deoxyribonucleotides or ribonucleotides along a strand of deoxyribonucleic acid or ribonucleic acid. The order of these deoxyribonucleotides or ribonucleotides determines the order of amino acids along the polypeptide (protein) chain translated from the mRNA. The DNA or RNA sequence thus codes for the amino acid sequence.

As used herein, the term “reporter gene” refers to a gene encoding a protein that may be assayed. Examples of reporter genes include, but are not limited to, luciferase (See, e.g., deWet et al., Mol. Cell. Biol., 7:725 [1987] and U.S. Pat. Nos. 6,074,859; 5,976,796; 5,674,713; and 5,618,682; all of which are incorporated herein by reference), green fluorescent protein (e.g., GenBank Accession Number U43284; a number of GFP variants are commercially available from CLONTECH Laboratories, Palo Alto, Calif.), chloramphenicol acetyltransferase, β-galactosidase, alkaline phosphatase, and horse radish peroxidase.

As used herein, the term “regulatory element” refers to a genetic element that controls some aspect of the expression of nucleic acid sequences. For example, a promoter is a regulatory element that facilitates the initiation of transcription of an operably linked coding region. Other regulatory elements are splicing signals, polyadenylation signals, termination signals, RNA export elements, internal ribosome entry sites, etc (defined infra).

Transcriptional control signals in eukaryotes comprise “promoter” and “enhancer” elements. Promoters and enhancers consist of short arrays of DNA sequences that interact specifically with cellular proteins involved in transcription (Maniatis et al., Science, 236:1237 [1987]). Promoter and enhancer elements have been isolated from a variety of eukaryotic sources including genes in yeast, insect and mammalian cells, and viruses (analogous control elements, i.e., promoters, are also found in prokaryotes). The selection of a particular promoter and enhancer depends on what cell type is to be used to express the protein of interest. Some eukaryotic promoters and enhancers have a broad host range while others are functional in a limited subset of cell types (for review See e.g., Voss et al., Trends Biochem. Sci., 11:287 [1986]; and Maniatis et al., supra). For example, the SV40 early gene enhancer is very active in a wide variety of cell types from many mammalian species and has been widely used for the expression of proteins in mammalian cells (Dijkema et al., EMBO J. 4:761 [1985]). Two other examples of promoter/enhancer elements active in a broad range of mammalian cell types are those from the human elongation factor 1 gene (Uetsuki et al., J. Biol. Chem., 264:5791 [1989]; Kim et al., Gene 91:217 [1990]; and Mizushima and Nagata, Nuc. Acids. Res., 18:5322 [1990]) and the long terminal repeats of the Rous sarcoma virus (Gorman et al., Proc. Natl. Acad. Sci. USA, 79:6777 [1982]) and the human cytomegalovirus (Boshart et al., Cell, 41:521 [1985]). In preferred embodiments, inducible retroviral promoters (e.g., the BLV promoter is utilized.

As used herein, the term “promoter/enhancer” denotes a segment of DNA which contains sequences capable of providing both promoter and enhancer functions (i.e., the functions provided by a promoter element and an enhancer element, see above for a discussion of these functions). For example, the long terminal repeats of retroviruses contain both promoter and enhancer functions. The enhancer/promoter may be “endogenous” or “exogenous” or “heterologous.” An “endogenous” enhancer/promoter is one that is naturally linked with a given gene in the genome. An “exogenous” or “heterologous” enhancer/promoter is one that is placed in juxtaposition to a gene by means of genetic manipulation (i.e., molecular biological techniques such as cloning and recombination) such that transcription of that gene is directed by the linked enhancer/promoter.

Promoters may be constitutive or regulatable. The term “constitutive” when made in reference to a promoter means that the promoter is capable of directing transcription of an operably linked nucleic acid sequence in the absence of a stimulus (e.g., heat shock, chemicals, etc). In contrast, a “regulatable” promoter is one that is capable of directing a level of transcription of an operably linked nucleic acid sequence in the presence of a stimulus (e.g., heat shock, chemicals, etc), which is different from the level of transcription of the operably linked nucleic acid sequence in the absence of the stimulus.

Regulatory elements may be tissue specific or cell specific. The term “tissue specific” as it applies to a regulatory element refers to a regulatory element that is capable of directing selective expression of a nucleotide sequence of interest to a specific type of tissue (e.g., mammillary gland) in the relative absence of expression of the same nucleotide sequence(s) of interest in a different type of tissue (e.g., liver).

Tissue specificity of a regulatory element may be evaluated by, for example, operably linking a reporter gene to a promoter sequence (which is not tissue-specific) and to the regulatory element to generate a reporter construct, introducing the reporter construct into the genome of an animal such that the reporter construct is integrated into every tissue of the resulting transgenic animal, and detecting the expression of the reporter gene (e.g., detecting mRNA, protein, or the activity of a protein encoded by the reporter gene) in different tissues of the transgenic animal. The detection of a greater level of expression of the reporter gene in one or more tissues relative to the level of expression of the reporter gene in other tissues shows that the regulatory element is “specific” for the tissues in which greater levels of expression are detected. Thus, the term “tissue-specific” (e.g., liver-specific) as used herein is a relative term that does not require absolute specificity of expression. In other words, the term “tissue-specific” does not require that one tissue have extremely high levels of expression and another tissue have no expression. It is sufficient that expression is greater in one tissue than another. By contrast, “strict” or “absolute” tissue-specific expression is meant to indicate expression in a single tissue type (e.g., liver) with no detectable expression in other tissues.

The term “cell type specific” as applied to a regulatory element refers to a regulatory element which is capable of directing selective expression of a nucleotide sequence of interest in a specific type of cell in the relative absence of expression of the same nucleotide sequence of interest in a different type of cell within the same tissue (e.g., cells infected with retrovirus, and more particularly, cells infected with BLV or HTLV). The term “cell type specific” when applied to a regulatory element also means a regulatory element capable of promoting selective expression of a nucleotide sequence of interest in a region within a single tissue.

The cell type specificity of a regulatory element may be assessed using methods well known in the art (e.g., immunohistochemical staining or Northern blot analysis). Briefly, for immunohistochemical staining, tissue sections are embedded in paraffin, and paraffin sections are reacted with a primary antibody specific for the polypeptide product encoded by the nucleotide sequence of interest whose expression is regulated by the regulatory element. A labeled (e.g., peroxidase conjugated) secondary antibody specific for the primary antibody is allowed to bind to the sectioned tissue and specific binding detected (e.g., with avidin/biotin) by microscopy. Briefly, for Northern blot analysis, RNA is isolated from cells and electrophoresed on agarose gels to fractionate the RNA according to size followed by transfer of the RNA from the gel to a solid support (e.g., nitrocellulose or a nylon membrane). The immobilized RNA is then probed with a labeled oligodeoxyribonucleotide probe or DNA probe to detect RNA species complementary to the probe used. Northern blots are a standard tool of molecular biologists.

A “subject” is an animal such as vertebrate, preferably a mammal, more preferably a human. Mammals, however, are understood to include, but are not limited to, murines, simians, humans, bovines, cervids, equines, porcines, canines, felines etc).

An “effective amount” is an amount sufficient to effect beneficial or desired results. An effective amount can be administered in one or more administrations.

As used herein, the term “administration” refers to the act of giving a drug, prodrug, or other agent (e.g., chemical agent) to a physiological system (e.g., a subject or cells in vivo or in vitro, and the like). Routes of administration to the human body can be through the eyes (ophthalmic), mouth (oral), skin (transdermal), nose (nasal), lungs (inhalant), oral mucosa (buccal), ear, by injection (e.g., intravenously, subcutaneously, intratumorally, intraperitoneally, etc) and the like.

“Coadministration” refers to administration of more than one agent or therapy to a subject. Coadministration may be concurrent or, alternatively, the chemical compounds described herein may be administered in advance of or following the administration of the other agent(s). One skilled in the art can readily determine the appropriate dosage for coadministration. When coadministered with another therapeutic agent, both the agents may be used at lower dosages. Thus, coadministration is especially desirable where the claimed compounds are used to lower the requisite dosage of known toxic agents.

As used herein, the term “toxic agent” refers to a material or mixture of materials which are themselves toxic to a biological system (e.g., pathogen, virus, bacteria, cell, or multicellular organism) or which upon a stimulus (e.g., light, or particles) produce an agent (e.g., singlet oxygen or free radical) which is toxic to a biological system. As used herein, the term “toxic” refers to any detrimental or harmful effects on a cell or tissue.

As used herein, the term “payload molecule,” refers in the broadest sense to any biologically active (or made to be active), or otherwise therapeutically, diagnostically, or pharmacologically useful compound. Payload molecules, or active portions thereof, can be linked to chemical address tag(s), or portion thereof. As used herein, the terms “therapeutic agent” therapeutic molecule,” “small molecule drug,” “small molecule therapeutic,” “drug,” “prodrug,” “anticancer drug,” “anticancer agent,” “proapoptotic agent [i.e., agents that promote apoptosis],” “agent that bind intracellular proteins [e.g., enzymes, structural proteins, etc],” and “agents that bind nucleic acids [e.g., siRNA, RNA, tRNA, mRNA, DNA, mDNA, antisense and sense nucleic acids, etc],” “imagining agents,” “diagnostic agents,” “antibiotics,” “antiviral agents,” “antifungal agents,” and the like, are exemplary “payload molecules.” “Chemical address tags” can be linked by chemical interactions to “payload molecules.”

As used herein, the term “drug” refers to a pharmacologically active substance or substances that are used to diagnose, treat, or prevent diseases or conditions. Drugs act by altering the physiology of a living organism, tissue, cell, or in vitro system that they are exposed to. It is intended that the term encompass antimicrobials, including, but not limited to, antibacterial, antifungal, and antiviral compounds. It is also intended that the term encompass antibiotics, including naturally occurring, synthetic, and compounds produced by recombinant DNA technology.

As used herein the term “prodrug” refers to a pharmacologically inactive derivative of a parent drug molecule that requires biotransformation (e.g., either spontaneous or enzymatic) within the organism to release, or to convert (e.g., enzymatically, mechanically, electromagnetically, etc) the prodrug into the active drug. Prodrugs are designed to overcome problems associated with stability, toxicity, lack of specificity, or limited bioavailability. In preferred embodiments, the prodrug comprises the active drug compound itself and a beneficial chemical masking group (e.g., one that reversible suppresses activity and/or appreciably reduces toxicity).

Preferred prodrugs are variations or derivatives of the compounds that have groups cleavable under metabolic conditions. For example, prodrugs become pharmaceutically active in vivo when they undergo solvolysis under physiological conditions or undergo enzymatic degradation or other biochemical transformation (e.g., phosphorylation, hydrogenation, dehydrogenation, glycosylation etc). Prodrugs often offer advantages of solubility, tissue compatibility, or delayed release in the mammalian organism. (See e.g., Bundgard, Design of Prodrugs, pp. 7-9, 21-24, Elsevier, Amsterdam [1985]; and Silverman, The Organic Chemistry of Drug Design and Drug Action, pp. 352-401, Academic Press, San Diego, Calif. [1992]). Common prodrugs include acid derivatives such as, esters prepared by reaction of parent acids with a suitable alcohol, amides prepared by reaction of the parent acid compound with an amine, or basic groups reacted to form an acylated base derivative. Moreover, the prodrug derivatives of this invention may be combined with other commonly known pharmacological molecules and reaction schemes to enhance bioavailability.

As used herein, the term “abzyme” refers to catalytic antibodies that catalyze a chemical reaction (e.g., conversion of a prodrug molecule into an active drug molecule).

A “pharmaceutical composition” is intended to include the combination of an active agent with a carrier, inert or active, making the composition suitable for diagnostic or therapeutic use in vivo, in vitro or ex vivo.

As used herein, the term “pharmaceutically acceptable carrier” encompasses any of the standard pharmaceutical carriers, such as a phosphate buffered saline solution, water, and an emulsion, such as an oil/water or water/oil emulsion, and various types of wetting agents. The compositions also can include stabilizers and preservatives. For examples of carriers, stabilizers and adjuvants see Martin, Remington's Pharmaceutical Sciences, Gennaro A R ed. 20th edition, 2000: Williams & Wilkins Pa., USA.

“Pharmaceutically acceptable salt” as used herein, relates to any pharmaceutically acceptable salt (acid or base) of a compound of the present invention which, upon administration to a recipient, is capable of providing a compound of this invention or an active metabolite or residue thereof. As is known to those of skill in the art, “salts” of the compounds of the present invention may be derived from inorganic or organic acids and bases. Examples of acids include hydrochloric, hydrobromic, sulfuric, nitric, perchloric, fumaric, maleic, phosphoric, glycolic, lactic, salicylic, succinic, toluene-p-sulfonic, tartaric, acetic, citric, methanesulfonic, ethanesulfonic, formic, benzoic, malonic, naphthalene-2-sulfonic and benzenesulfonic acid. Other acids, such as oxalic, while not in themselves pharmaceutically acceptable, may be employed in the preparation of salts useful as intermediates in obtaining the compounds of the invention and their pharmaceutically acceptable acid.

As used herein, the term “purified” or “to purify” refers to the removal of undesired components from a sample. As used herein, the term “substantially purified” refers to molecules that are removed from their natural environment, isolated or separated, and are at least 60% free, preferably 75% free, and most preferably 90% or greater free from other components with which they are naturally associated.

As used herein, the term “sample” is used in its broadest sense. In one sense, it is meant to include a specimen or culture obtained from any source, including biological and environmental samples. Biological samples may be obtained from animals (including humans) and encompass fluids, solids, tissues, and gases. Biological samples include blood products, such as plasma, serum and the like. Environmental samples include environmental material such as surface matter, soil, water, crystals, and industrial samples. These examples are not to be construed as limiting the present invention.

### GENERAL DESCRIPTION OF THE INVENTION

The present invention provides compositions (chemical address tags) and methods for directing the localization of small chemical molecules, pharmacophores, drug-like entities, and other organic and inorganic chemical species in cells and tissues, both in vivo and in vitro, and more particularly, to specific cellular and subcellular compartments within cells and tissues. The compositions and methods of the present invention can be used to generate libraries of supertargeted pharmaceutical agents with increased efficacy and decreased toxicity. In additional embodiments, the present invention provides chemical address tags, or portions thereof, associated with drug, prodrug, and other therapeutic agents.

In preferred embodiments, the invention provides compositions (e.g., chemical address tags) that target specific subcellular compartments. In particularly preferred embodiments, the compositions of the present invention promote or inhibit accumulation of a compound in selected subcellular compartments (e.g., mitochondria, endoplasmic reticulum, cytoplasm, vesicles, granules, nuclei and nucleoli and other subcellular organelles, compartments, and vesicles). The chemical address tags of the present invention are designed to incorporate various chemical functional groups useful for associating (e.g., chemical binding) the chemical address tag to one or more additional molecules (e.g., therapeutic agents, drugs, and small molecules). The present invention is not limited however to providing chemical address tags comprising any particular chemical function groups. For example, the present invention contemplates providing chemical address tags having various chemical functional groups, such as alkene, alkyne, arene, halide, hydroxyl, carbonyl, ether, amine, amide, nitrile, nitro, sulfide, sulfoxide, sulfone, thiol (sulfhydryl), aldehyde, ketone, ester, carboxylic acid (carboxyl), carboxylic acid halide, carboxylic acid anhydride, phosphate, and the like. Similarly, the chemical address tags of the present invention are not limited to association with other molecules by any one particular type of chemical bond; a number of types of chemical interactions (e.g., bonds) are contemplated, including, but not limited to, covalent, noncovalent, ionic, nonionic, single bond, double bond, triple bond, ene-yne, amine bond, amide, thiol bond, and aldehyde bonds.

In still other embodiments, the present invention provides methods for rationally designing and evaluating chemical address tags that promote or inhibit the entry of one or more molecules into specific subcellular loci such as organelles.

The present invention also provides libraries of chemical molecules optimized for entry into, or exclusion from, specific cellular and subcellular loci such as organelles. In some of these embodiments, the chemical libraries comprise molecules that are synthesized de novo; in other embodiments, the libraries comprise molecules that have been modified to include portions of one or more chemical address tags. Thus, in some embodiments, the present invention provides methods of modifying existing molecules, such as a drugs, prodrugs, and other therapeutic agents such that the ability of these molecules to enter or resist entering specific cellular and subcellular locations are enhanced or otherwise optimized.

In still further embodiments, the present invention provides methods for evaluating (e.g., qualitatively and quantitatively) the ability of chemical address tags, molecules associated with chemical address tags, and molecules modified to comprise portions of chemical address tags, to promote or inhibit entry of specific cellular and subcellular locations.

I. Cellular Level Targeting Moieties and Techniques

As used herein, the term “cellular level targeting moieties” refers to chemical moieties, and portions thereof, and to methods associated with using these moieties for targeting associated chemical compounds (e.g., drugs, prodrugs, small molecules, therapeutic agents, diagnostics, and imaging agents, and the like) to cells, tissues, and organs of interest. Cellular level targeting moieties may additionally promote the binding of the associated chemical compound an/or the entry of the compound into the cell membrane or cell wall of targeted cells, tissues, and organs. Preferably, cellular level targeting moieties are selected according to their specificity, affinity, and other related characteristics related to their targets. Similarly, as used herein, the term “subcellular level targeting moiety” refers to chemical moieties, or portion thereof, and to associated with using these moieties for promoting or inhibiting the accumulation of associated chemical compounds (e.g., drugs, prodrugs, small molecules, therapeutic agents, diagnostics, and imaging agents, and the like) in specific subcellular locations and organelles. Subcellular level targeting moieties include, but are not limited to, chemical address tags.

In some preferred embodiments, the chemical address tags of the present invention are associated with a molecule of interest (e.g., drug, prodrug, therapeutic agent, diagnostic agent, imaging agent, etc), optionally a cellular level targeting moiety (e.g., signal peptide, antibody, nucleic acid, toxin, etc), and optionally one or more other molecules (e.g., polyethylene glycol [PEG], protein transduction domain peptides [TAT], linker and spacer molecules, protecting groups, etc). In this regard, the chemical address tags of the present invention can be thought of as forming a part of a larger drug delivery composition or system.

In preferred embodiments of the present invention, cellular level targeting moieties are associated (e.g., covalently or noncovalently bound) to the other subcomponents/elements of the composition by short (e.g., direct coupling), medium (e.g., using small-molecule bifunctional linkers such as SPDP [Pierce Biotechnology, Inc., Rockford, Ill.]), or long (e.g., PEG bifunctional linkers [Nektar Therapeutics, Inc., San Carlos, Calif.]) chemical linkages. Preferably, the various chemical groups and agents of the drug delivery compositions are attached, fixed, or conjugated such that each entity therein is sufficiently free of steric hindrance (e.g., via connection through a suitable linker) such that its chemical or biological activity is at least partially retained.

The chemical address tags of the present invention can be incorporated into larger drug delivery compositions designed to bind one or more of a wide range biological targets including, but not limited to, diseased cells (e.g., tumor cells) and tissues, healthy cells and tissues, nucleic acids, including, intracellular nucleic acids (e.g., DNA, cDNA, RNA, mRNA, and siRNA), peptides (e.g., enzymes, cell surface proteins), cell surface proteins, cell surface receptors, cell surface polysaccharides, extracellular matrix proteins, intracellular proteins, and microorganism including pathogens (e.g., bacteria, fungi, mycoplasma, prions, and viruses).

A variety of cellular level targeting moieties are contemplated for use in association with the present compositions such as, nucleic acids (e.g., RNA and DNA), polypeptides (e.g., receptor ligands, signal peptides, avidin, Protein A, antigen binding proteins, etc), polysaccharides, biotin, hydrophobic groups, hydrophilic groups, drugs, and any organic molecules that bind to receptors. It is contemplated that the drug delivery compositions of the present invention display (e.g., be conjugated to) one, two, or a variety of cellular level targeting moieties. In some embodiments of the present invention, a plurality (i.e., ≧2) of cellular level targeting moieties are associated with the chemical address tags or compositions comprising chemical address tags. In some of these embodiments, the plurality of cellular level targeting moieties can be either similar (e.g. monoclonal antibodies) or dissimilar (e.g., distinct idiotypes or isotypes of antibodies, or an antibody and a nucleic acid, etc).

Utilization of more than one cellular level targeting moieties in a particular drug delivery composition allows multiple biological targets to be targeted or to the increase affinity for particular targets. Multiple cellular level targeting moieties also allow the drug delivery compositions to be “stacked,” wherein a first drug delivery composition is targeted to a biological target, and a second drug delivery composition is targeted to the cellular level targeting moieties on the first drug delivery composition. A number of specific yet exemplary cellular level targeting moieties are describe in more detail below.

A. General Cellular Level Targeting Considerations

Various efficiency issues affect the administration of all drugs—and highly cytotoxic drugs (e.g., cancer drugs) in particular. One issue of particular importance is ensuring that the administered agents affect only targeted cells (e.g., cancer cells). Many drug delivery systems lack sufficient specificity to target specific cells let alone certain subcellular locations within those cells. The unintended delivery of highly cytotoxic agents to nontargeted cells or nontargeted subcellular locations can cause serious toxicity issues.

Numerous efforts have been made to use devise-targeting schemes to address problems associated with nonspecific drug delivery. (See e.g., K. N. Syrigos and A. A. Epenetos Anticancer Res., 19:606-614 [1999]; Y. J. Park et al., J. Controlled Release, 78:67-79 [2002]; R. V. J. Chari, Adv. Drug Deliv. Rev., 31:89-104 [1998]; and D. Putnam and J. Kopecek, Adv. Polymer Sci., 122:55-123 [1995]). Conjugating targeting moieties such as antibodies and ligand peptides (e.g., RDG for endothelium cells) to drugs has been used to alleviate some the collateral toxicity issues associated with particular drugs. However, conjugating drugs to targeting moieties alone does not completely negate potential side effects to nontargeted cells, since the drugs are usually bioactivity on their way to target cells. However, advances in targeting moiety-prodrug conjugates, which are inactive while traveling to specific targeted tissues, have diminished some of these concerns.

A biotransformation, such as enzymatic cleavage, typically converts the prodrug into a biologically active molecule at the target site. Despite advances in the prodrug field, the effectiveness of many targeting moiety-prodrug conjugates is reduced by ineffective delivery of the drug/prodrug to targeted cells (described more fully infra) and by the lack of subcellular targeting mechanisms.

Accordingly, in some preferred embodiments the present invention provides targeting molecules (e.g., chemical address tags)-prodrug conjugates such that the therapeutic agent (e.g., the prodrug) remains inactive until reaching its target where it is subsequently converted into an active therapeutic drug molecule. Two exemplary prodrug delivery systems compatible with certain embodiments of the present invention are described below.

In one embodiment, the present invention uses the ADEPT system described by K. N. Syrigos and A. A. Epenetos, Anticancer Res., 19:606-614 (1999); and K. D. Bagshawe, Brit. J. Cancer, 56:531-532 (1987), which provides for the specific enzymatic conversion of the prodrug to the active parent drug at a target site. In yet another embodiment, the present invention contemplates using the ATTEMPTS system described by Y. J. Park et al., J. Controlled Release, 72:145-156 (2001); and Y. J. Park et al., J. Controlled Release, 78:67-79 (2002). The ATTEMPTS system converts proteases (e.g., t-PA) into prodrugs by blocking their catalytic site(s) with an appended macromolecule. The bioactive of the protease is restored at the target site by releasing the macromolecule blockage with the addition of a triggering agent. Preferred embodiments of the present incorporate prodrug delivery systems with the subcellular location specific chemical address tags of the present invention.

The rapid clearance of some types of therapeutic agents, especially water-soluble low molecular weight agents, from the subject's bloodstream is an additional consideration in drug targeting systems. Similarly, the effective targeting of peptide and nucleic acid agents (e.g., anticancer agents) is complicated by the agents' susceptibility to proteolytic degradation or potential immunogenicity.

In natural systems, clearance and other pharmacokinetic behaviors of small molecules (e.g., drugs) in a subject are regulated by a series of transport proteins. (See e.g., H. T. Nguyen, Clin. Chem. Lab. Anim., (2nd Ed.) pp. 309-335 [1999]; and G. J. Russell-Jones and D. H. Alpers, Pharm. Biotechnol., 12:493-520 [1999]). Thus, the pharmacokinetics of potential therapeutic agents is a consideration when designing chemical address tag conjugates or chemical address tag modifications to existing agents. The rate of agent clearance in a subject is typically manageable. For instance, attaching (e.g., binding) the agent to a macromolecular carrier normally prolongs its circulation and retention times. Accordingly, some embodiments of the present invention provide biomolecules (e.g., drugs) conjugated with polyethylene glycol (PEG), or similar biopolymers, to prevent degradation of the biomolecule and to improve their retention in the subject's bloodstream. (See e.g., R. B. Greenwald et al., Critical Rev. Therapeutic Drug Carrier Syst., 17:101-161 [2000]). PEG's ability to discourage protein-protein interactions reduces the immunogenicity of many conjugated biomolecule compositions.

Another issue affecting the administration of some therapeutic agents especially, hydrophilic and macromolecular drugs such as peptides and nucleic acids, is that these agents have difficulty crossing into target cellular membranes. Small (typically less than 1,000 Daltons) hydrophobic molecules are less susceptible to having difficulties entering target cell membranes. Moreover, low molecular weight cytotoxic drugs often localize more efficiently in normal tissues rather than in target tissues such as tumors (K. Bosslet et al., Cancer Res., 58:1195-1201 [1998]) due to the high interstitial pressure and unfavorable blood flow properties within rapidly growing tumors (R. K. Jain, Int. J. Radiat. Biol., 60:85-100 [1991]; and R. K. Jain and L. T. Baxter, Cancer Res., 48:7022-7032 [1998]).

In certain embodiments, the composition and methods of the present invention, especially those directed to delivering macromolecular agents, comprise a chemical address tag or an agent modified to incorporate at least a portion of a chemical address tag and one or more additional agents or administration techniques, including but not limited to, microinjection (See e.g., M. Foldvari and M. Mezei, J. Pharm. Sci., 80:1020-1028, [1991]), scrape loading (See e.g., P. L. McNeil et al., J. Cell Biol., 98:1556-1564 [1984]), electroporation (See e.g., R. Chakrabarti et al., J. Biol. Chem., 26:15494-15500 [1989]), liposomes (See e.g., M. Foldvari et al., J. Pharm. Sci., 80:1020-1028 [1991]), bacterial toxins (See e.g., T. I. Prior et al., Biochemistry, 31:3555-3559 [1992]; and H. Stenmark et al., J. Cell Biol., 113:1025-1032 [1991]), receptor-mediated endocytosis and phagocytosis (See e.g., I. Mellman, Annu. Rev. Cell Dev. Biol., 12:575-625 [1996]; C. P. Leamon and P. S. Low, J. Biol. Chem., 267 (35):24966-24971 [1992]; H. Ishihara et al., Pharm. Res., 7:542-546 [1990]; S. K. Basu, Biochem. Pharmacol., 40:1941-1946 [1990]; and G. Y. Wu and C. H. Wu, Biochemistry, 27:887-892 [1988]); and protein transduction domains (e.g., TAT).

The most preferred and widely used method for cellular level translocation of agents across membranes is receptor-mediated endocytosis. Receptor-mediated endocytosis relies upon the binding of antibodies (or ligands) to antigenic determinants (or receptors) on the surface of targeted cells to deliver conjugated agents. Internalization of the agents occurs via endocytosis. (See e.g., I. Mellman, Annul. Rev. Cell Dev. Biol., 12:575-625 [1996]).

One particular system of receptor-mediated endocytosis for cellular level targeting of therapeutic agents that is contemplated for use in certain embodiments of the present invention is the “TAP” (Tumor-Activated Prodrug) system. (R. V. J. Chari, Adv. Drug Deliv. Rev., 31:89-104 [1998]). In the TAP approach, small cytotoxic drugs are conjugated to tumor-specific antibodies via either a hydrolysable linkage (e.g., hydrozone or a peptide linker) that are cleavable by lysosomal peptidases. (See e.g., B. C. Laguzza et al., J. Med. Chem., 32:548-555 [1989]; A. Trouet, Proc. Natl. Acad. Sci. USA, 79:626-629 [1982]). In some instances, the conjugation of the drugs to macromolecular antibodies renders the drugs inactive while traveling to target cells. Once the conjugate binds to target cell's surface, the conjugated drug is internalized via endocytosis and subsequently released from the carrier by hydrolysis or enzymatic degradation of the linker, restoring its original therapeutic potency.

Another system for cellular level translocation of drugs across target cell membranes, involves conjugating the drug molecules to nanocarriers such as water-soluble polymers. Generally, this approach utilizes the “EPR” (Enhanced Permeation and Retention) effect for passive targeting and accumulation of polymer carriers in solid tumor tissues. (See e.g., H. Maeda et al, J. Controlled Release, 65:271-284 [2000]). During tumor angiogenesis, the nascent capillaries supplying nutrients to the tumor tissues posses large gaps between their vascular endothelial cells relative to healthy tissue types. This renders the tumor's nascent blood vessels permeable to macromolecules (>30 KDa), whereas capillaries in normal vascular tissue typically do not allow molecules to traverse. The macromolecules tend to collect in the interstitial space of tumors because the tumors lack a developed lymphatic drainage system. As these drug carriers accumulate, they can enter tumor cells via pinocytosis; a process that is also accelerated in rapidly growing tumor cells. This phenomenon is known as the EPR effect, and has been documented for a variety of polymers (H. Maeda et al., supra; and L. W. Seymour, Crit. Rev. Therapeu. Drug Carrier Systems, 9:135-187 [1992]) or other types of carriers such as liposomes (J. N. Moreira et al., Biochim Biophys Acta., 515:167-176 [2001]) as a passive means for targeting therapeutic agents to cancer cells. To further facilitate agent uptake, various types of targeting moieties have been attached to the nanocarriers. (See e.g., J. Kopecek et al., Eur. J. Pharm. Biopharm., 50:61-81 [2000]). Conjugation of PEG to the nanocarriers (e.g., stealth liposomes) may prolong agent circulation times for enhanced accumulation of these agents in target cells. (See e.g., J. N. Moreira et al., supra).

B. Antibody Cellular Level Targeting Moieties

In some embodiments of the present invention, the cellular level targeting moieties comprise antigen binding proteins or immunoglobulins (antibodies). Immunoglobulins can be generated to allow for the targeting of antigens or immunogens (e.g., tumor, tissue, or pathogen specific antigens) on various biological targets (e.g., pathogens, tumor cells, normal tissue). Such immunoglobulins include, but are not limited to polyclonal, monoclonal, chimeric, single chain, Fab fragments, and Fab expression libraries.

Immunoglobulins (antibodies) are proteins generated by the immune system to provide a specific molecule capable of complexing with an invading molecule commonly referred to as an antigen. Natural antibodies have two identical antigen-binding sites, both of which are specific to a particular antigen. The antibody molecule recognizes the antigen by complexing its antigen-binding sites with areas of the antigen termed epitopes. The epitopes fit into the conformational architecture of the antigen-binding sites of the antibody, enabling the antibody to bind to the antigen.

The immunoglobulin molecule is composed of two identical heavy and two identical light polypeptide chains, held together by interchain disulfide bonds. Each individual light and heavy chain folds into regions of about 110 amino acids, assuming a conserved three-dimensional conformation. The light chain comprises one variable region (termed V_{L}) and one constant region (C_{L}), while the heavy chain comprises one variable region (V_{H}) and three constant regions (C_{H}1, C_{H}2 and C_{H}3). Pairs of regions associate to form discrete structures. In particular, the light and heavy chain variable regions, V_{L} and V_{H}, associate to form an “F_{V}” area which contains the antigen-binding site.

The variable regions of both heavy and light chains show considerable variability in structure and amino acid composition from one antibody molecule to another, whereas the constant regions show little variability. Each antibody recognizes and binds an antigen through the binding site defined by the association of the heavy and light chain, variable regions into an F_{V} area. The light-chain variable region V_{L} and the heavy-chain variable region V_{H} of a particular antibody molecule have specific amino acid sequences that allow the antigen-binding site to assume a conformation that binds to the antigen epitope recognized by that particular antibody.

Within the variable regions are found regions in which the amino acid sequence is extremely variable from one antibody to another. Three of these so-called “hypervariable” regions or “complementarity-determining regions” (CDR's) are found in each of the light and heavy chains. The three CDRs from a light chain and the three CDRs from a corresponding heavy chain form the antigen-binding site.

Cleavage of naturally occurring antibody molecules with the proteolytic enzyme papain generates fragments that retain their antigen-binding site. These fragments, commonly known as Fab's (for Fragment, antigen binding site) are composed of the C_{L}, V_{L}, C_{H}1 and V_{H} regions of the antibody. In the Fab the light chain and the fragment of the heavy chain are covalently linked by a disulfide linkage.

Antibody fragments that contain the idiotype (antigen binding region) of the antibody molecule can be generated by known techniques. For example, such fragments include but are not limited to: the F(ab′)2 fragment that can be produced by pepsin digestion of the antibody molecule; the Fab′ fragments that can be generated by reducing the disulfide bridges of the F(ab′)2 fragment, and the Fab fragments that can be generated by treating the antibody molecule with papain and a reducing agent.

Various procedures known in the art are used for the production of polyclonal antibodies. For the production of antibody, various host animals can be immunized by injection with the peptide corresponding to the desired epitope including but not limited to rabbits, mice, rats, sheep, goats, etc In a preferred embodiment, the peptide is conjugated to an immunogenic carrier (e.g., diphtheria toxoid, bovine serum albumin (BSA), or keyhole limpet hemocyanin (KLH)). Various adjuvants are used to increase the immunological response, depending on the host species, including but not limited to Freund's (complete and incomplete), mineral gels such as aluminum hydroxide, surface active substances such as lysolecithin, pluronic polyols, polyanions, peptides, oil emulsions, keyhole limpet hemocyanins, dinitrophenol, and potentially useful human adjuvants such as BCG (Bacille Calmette-Guerin) and Corynebacterium parvum.

Monoclonal antibodies against target antigens (e.g., a cell surface protein such as a receptor) are produced by a variety of techniques including conventional monoclonal antibody methodologies such as the somatic cell hybridization techniques of Kohler and Milstein, Nature, 256:495 (1975). Although in some embodiments, somatic cell hybridization procedures are preferred, other techniques for producing monoclonal antibodies are contemplated as well (e.g., viral or oneogenic transformation of B lymphocytes).

In one embodiment, the preferred animal for preparing hybridomas is the mouse. Hybridoma production in the mouse is a well-established procedure. Immunization protocols and techniques for isolation of immunized splenocytes for fusion are known in the art. Fusion partners (e.g., murine myeloma cells) and fusion procedures are also known. In other preferred embodiments, avian (e.g., chickens) species are preferred for antibody production.

Human monoclonal antibodies (mAbs) directed against human proteins can be generated using transgenic mice carrying the complete human immune system rather than-the mouse system. Splenocytes from the transgenic mice are immunized with the antigen of interest which are used to produce hybridomas that secrete human mAbs with specific affinities for epitopes from a human protein. (See e.g., Wood et al., WO 91/00906, Kucherlapati et al., WO 91/10741; Lonberg et al., WO 92/03918; Kay et al., WO 92/03917 [each of which is herein incorporated by reference in its entirety]; N. Lonberg et al., Nature, 368:856-859 [1994]; L. L. Green et al., Nature Genet., 7:13-21 [1994]; S. L. Morrison et al., Proc. Nat. Acad. Sci. USA, 81:6851-6855 [1994]; Bruggeman et al., Immunol., 7:33-40 [1993]; Tuaillon et al., Proc. Nat. Acad. Sci. USA, 90:3720-3724 [1993]; and Bruggeman et al. Eur. J. Immunol., 21:1323-1326 [1991]).

Monoclonal antibodies can also be generated by other methods known to those skilled in the art of recombinant DNA technology. An alternative method, referred to as the “combinatorial antibody display” method, has been developed to identify and isolate antibody fragments having a particular antigen specificity, and can be utilized to produce monoclonal antibodies. (See e.g., Sastry et al., Proc. Nat. Acad. Sci. USA, 86:5728 [1989]; Huse et al., Science, 246:1275 [1989]; and Orlandi et al., Proc. Nat. Acad. Sci. USA, 86:3833 [1989]). After immunizing an animal with an immunogen as described above, the antibody repertoire of the resulting B-cell pool is cloned. Methods are available for obtaining DNA sequences of from the variable regions of a diverse population of immunoglobulin molecules using a mixture of oligomer primers and PCR. For instance, mixed oligonucleotide primers corresponding to the 5′ leader (signal peptide) sequences or framework 1 (FR1) sequences, as well as primer to a conserved 3′ constant region primer can be used for PCR amplification of the heavy and light chain variable regions from a number of murine antibodies. (See e.g., Larrick et al., Biotechniques, 11:152-156 [1991]). A similar strategy can also been used to amplify human heavy and light chain variable regions from human antibodies (See e.g., Larrick et al., Methods: Companion to Methods in Enzymology, 2:106-110 [1991]).

In one embodiment, RNA is isolated from B lymphocytes, for example, peripheral blood cells, bone marrow, or spleen preparations, using standard protocols (e.g., U.S. Pat. No. 4,683,292 [incorporated herein by reference in its entirety]; Orlandi, et al., Proc. Nat. Acad. Sci. USA, 86:3833-3837 [1989]; Sastry et al., Proc. Nat. Acad. Sci. USA, 86:5728-5732 [1989]; and Huse et al., Science, 246:1275 [1989]). First strand cDNA is synthesized using primers specific for the constant region of the heavy chain(s) and each of the and light chains, as well as primers for the signal sequence. Using variable region PCR primers, the variable regions of both heavy and light chains are amplified, each alone or in combination, and ligated into appropriate vectors for further manipulation in generating the display packages. Oligonucleotide primers useful in amplification protocols may be unique or degenerate or incorporate inosine at degenerate positions. Restriction endonuclease recognition sequences may also be incorporated into the primers to allow for the cloning of the amplified fragment into a vector in a predetermined reading frame for expression.

The V-gene library cloned from the immunization-derived antibody repertoire can be expressed by a population of display packages, preferably derived from filamentous phage, to form an antibody display library. Ideally, the display package comprises a system that allows the sampling of very large variegated antibody display libraries, rapid sorting after each affinity separation round, and easy isolation of the antibody gene from purified display packages. In addition to commercially available kits for generating phage display libraries, examples of methods and reagents particularly amenable for use in generating a variegated antibody display library can be found in, for example, U.S. Pat. No. 5,223,409; WO 92/18619; WO 91/17271; WO 92/20791; WO 92/15679; WO 93/01288; WO 92/01047; WO 92/09690; WO 90/02809 [each of which is herein incorporated by reference in its entirety]; Fuchs et al., Biol. Technology, 9:1370-1372 [1991]; Hay et al., Hum. Antibod. Hybridomas, 3:81-85 [1992]; Huse et al., Science, 46:1275-1281 [1989]; Hawkins et al., J. Mol. Biol., 226:889-896 [1992]; Clackson et al., Nature, 352:624-628 [1991]; Gram et al., Proc. Nat. Acad. Sci. USA, 89:3576-3580 [1992]; Garrad et al., Bio/Technology, 2:1373-1377 [1991]; Hoogenboom et al., Nuc. Acid Res., 19:4133-4137 [1991]; and Barbas et al., Proc. Nat. Acad. Sci. USA, 88:7978 [1991]. In certain embodiments, the V region domains of heavy and light chains can be expressed on the same polypeptide, joined by a flexible linker to form a single-chain Fv fragment, and the scFV gene subsequently cloned into the desired expression vector or phage genome.

As generally described in McCafferty et al., Nature, 348:552-554 (1990), complete V_{H} and V_{L} domains of an antibody, joined by a flexible linker (e.g., (Gly₄-Ser)₃) can be used to produce a single chain antibody which can render the display package separable based on antigen affinity. Isolated scFV antibodies immunoreactive with the antigen can subsequently be formulated into a pharmaceutical preparation for use in the subject method.

According to the invention, techniques described for the production of single chain antibodies (U.S. Pat. No. 4,946,778; herein incorporated by reference) can be adapted to produce specific single chain antibodies. An additional embodiment of the invention utilizes the techniques described for the construction of Fab expression libraries (Huse et al., Science, 246:1275-1281 [1989]) to allow rapid and easy identification of monoclonal Fab fragments with the desired specificity.

Once displayed on the surface of a display package (e.g., filamentous phage), the antibody library is screened with the target antigen, or peptide fragment thereof, to identify and isolate packages that express an antibody having specificity for the target antigen. Nucleic acid encoding the selected antibody can be recovered from the display package (e.g., from the phage genome) and subcloned into other expression vectors by standard recombinant DNA techniques.

Specific antibody molecules with high affinities for a surface protein can be made according to methods known to those in the art, e.g., methods involving screening of libraries U.S. Pat. No. 5,233,409 and U.S. Pat. No. 5,403,484 (both incorporated herein by reference in their entireties). Further, the methods of these libraries can be used in screens to obtain binding determinants that are mimetics of the structural determinants of antibodies.

Generally, in the production of antibodies, screening for the desired antibody can be accomplished by techniques known in the art (e.g., radioimmunoassay, ELISA (enzyme-linked immunosorbant assay), “sandwich” immunoassays, immunoradiometric assays, gel diffusion precipitin reactions, immunodiffusion assays, in situ immunoassays (using colloidal gold, enzyme or radioisotope labels, for example), Western Blots, precipitation reactions, agglutination assays (e.g., gel agglutination assays, hemagglutination assays, etc), complement fixation assays, immunofluorescence assays, protein A assays, and immunoelectrophoresis assays, etc).

In particular, the Fv binding surface of a particular antibody molecule interacts with its target ligand according to principles of protein-protein interactions, hence sequence data for V_{H} and V_{L} (the latter of which may be of the or chain type) is the basis for protein engineering techniques known to those with skill in the art. Details of the protein surface that comprises the binding determinants can be obtained from antibody sequence in formation, by a modeling procedure using previously determined three-dimensional structures from other antibodies obtained from NMR studies or crystallographic data.

In one embodiment, a variegated peptide library is expressed by a population of display packages to form a peptide display library. Ideally, the display package comprises a system that allows the sampling of very large variegated peptide display libraries, rapid sorting after each affinity separation round, and easy isolation of the peptide-encoding gene from purified display packages. Peptide display libraries can be in, e.g., prokaryotic organisms and viruses, which can be amplified quickly, are relatively easy to manipulate, and which allows the creation of large number of clones. Preferred display packages include, for example, vegetative bacterial cells, bacterial spores, and most preferably, bacterial viruses (especially DNA viruses). However, the present invention also contemplates the use of eukaryotic cells, including yeast and their spores, as potential display packages. Phage display libraries are know in the art.

Other techniques include affinity chromatography with an appropriate “receptor,” e.g., a target antigen, followed by identification of the isolated binding agents or ligands by conventional techniques (e.g., mass spectrometry and NMR). Preferably, the soluble receptor is conjugated to a label (e.g., fluorophores, colorimetric enzymes, radioisotopes, or luminescent compounds) that can be detected to indicate ligand binding. Alternatively, immobilized compounds can be selectively released and allowed to diffuse through a membrane to interact with a receptor.

Combinatorial libraries of compounds can also be synthesized with “tags” to encode the identity of each member of the library. (See e.g., W. C. Still et al., WO 94/08051, incorporated herein by reference in its entirety). In general, this method features the use of inert but readily detectable tags that are attached to the solid support or to the compounds. When an active compound is detected, the identity of the compound is determined by identification of the unique accompanying tag. This tagging method permits the synthesis of large libraries of compounds which can be identified at very low levels among to total set of all compounds in the library.

The term modified antibody is also intended to include antibodies, such as monoclonal antibodies, chimeric antibodies, and humanized antibodies which have been modified by, for example, deleting, adding, or substituting portions of the antibody. For example, an antibody can be modified by deleting the hinge region, thus generating a monovalent antibody. Any modification is within the scope of the invention so long as the antibody has at least one antigen binding region specific.

Chimeric mouse-human monoclonal antibodies can be produced by recombinant DNA techniques known in the art. For example, a gene encoding the Fc constant region of a murine (or other species) monoclonal antibody molecule is digested with restriction enzymes to remove the region encoding the murine Fc, and the equivalent portion of a gene encoding a human Fc constant region is substituted. (See e.g., Robinson et al., PCT/US86/02269; European Patent Application 184,187; European Patent Application 171,496; European Patent Application 173,494; WO 86/01533; U.S. Pat. No. 4,816,567; European Patent Application 125,023 [each of which is herein incorporated by reference in its entirety]; Better et al., Science, 240:1041-1043 [1988]; Liu et al., Proc. Nat. Acad. Sci. USA, 84:3439-3443 [1987]; Liu et al., J. Immunol., 139:3521-3526 [1987]; Sun et al., Proc. Nat. Acad. Sci. USA, 84:214-218 [1987]; Nishimura et al., Canc. Res., 47:999-1005 [1987]; Wood et al., Nature, 314:446-449 [1985]; and Shaw et al., J. Natl. Cancer Inst., 80:1553-1559 [1988]).

The chimeric antibody can be further humanized by replacing sequences of the Fv variable region which are not directly involved in antigen binding with equivalent sequences from human Fv variable regions. General reviews of humanized chimeric antibodies are provided by S. L. Morrison, Science, 229:1202-1207 (1985) and by Oi et al., Bio. Techniques, 4:214 (1986). Those methods include isolating, manipulating, and expressing the nucleic acid sequences that encode all or part of immunoglobulin Fv variable regions from at least one of a heavy or light chain. Sources of such nucleic acid are known and for example, may be obtained from 7E3, an anti-GPII_{b}IIIₐ antibody producing hybridoma. The recombinant DNA encoding the chimeric antibody, or fragment thereof, is then cloned into an appropriate expression vector.

Suitable humanized antibodies can alternatively be produced by CDR substitution (e.g., U.S. Pat. No. 5,225,539 (incorporated herein by reference in its entirety); Jones et al., Nature, 321:552-525 [1986]; Verhoeyan et al., Science, 239:1534 [1988]; and Beidler et al., J. Immunol., 141:4053 [1988]). All of the CDRs of a particular human antibody may be replaced with at least a portion of a non-human CDR or only some of the CDRs may be replaced with non-human CDRs. It is only necessary to replace the number of CDRs required for binding of the humanized antibody to the Fc receptor.

An antibody are humanized by any method that is capable of replacing at least a portion of a CDR of a human antibody with a CDR derived from a non-human antibody. The human CDRs may be replaced with non-human CDRs; using oligonucleotide site-directed mutagenesis.

Also within the scope of the invention are chimeric and humanized antibodies in which specific amino acids have been substituted, deleted or added. In particular, preferred humanized antibodies have amino acid substitutions in the framework region, such as to improve binding to the antigen. For example, in a humanized antibody having mouse CDRs, amino acids located in the human framework region can be replaced with the amino acids located at the corresponding positions in the mouse antibody. Such substitutions are known to improve binding of humanized antibodies to the antigen in some instances.

In preferred embodiments, the fusion proteins include a monoclonal antibody subunit (e.g., a human, murine, or bovine), or a fragment thereof, (e.g., an antigen binding fragment thereof). The monoclonal antibody subunit or antigen binding fragment thereof can be a single chain polypeptide, a dimer of a heavy chain and a light chain, a tetramer of two heavy and two light chains, or a pentamer (e.g., IgM). IgM is a pentamer of five monomer units held together by disulfide bonds linking their carboxyl-terminal (Cμ4/Cμ4) domains and Cμ3/Cμ3 domains. The pentameric structure of IgM provides 10 antigen-binding sites, thus serum IgM has a higher valency than other types of antibody isotypes. With its high valency, pentameric IgM is more efficient than other antibody isotypes at binding multidimensional antigens (e.g., viral particles and red blood cells. However, due to its large pentameric structure, IgM does not diffuse well and is usually found in low concentrations in intercellular tissue fluids. The J chain of IgM allows the molecule to bind to receptors on secretary cells, which transport the molecule across epithelial linings to the external secretions that bathe the mucosal surfaces. In some embodiments, of the present invention take advantage of the low diffusion rate of pentameric IgM to help concentrate the fusion proteins of present invention at a site of interest.

In some preferred embodiments, the monoclonal antibody is a murine antibody or a fragment thereof. In other preferred embodiments, the monoclonal antibody is a bovine antibody or a fragment thereof. For example, the murine antibody can be produced by a hybridoma that includes a B cell obtained from a transgenic mouse having a genome comprising a heavy chain transgene and a light chain transgene fused to an immortalized cell. The antibodies can be of the various isotypes, including, IgG (e.g., IgG1, IgG2, IgG3, IgG4), IgM, IgA1, IgA2, IgA_{sec}, IgD, of IgE. In some preferred embodiments, the antibody is an IgG isotype. In other preferred embodiments, the antibody is an IgM isotype. The antibodies can be full-length (e.g., an IgG1, IgG2, IgG3, or IgG4 antibody) or can include only an antigen-binding portion (e.g., a Fab, F(ab′)₂, Fv or a single chain Fv fragment).

In preferred embodiments, the immunoglobulin subunit of the fusion proteins is a recombinant antibody (e.g., a chimeric or a humanized antibody), a subunit or an antigen binding fragment thereof (e.g., has a variable region, or at least a complementarity determining region (CDR)).

In preferred embodiments, the immunoglobulin subunit of the fusion protein is monovalent (e.g., includes one pair of heavy and light chains, or antigen binding portions thereof). In other embodiments, the immunoglobulin subunit of the fusion protein is a divalent (e.g., includes two pairs of heavy and light chains, or antigen binding portions thereof). In preferred embodiments, the transgenic fusion proteins include an immunoglobulin heavy chain or a fragment thereof (e.g., an antigen binding fragment thereof).

In some preferred embodiments, the antibodies recognize tumor specific epitopes (e.g., TAG-72 (Kjeldsen et al., Cancer Res., 48:2214-2220 [1988]; U.S. Pat. Nos. 5,892,020; 5,892,019; and 5,512,443); human carcinoma antigen (U.S. Pat. Nos. 5,693,763; 5,545,530; and 5,808,005); TP1 and TP3 antigens from osteocarcinoma cells (U.S. Pat. No. 5,855,866); Thomsen-Friedenreich (TF) antigen from adenocarcinoma cells (U.S. Pat. No. 5,110,911); “KC-4 antigen” from human prostrate adenocarcinoma (U.S. Pat. Nos. 4,708,930 and 4,743,543); a human colorectal cancer antigen (U.S. Pat. No. 4,921,789); CA125 antigen from cystadenocarcinoma (U.S. Pat. No. 4,921,790); DF3 antigen from human breast carcinoma (U.S. Pat. Nos. 4,963,484 and 5,053,489); a human breast tumor antigen (U.S. Pat. No. 4,939,240); p97 antigen of human melanoma (U.S. Pat. No. 4,918,164); carcinoma or orosomucoid-related antigen (CORA) (U.S. Pat. No. 4,914,021); a human pulmonary carcinoma antigen that reacts with human squamous cell lung carcinoma but not with human small cell lung carcinoma (U.S. Pat. No. 4,892,935); T and Tn haptens in glycoproteins of human breast carcinoma (Springer et al., Carbohydr. Res., 178:271-292 [1988]), MSA breast carcinoma glycoprotein termed (Tjandra et al, Br. J. Surg., 75:811-817 [1988]); MFGM breast carcinoma antigen (Ishida et al., Tumor Biol., 10:12-22 [1989]); DU-PAN-2 pancreatic carcinoma antigen (Lan et al., Cancer Res., 45:305-310 [1985]); CA125 ovarian carcinoma antigen (Hanisch et al., Carbohydr. Res., 178:29-47 [1988]); YH206 lung carcinoma antigen (Hinoda et al., Cancer J., 42:653-658 [1988]). Each of the foregoing references are specifically incorporated herein by reference.

For breast cancer, the cell surface may be targeted with Mammastatin, folic acid, EGF, FGF, and antibodies (or antibody fragments) to the tumor-associated antigens MUC1, cMet receptor and CD56 (NCAM).

A very flexible method to identify and select appropriate peptide targeting groups is the phage display technique (See e.g., Cortese et al., Curr. Opin. Biotechol., 6:73 [1995]), which can be conveniently carried out using commercially available kits. The phage display procedure produces a large and diverse combinatorial library of peptides attached to the surface of phage, which are screened against immobilized surface receptors for tight binding. After the tight-binding, viral constructs are isolated and sequenced to identify the peptide sequences. The cycle is repeated using the best peptides as starting points for the next peptide library. Eventually, suitably high-affinity peptides are identified and then screened for biocompatibility and target specificity. In this way, it is possible to produce peptides that can be conjugated to dendrimers, producing multivalent conjugates with high specificity and affinity for the target cell receptors (e.g., tumor cell receptors) or other desired targets.

Related to the targeting approaches described above is the “pretargeting” approach (See e.g., Goodwin and Meares, Cancer (suppl.), 80:2675 [1997]). An example of this strategy involves initial treatment of the patient with conjugates of tumor-specific monoclonal antibodies and streptavidin. Remaining soluble conjugate is removed from the bloodstream with an appropriate biotinylated clearing agent. When the tumor-localized conjugate is all that remains, a gossypol-linked, biotinylated agent is introduced, which in turn localizes at the tumor sites by the strong and specific biotin-streptavidin interaction.

In other preferred embodiments, the antibodies recognize specific pathogens (e.g., Legionella peomophilia, Mycobacterium tuberculosis, Clostridium tetani, Hemophilus influenzae, Neisseria gonorrhoeae, Treponema pallidum, Bacillus anthracis, Vibrio cholerae, Borrelia burgdorferi, Cornebacterium diphtheria, Staphylococcus aureus, human papilloma virus, human immunodeficiency virus, rubella virus, polio virus, and the like).

C. Peptide Cellular Level Targeting Moieties

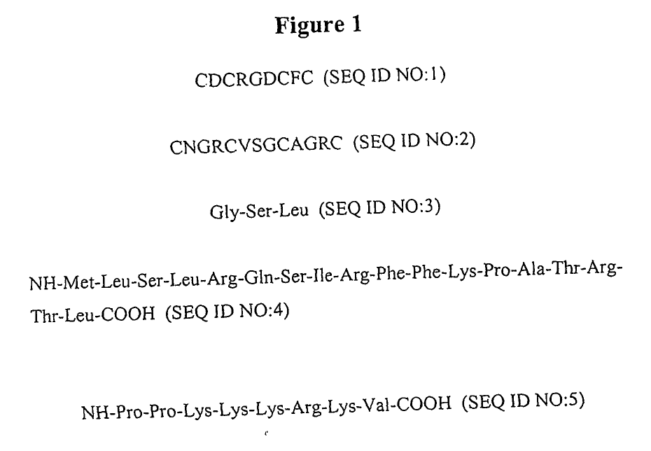

In some preferred embodiments, cellular level targeting moieties comprise peptides that bind specifically to tumor blood vessels. (See e.g., Arap et al., Science, 279:377-80 [1998]). These peptides include but are not limited to peptides containing the RGD (Arg-Gly-Asp) motif (e.g., CDCRGDCFC; SEQ ID NO:1) (FIG. 1), the NGR (Asn-Gly-Arg) motif (e.g., CNGRCVSGCAGRC; SEQ ID NO:2) (FIG. 1), and the GSL (Gly-Ser-Leu; SEQ ID NO:3) (FIG. 1) motif. These peptides and conjugates containing these peptides selectively bind to various tumors, including but not limited to, breast carcinomas, Karposi's sarcoma, and melanoma. It is not intended that the present invention be limited to particular mechanism of action. Indeed, an understanding of the mechanism is not necessary to make and use the present invention. However, it is believed that these peptides are ligands for integrins and growth factor receptors that are absent or barely detectable in established blood vessels. In some preferred embodiments, the peptide is preferably produced using chemical synthesis methods. For example, peptides can be synthesized by solid phase techniques, cleaved from the resin, and purified by preparative high performance liquid chromatography. (See e.g., Creighton (1983) Proteins Structures and Molecular Principles, W.H. Freeman and Co, New York, N.Y.). In other embodiments, the composition of the synthetic peptides is confirmed by amino acid analysis or sequencing.

In some preferred embodiments, cellular level targeting moieties comprise peptides that specifically bind to glioma cells. (See e.g. Debinski et al., Nature Biotech., 16:449-53 [1998]; Debinski et al., J. Biol. Chem., 270(28):16775-80 [1995]; and Debinski et al., J. Biol. Chem., 271(37):22428-33 [1996]). In some embodiments, the present invention contemplates using drug delivery compositions comprising IL13, or one of its variants, so that the drug delivery compositions bind to IL13 binding sites in glioma cells.

Human high-grade gliomas are uniquely enriched in IL13 binding sites. Many of the established brain tumor cell lines, primarily malignant gliomas, over-express hIL13 binding sites. Human malignant glioma cell lines express high number, up to 30,000, binding sites for hIL13 per cell. Of interest, glioblastoma multiforme (GBM) explant cells showed an extraordinary high number of hIL13 binding sites, up to 500,000 per cell. The binding of hIL13 is not neutralized by hIL4 on an array of established human glioma cell lines that includes U-251 MG, U-373 MG, DBTRG MG, Hs-683, U-87 MG, SNB-19, and A-172 cells. hIL13 can be engineered to increase its specific targeting of high-grade gliomas. The pattern for IL13- and IL4R sharing on normal cells requires IL13 to bind hIL4R. This is confirmed by the fact that hIL13 binding is always fully competed by hIL4. The recently proposed model for this hIL3R suggests that the shared hIL13/4R is heterodimeric. This scenario would imply that hIL13 may contain at least two receptor-binding sites, each recognizing a respective subunit of the receptor. The engineered hIL13 variants (e.g., hIL13.E13K or hIL13.E13Y) are deprived of cell signaling abilities. This is desirable because interaction with physiological systems contributes prominently to the dose-limiting toxicity of some biological therapeutics (e.g., cytokines). Significantly, the molecule of hIL13 appears not to be sensitive to a variety of genetically engineered modifications and these variants can be produced in large quantities. It is thus possible to divert the molecule of hIL13 from its physiological receptor and make it a non-signaling compound, while its discovery of the expression of IL13 receptors on the surface of all of the malignancies of glial origin provides a novel strategy for the accumulation and retention of drug delivery compositions within CNS cancers. The high-grade glioma-associated receptor for IL13 used in the present affinity toward the HGG-associated receptor remains intact or is increased. Such forms of IL13 can serve as rationally designed vectors for variety of imaging and therapeutic approaches of HGG.

Given the typically grim prognosis following the identification of an intracranial malignancy, any strategy for the pre-, intra- or post-operative identification and removal of cancer cells is a significant improvement. In some embodiments, nucleic acids encoding IL13 fragments, fusion proteins or functional equivalents or variants (e.g., hIL13.E13K or hIL13.E13Y) thereof are cloned into an appropriate expression vector, expressed and purified (e.g., preferably as described in Debinski et al., Nature Biotech., 16:449-53 [1998]; Debinski et al., J. Biol. Chem., 270(28):16775-80 [1995]; and Debinski et al., J. Biol. Chem., 271(37):22428-33 [1996]). In other embodiments of the present invention, vectors include, but are not limited to, chromosomal, nonchromosomal and synthetic DNA sequences, e.g., derivatives of SV40; bacterial plasmids; phage DNA; baculovirus; yeast plasmids; vectors derived from combinations of plasmids and phage DNA, viral DNA such as vaccinia, adenovirus, fowl pox virus, and pseudorabies. Large numbers of suitable vectors are known to those of skill in the art, and are commercially available. Such vectors include, but are not limited to, the following vectors: 1) Bacterial—pQE70: pQE60; pQE-9 (Qiagen, Inc., Valencia, Calif.); pBS; pD10; phagescript; psiX174; pbluescript SK; pBSKS; pNH8A; pNH16a; pNH18A; pNH46A (Stratagene, Inc., La Jolla, Calif.); ptrc99a; pKK223-3; pKK233-3; pDR540; pRIT5 (Pharmacia, Peapack, N.J.); and 2) Eukaryotic—pWLNEO; pSV2CAT; pOG44; PXT1; pSG (Stratagene); pSVK3; pBPV; pMSG; and pSVL (Pharmacia). Any other plasmid or vector can be used as long as they are replicable and viable in the host. In some preferred embodiments of the present invention, mammalian expression vectors comprise an origin of replication, a suitable promoter and enhancer, and any necessary ribosome binding sites, polyadenylation site, splice donor and acceptor sites, transcriptional termination sequences, and 5′ flanking nontranscribed sequences. In other embodiments, DNA sequences derived from the SV40 splice, and polyadenylation sites are used to provide the required nontranscribed genetic elements.

In other embodiments, the IL13 peptide or variant thereof is expressed in a host cell. In some embodiments of the present invention, the host cell is a higher eukaryotic cell (e.g., a mammalian or insect cell). In other embodiments of the present invention, the host cell is a lower eukaryotic cell (e.g., a yeast cell). In still other embodiments of the present invention, the host cell can be a prokaryotic cell (e.g., a bacterial cell). Specific examples of host cells include, but are not limited to, Escherichia coli, Salmonella typhimurium, Bacillus subtilis, and various species within the genera Pseudomonas, Streptomyces, and Staphylococcus, as well as, Saccharomyces cerevisiae, Schizosaccharomyces pombe, Drosophila S2 cells, Spodoptera Sf9 cells, Chinese Hamster Ovary (CHO) cells, COS-7 lines of monkey kidney fibroblasts, (Gluzman, Cell, 23:175 [1981]), C127, 3T3, HeLa and BHK cell lines.

In some embodiments of the present invention, IL13 or variants thereof are recovered or purified from recombinant cell cultures by methods including but not limited to ammonium sulfate or ethanol precipitation, acid extraction, anion or cation exchange chromatography, phosphocellulose chromatography, hydrophobic interaction chromatography, affinity chromatography, hydroxylapatite chromatography and lectin chromatography. In other embodiments of the present invention, protein refolding steps are used, as necessary, in completing configuration of the mature protein. In still other embodiments of the present invention, high performance liquid chromatography (HPLC) is employed for final purification steps.

Some embodiments of the present invention provide polynucleotides having the coding sequence fused in frame to a marker sequence that allows for purification of the polypeptide of the present invention. A non-limiting example of a marker sequence is a hexahistidine tag that is supplied by a vector, preferably a pQE-9 vector, that provides for purification of the polypeptide fused to the marker in the case of a bacterial host, or, for example, the marker sequence may be a hemagglutinin (HA) tag when a mammalian host (e.g., COS-7 cells) is used. The HA tag corresponds to an epitope derived from the influenza hemagglutinin protein (Wilson, et al., Cell, 37:767 [1984]).

D. Specific Signal Peptide Cellular Level Targeting Moieties

In some embodiments of the present invention, the cellular level targeting moieties comprise signal peptides. These peptides are chemically synthesized or cloned, expressed and purified as described above. Signal peptides can assist the chemical address tags of the present invention target the drug delivery composition (or a portion thereof) to discreet regions within a cell.

In some embodiments, the signal peptides aids in directing molecules into mitochondria. In some of these embodiments, the signal peptide is preferably: NH-Met-Leu-Ser-Leu-Arg-Gln-Ser-Ile-Arg-Phe-Phe-Lys-Pro-Ala-Thr-Arg-Thr-Leu-COOH (SEQ ID NO:4) (FIG. 1). The present invention is not limited to any particular mechanism, and an understanding of mechanisms is not necessary to make and use the present invention, however, it is contemplated that the peptide of SEQ ID NO:4 forms an amphipathic helix that associates with mitochondrial membrane protein import sites. This association allows peptides complexes to attach to mitochondrial membranes. It is unlikely that the complex is internalized, since there are few pores of nanometer size on intact mitochondria.

In still other embodiments, the following nuclear localization signal is utilized: NH-Pro-Pro-Lys-Lys-Lys-Arg-Lys-Val-COOH (SEQ ID NO:5) (FIG. 1).

In another embodiment, SNAP-25 antibodies (Affinity Bioreagents, Inc., Golden, Colo.), are used to deliver the drug delivery compositions to the presynaptic region of neuronal cells. The present invention is not limited to any particular mechanism, and an understanding of mechanisms is not necessary to make and use the present invention, however, it is contemplated that SNAP-25 is one of the prototypic v-SNARE proteins, and that SNAP-25 localizes specifically to the presynaptic terminals of neuronal cells and PC-12 cells. It is not known which portion of the peptide is responsible for sorting to the presynaptic terminal. During cellular processing of the peptide, SNAP-25 becomes palmitoylated at a central Cys-quartet. These palmitoylated groups help anchor the protein in the presynaptic membrane. SNAP-25 associates with syntaxin, and ultimately, with the entire vesicular fusion machinery in a calcium-activated presynaptic terminal.

E. Nucleic Acid Cellular Level Targeting Moieties

In some embodiments of the present invention, the cellular level targeting moieties comprise nucleic acids (e.g., RNA or DNA). In some embodiments, these nucleic acid moieties are designed to hybridize (by base pairing) to a particular nucleic acid (e.g., chromosomal DNA, mRNA, or ribosomal RNA) sequences in target cells and tissues. In other embodiments, the cellular level targeting moiety nucleic acids bind ligands or biological targets directly. Suitable nucleic acids that bind the following proteins have been identified: reverse transcriptase, REV and TAT proteins of HIV (Tuerk et al., Gene, 137(1):33-9 [1993]); human nerve growth factor (Binkley et al., Nuc. Acids Res., 23(16):3198-205 [1995]); and vascular endothelial growth factor (Jellinek et al., Biochem., 83(34):10450-6 [1994]). In some embodiments, suitable nucleic acids that bind ligands are identified using the SELEX procedure (U.S. Pat. Nos. 5,475,096; 5,270,163; 5,475,096; WO 97/38134; WO 98/33941; and WO 99/07724; all of which are herein incorporated by reference), although many additional methods are known in the art and are suitable in certain embodiments of the present invention.

F. Other Cellular Level Targeting Moieties

The cellular level targeting moieties of present compositions may recognize a variety of epitopes on biological targets (e.g., pathogens, tumor cells, normal tissues). In some embodiments, cellular level targeting moieties are incorporated to recognize, target, or detect a variety of pathogenic organisms including but not limited to sialic acid to target HIV (Wies et al., Nature, 333:426 [1988]), influenza (White et al., Cell, 56:725 [1989]), Chlamydia (Infect. Immunol, 57:2378 [1989]), Neisseria meningitidis, Streptococcus suis, Salmonella, mumps, newcastle, and various viruses, including reovirus, Sendai virus, and myxovirus; and 9-OAC sialic acid to target coronavirus, encephalomyelitis virus, and rotavirus; non-sialic acid glycoproteins to detect cytomegalovirus (Virology, 176:337 [1990]) and measles virus (Virology, 172:386 [1989]); CD4 (Khatzman et al., Nature, 312:763 [1985]), vasoactive intestinal peptide (Sacerdote et al., J. of Neuroscience Research, 18:102 [1987]), and peptide T Ruff et al., FEBS Letters, 211:17 [1987]) to target HIV; epidermal growth factor to target vaccinia (Epstein et al., Nature, 318: 663 [1985]); acetylcholine receptor to target rabies (Lentz et al., Science 215: 182 [1982]); Cd3 complement receptor to target Epstein-Barr virus (Carel et al., J. Biol. Chem., 265:12293 [1990]); -adrenergic receptor to target reovirus (Co et al., Proc. Natl. Acad. Sci. USA, 82:1494 [1985]); ICAM-1 (Marlin et al., Nature, 344:70 [1990]), N-CAM, and myelin-associated glycoprotein MAb (Shephey et al., Proc. Natl. Acad. Sci. USA, 85:7743 [1988]) to target rhinovirus; polio virus receptor to target polio virus (Mendelsohn et al., Cell, 56:855 [1989]); fibroblast growth factor receptor to target herpes virus (Kaner et al., Science, 248:1410 [1990]); oligomannose to target Escherichia coli; ganglioside G_{M1} to target Neisseria meningitidis; and antibodies to detect a broad variety of pathogens (e.g., Neisseria gonorrhoeae, V. vulnificus, V. parahaemolyticus, V. chlolerae, and V. alginolyticus, etc).

In some embodiments of the present invention, the cellular level targeting moieties also function as agents to identify particular tumors characterized by expressing a receptor for that moiety (ligand) binds with, for example, tumor specific antigens including, but are not limited to, carcinoembryonic antigen, prostate specific antigen, tyrosinase, ras, a sialyly lewis antigen, erb, MAGE-1, MAGE-3, BAGE, MN, gp100, gp75, p97, proteinase 3, a mucin, CD81, CID9, CD63; CD53, CD38, CO-029, CA125, GD2, GM2 and O-acetyl GD3, M-TAA, M-fetal or M-urinary all find use with certain embodiments of the present invention. Alternatively, the cellular level targeting moiety may be a tumor suppressor, a cytokine, a chemokine, a tumor specific receptor ligand, a receptor, an inducer of apoptosis, or a differentiating agent.

Tumor suppressor proteins contemplated for targeting include, but are not limited to, p16, p21, p27, p53, p73, Rb, Wilms tumor (WT-1), DCC, neurofibromatosis type 1 (NF-1), von Hippel-Lindau (VHL) disease tumor suppressor, Maspin, Brush-1, BRCA-1, BRCA-2, the multiple tumor suppressor (MTS), gp95/p97 antigen of human melanoma, renal cell carcinoma-associated G250 antigen, KS 1/4 pan-carcinoma antigen, ovarian carcinoma antigen (CA125), prostate specific antigen, melanoma antigen gp75, CD9, CD63, CD53, CD37, R2, CD81, C0029, TI-1, L6 and SAS. Of course, these are merely exemplary tumor suppressors. It is envisioned that the present invention may be used in conjunction with any other agent that is or becomes known to those of skill in the art as a tumor suppressor.

In preferred embodiments of the present invention, the compositions are targeted to factors expressed by oncogenes. These include, but are not limited to, tyrosine kinases, both membrane-associated and cytoplasmic forms, such as members of the Src family, serine/threonine kinases, such as Mos, growth factor and receptors, such as platelet derived growth factor (PDDG), SMALL GTPases (G proteins) including the ras family, cyclin-dependent protein kinases (cdk), members of the myc family members including c-myc, N-myc, and L-myc and bcl-2 and family members.

Receptors and their related ligands that find use in the context of certain embodiments of the present invention include, but are not limited to, the folate receptor, adrenergic receptor, growth hormone receptor, luteinizing hormone receptor, estrogen receptor, epidermal growth factor receptor, fibroblast growth factor receptor, and the like.

Hormones and their receptors that find use in the cellular level targeting aspects of the present invention include, but are not limited to, growth hormone, prolactin, placental lactogen, luteinizing hormone, follicle-stimulating hormone, chorionic gonadotropin, thyroid-stimulating hormone, leptin, adrenocorticotropin (ACTH), angiotensin I, angiotensin II, α-endorphin, α-melanocyte stimulating hormone (α-MSH), cholecystokinin, endothelin L galanin, gastric inhibitory peptide (GIP), glucagon, insulin, amylin, lipotropins, GLP-1 (7-37) neurophysins, and mammastatin, somatostatin.

In addition, the present invention contemplates that vitamins (both fat soluble and non-fat soluble vitamins) be used as cellular level targeting moieties to target biological targets (e.g., cells) that have receptors for, or otherwise take up these vitamins. Particularly preferred for this aspect of the invention are the fat soluble vitamins D, E, and A, and analogues thereof, and water soluble vitamin C.

II. Subcellular Level Targeting Compositions and Methods

The composition (e.g., chemical address tags) of the present invention influence the cellular and subcellular distribution of associated (e.g., attached) compounds. In preferred embodiments, the chemical address tags decrease the collateral toxicity results when certain therapeutic agents accumulate in unintended cellular, subcellular, and intracellular target sites. For toxic or potentially toxic compounds, chemical address tags divert the compounds from undesired sites.

In some embodiments, the present invention provides compositions and methods that effectively target chemical entities (e.g., therapeutic agents), to particular molecules such as kinases, receptors, or enzymes, without inhibiting other structurally related molecules or molecules that share similar mechanisms but have differential localization within the cell. Further embodiments provide methods for identifying chemical address tags used to influence a compound's cellular and subcellular distribution properties; consequently, preferred embodiments provide compositions that affect the pharmaceutical properties (e.g., efficacy, toxicity, pharmacokinetics, biodistribution, clearance, elimination and metabolism) of associated compounds.

While the present invention is not limited to any particular mechanism, it is contemplated that a compound's distribution may be controlled by introducing chemical groups that predictably inhibit the affinity of the compound for a particular organ or tissue, cell type, subcellular component or organelle, or by introducing other chemical groups that promote physicochemical interactions that serve to localize the compound to a specific organ, tissue, cell type, organelle or subcellular compartment. Localizing the compound to desired sites increases the efficacy of the compound and in many instances reduces dosing requirements or otherwise favorably alters the compound's pharmacological profile or biodistribution.

Despite an increased understanding of the localization of biochemical reactions within cells and the successful development of many potent agonists and antagonists of these reactions, traditional drug design strategies and lead optimization approaches have not addressed the problems associated with targeting drugs to particular organ or tissue by affecting its cellular or subcellular distribution and transport processes. Nevertheless, due to the compartmentalization of biochemical functions, the present compositions and methods for introducing chemical modifications that affect a compound's biodistribution at the cellular and subcellular level, enhance the compound's specificity and improve its biodistribution and pharmacokinetics at the organismic level.

In preferred embodiments, the compositions and methods of the present invention provide chemical address tags, and methods of modifying existing molecules to comprise portions of chemical address tags, that promote or inhibit the subcellular localization of compounds (e.g., drugs, therapeutic agents, imagining agents, toxicants, etc) in specific subcellular compartments. Other preferred embodiments provide methods for identifying chemical address tags, to analyze the subcellular localization of drugs and drug-like molecules comprising chemical address tags as well as methods for designing libraries of small molecules with controlled biodistribution and subcellular localizations properties. Still further embodiments provide methods for performing de novo predictions of the biodistribution of small molecule chemical entities.

Preferred embodiments of the present invention comprise sets of chemical structures known as chemical address tags, based on their ability to promote or inhibit the localization of small molecules to mitochondria, endoplasmic reticulum, nucleus, nucleolus, cytoplasmic vesicles, cytosol, and other intracellular and subcellular locations. In some preferred embodiments, the chemical address tags confer organelle-selective localization independent of other chemical functionalities, according to thermodynamic partitioning, binding affinity for different subcellular compartments, electrochemical potential, or other physical interactions driven by a Gibbs free energy difference or chemical potential of the localized versus unlocalized chemical address tag. In still some other embodiments directed to subcellular analysis, the chemical address tags are conjugated to a fluorescent scaffold that allows their subcellular localization to be characterized by high content screening.

In preferred embodiments, chemical address tags are identify using a novel quantitative structure-localization analysis strategy (QSLR) through which the ability of a specific chemical address tag to confer a specific localization is measured in terms of the predicted localization of a molecule and an attached chemical address tag. The QSLR approach is based on a statistical analysis strategy referred to as “factorial regression.” The QSLR strategies of the present invention provide quantitative analyses of the structure-localization relationships obtained from a combinatorial library of molecules and associated chemical address tags. Predications based on the QSLR strategy yield excellent fit with actual localization data, particularly, when a log transformation is applied to the localization data. In some embodiments, data generated using the QSLR strategy indicates that the additive decomposition model is consistent with thermodynamic physical models generally used to describe the binding, partitioning, or distribution of the molecules in association with other molecules, or in different phases or membrane bound compartments, based on the Gibbs free energy or chemical potential of the interaction between the chemical address tag and the localized subcellular component with which it interacts. In some embodiments, using the QSLR methods of the present invention, a measure of the affinity between the chemical address tag and a localized cellular component present in the organelle is obtained independently of an accurate or precise physical model, and is therefore amenable to identifying chemical address tags without necessarily relying on specific physical mechanisms to explain the compounds biodistribution properties.

Based on the molecular structure of the chemical address tags as well as certain calculated chemical features the present invention also provides methods for: 1) identifying a variety of chemical address tags that drive the accumulation of compounds towards and away from different organ or tissues by virtue of their affinity or lack of affinity for particular subcellular compartments; 2) predicting how a compound may localize within different organs, tissues, and cellular compartments and subcompartments based on the compounds chemical structure; and 3) identify suitable experimental systems that allow study of localization mechanisms at the subcellular level.

In some preferred embodiments, incorporating chemical address tags, or portions thereof, with fluorescent scaffolds suitable for constructing combinatorial libraries allows for probing the structure-localization relationships across a large variety of different compounds. These methods provide a means for analyzing the ability of various chemical groups to confer differential subcellular localization. The present invention is not limited however to incorporating potential chemical address tags onto fluorescent scaffolds. Indeed, other embodiments of the present invention incorporate potential chemical address tags with other detectable molecules (e.g., radioisotopes, chromophores, and the like) and other detection schemes (e.g., immunochemistry, spectroscopy, nucleic acid detection, and the like). In particularly preferred embodiments, regardless of the exact combination of chemical species (e.g., detectable scaffold molecule(s)), or the particular detection scheme used to render a target molecule detectable, the compositions and methods of the present invention provide tools to assess the localization conferred by specific chemical moieties (e.g., individual chemical address tags) or an aggregate of moieties including, but not limited to, chemical address tags.

The present invention further provides methods for developing libraries of compounds useful in variety of application, such as pharmaceutical screening, comprising chemical address tags that provide the compounds with specific subcellular localization.

III. Exemplary Therapeutic Agents and Drugs

The selection of possible components (e.g., chemical address tags, drugs, prodrugs, therapeutic agents, imagining agents, etc) for a particular purpose is influenced by a number of factors such as, the intended target cells or tissues, the intended target subcellular locations within those cells, biochemical considerations, the pharmacological profile of therapeutic agent(s) (e.g., drugs) being carried and delivered (e.g., efficacy, side affects, rate of clearance, bioaccumulation, biodistribution, potential interactions and the like), the subject's health, the method of administration (e.g., intravenous, oral, transdermal, etc), and various other factors known to those skilled in the chemical, biochemical, medical, and pharmaceutical arts. In some embodiments of the present invention, the compositions further comprises chemical elements that increase the bioavailability or effectiveness (e.g., uptake, cellular retention, potency, etc) of the therapeutic agents, prodrugs, or drugs after their entering target cells or subcellular locations within those cells.

A wide range of therapeutic agents and drugs can be used with the compositions of the present invention. As discussed herein, certain embodiments of the present invention comprise at least one chemical address tag, or a portion thereof, conjugated (e.g., through a chemical bond) to one or more additional similar or dissimilar agents, typically a drug, prodrug, or other therapeutic agent. The present invention is not limited however, to compositions comprising chemical address tags, or portions thereof, and drugs, prodrugs, and other therapeutic agents. Indeed, in other embodiments, the chemical address tags, and portions thereof, of the present invention are conjugated to a wide variety non-therapeutic molecules including, but not limited to, imagining agents (e.g., dyes) and diagnostic agents. More particularly, in some embodiments, the compositions additionally comprise polyvalent drug carrier elements (e.g., polytraxane), tracking elements (e.g., fluorescent molecules, radioactive molecules, magnetic particles, etc), selection or purification elements (e.g., ligands, antibodies, and the like), cytotoxic and cytostatic agents, antimicrobial agents (e.g., antibiotics, toxins, defensins, antiviral agents etc), chemical protecting groups, signal sequence elements (e.g., nuclear localization signal “NLS”) etc

In still other embodiments, the present invention provides drugs, prodrugs, therapeutic agents, and non-therapeutic molecules comprising chemical modifications incorporating at least one chemical address, and more preferably, portions of at least one chemical address tag.

In the broadest sense, any therapeutic agent, drug, or prodrugs that can be associated (e.g., attached to or coadministered) with the chemical address tags of the present invention are suitable for delivery by the compositions and methods of the present invention.

Preferred embodiments of the present invention provide subcellular specific targeting and delivery of effective amounts of at least one therapeutic agent, such as an anticancer agent including, but not limited to, conventional anticancer agents (e.g., chemotherapeutic drugs, radioactive molecules, etc).

Anticancer agents suitable for use with the present invention include, but are not limited to, agents that induce apoptosis, agents that induce nucleic acid damage, agents that inhibit nucleic acid synthesis, agents that affect microtubule formation, and agents that affect protein synthesis or stability, and the like.

A list of particular, however, exemplary anticancer agents suitable for use with the compositions and methods of the present invention include, but is not limited to: 1) alkaloids, including, microtubule inhibitors (e.g., Vincristine, Vinblastine, and Vindesine, etc), microtubule stabilizers (e.g., Paclitaxel [Taxol], and Docetaxel, etc), and chromatin function inhibitors, including, topoisomerase inhibitors, such as, epipodophyllotoxins (e.g., Etoposide [VP-16], and Teniposide [VM-26], etc), and agents that target topoisomerase I (e.g., Camptothecin and Isirinotecan [CPT-11], etc); 2) covalent DNA-binding agents [alkylating agents], including, nitrogen mustards (e.g., Mechlorethamine, Chlorambucil, Cyclophosphamide, Ifosphamide, and Busulfan [Myleran], etc), nitrosoureas (e.g., Carmustine, Lomustine, and Semustine, etc), and other alkylating agents (e.g., Dacarbazine, Hydroxymethylmelamine, Thiotepa, and Mitocycin, etc); 3) noncovalent DNA-binding agents [antitumor antibiotics], including, nucleic acid inhibitors (e.g., Dactinomycin [Actinomycin D], etc), anthracyclines (e.g., Daunorubicin [Daunomycin, and Cerubidine], Doxorubicin [Adriamycin], and Idarubicin [Idamycin], etc), anthracenediones (e.g., anthracycline analogues, such as, [Mitoxantrone], etc), bleomycins (Blenoxane), etc, and plicamycin (Mithramycin), etc; 4) antimetabolites, including, antifolates (e.g., Methotrexate, Folex, and Mexate, etc), purine antimetabolites (e.g., 6-Mercaptopurine [6-MP, Purinethol], 6-Thioguanine [6-TG], Azathioprine, Acyclovir, Ganciclovir, Chlorodeoxyadenosine, 2-Chlorodeoxyadenosine [CdA], and 2′-Deoxycoformycin [Pentostatin], etc), pyrimidine antagonists (e.g., fluoropyrimidines [e.g., 5-fluorouracil (Adrucil), 5-fluorodeoxyuridine (FdUrd) (Floxuridine)] etc), and cytosine arabinosides (e.g., Cytosar [ara-C] and Fludarabine, etc); 5) enzymes, including, L-asparaginase, and hydroxyurea, etc; 6) hormones, including, glucocorticoids, such as, antiestrogens (e.g., Tamoxifen, etc), nonsteroidal antiandrogens (e.g., Flutamide, etc), and aromatase inhibitors (e.g., anastrozole [Arimidex], etc); 7) platinum compounds (e.g., Cisplatin and Carboplatin, etc); 8) monoclonal antibodies conjugated with anticancer drugs, toxins, or radionuclides, etc; 9) biological response modifiers (e.g., interferons [e.g., IFN-γ, etc] and interleukins [e.g., IL-2, etc], etc); 10) adoptive immunotherapy; 11) hematopoietic growth factors; 12) agents that 45 induce tumor cell differentiation (e.g., all-trans-retinoic acid, etc); 13) gene therapy agents and techniques (e.g., siRNA, antisense and sense nucleic acids); 14) tumor vaccines; 15) therapies directed against tumor metastases (e.g., Batimistat, etc); and 16) angiogenesis inhibitors. For a more detailed description of therapeutic agents, including anticancer agents (e.g., actinomycin D and mitomycin C, platinum complexes, verapamil, podophyllotoxin, carboplatin, procarbazine, mechlorethamine, cyclophosphamide, camptothecin, ifosfamide, melphalan, chlorambucil, bisulfan, nitrosurea, adriamycin, dactinomycin, daunorubicin, doxorubicin, bleomycin, plicomycin, mitomycin, etoposide (VP16), tamoxifen, taxol, transplatinum, 5-fluorouracil, vincristine, vinblastin and methotrexate and other similar anticancer agents), those skilled in the art are referred to instructive manuals such as the Physician's Desk reference and to Goodman and Gilman's, Pharmaceutical Basis of Therapeutics, 10th ed., Hardman et al., Eds., 2001.

The administered agents can be prepared and used in combination therapeutic compositions, kits, or in combination with immunotherapeutic agents, as described herein.

In some preferred embodiments, the subject has a disease characterized by overexpression of proteins associated with aberrant cellular division or cell growth such as cancer. In some other embodiments, the subject has a disease characterized by aberrant angiogenic development.

In still other embodiments, the subject has a disease characterized by aberrant autoimmunity. As used herein, “aberrant” refers to biochemical or physiological occurrences in a subject that are indicative of a disease state (e.g., inflammation, autoimmunity, uncontrolled cell growth and proliferation, etc). The present invention is not limited however to providing treatments, including prophylaxis, for only the aforementioned disease states or aberrant conditions. Indeed, in other embodiments, the present compositions and methods target and deliver therapeutic agents, drugs, or prodrugs suitable for treating infections, conditions characterized by aberrant metabolic regulation (e.g., diabetes, hypertension, hyperthyroidism, etc), and other diseases and conditions.

In one preferred embodiment, the present invention provides compositions that deliver an effective amount of taxanes (e.g., Docetaxel) to a subject having a disease characterized by the overexpression of proteins indicative of abnormal cellular division or growth (e.g., anti-apoptotic proteins).

The taxanes (e.g., Docetaxel) are an effective class of anticancer chemotherapeutic agents. (See e.g., K. D. Miller and G. W. Sledge, Jr. Cancer Investigation, 17:121-136 [1999]). While the present invention is not intended to be limited to any particular mechanisms, taxane-mediated cell death is thought to proceed through intercellular microtubule stabilization and the subsequent induction of the apoptotic pathway. (See e.g., S. Haldar et al., Cancer Research, 57:229-233 [1997]).

In some other embodiments, the present invention provides compositions that effectively target and deliver two or more therapeutic agents, drugs, or prodrugs to target cells and tissues, and more preferably deliver these agents to particular subcellular locations. For example, in one embodiment, the present invention provides compositions that specifically target and deliver a combination of Cisplatin and Taxol to cancerous cells and tissues.

Cisplatin and Taxol have a well-defined action of inducing apoptosis in tumor cells. (See e.g., Lanni et al., Proc. Natl. Acad. Sci. USA, 94:9679 [1997]; Tortora et al., Cancer Research, 57:5107 [1997]; and Zaffaroni et al., Brit. J. Cancer, 77:1378 [1998]). Each agent is active against a wide range of tumor types including, but not limited to, breast cancer and colon cancer. (Akutsu et al., Eur. J. Cancer, 31A:2341 [1995]). However, treatment with these and many other chemotherapeutic agents is difficult without incurring significant toxicity. Taxol (Paclitaxel) shows excellent antitumor activity in a wide variety of tumor models such as the B16 melanoma, L1210 leukemias, MX-1 mammary tumors, and CS-1 colon tumor xenografts, however it is poorly water-soluble. The poor aqueous solubility of Paclitaxel presents a major problem for human administration. Current Paclitaxel formulations use cremaphors to increase the aqueous-solubility of the drug. The drug administered by infusing a cremaphor mixture diluted with large volumes of aqueous vehicle. Notably, direct administration (e.g., subcutaneous) of Paclitaxel results in local toxicity and low levels of drug activity. Certain embodiments of the present invention provide compositions that effectively target and deliver therapeutically promising, but potentially deleterious agents like Paclitaxel, only to targeted cells and tissues (e.g., cancer cells), and in particular deliver these agents to specific subcellular and intracellular locations.

Additional embodiments of the present invention provide methods to monitor the therapeutic outcome following administration of therapeutic agents (e.g., anticancer agent) to a subject. Measuring the ability of administered agents/drugs to induce a biological affect (e.g., induce apoptosis in vitro) provides an indication of in vivo efficacy. (See, Gibb, Gynecologic Oncology, 65:13 [1997]).

In some embodiments, the compositions of the present invention target one or more agents that cross-link nucleic acids (e.g., DNA) to facilitate DNA damage that leads to synergistic antineoplastic affects. In this regard, agents such as Cisplatin, and other DNA alkylating agents may be used. Cisplatin has been widely used to treat cancer, with efficacious doses used in clinical applications of about 20 mg/M² for 5 days every three weeks for a total of three courses.

Additional contemplated agents that damage DNA include, but are not limited to, compounds that interfere with DNA replication, mitosis, and chromosomal segregation (e.g., Adriamycin [Doxorubicin], Etoposide, Verapamil, Podophyllotoxin, and the like). These, and similar, compounds are widely used in clinical settings for the treatment of neoplasms; typically being administered through bolus intravenous injections at doses ranging from about 25-75 Mg/M² at 21 day intervals for Adriamycin, to about 35-50 Mg/M² for Etoposide given intravenously or double the intravenous dose orally.

Agents that disrupt the synthesis and fidelity of nucleic acid precursors and subunits also lead to DNA damage and find use as chemotherapeutic agents with the chemical address tags of the present invention. One suitable example of such agents is nucleic acid precursors. Agents such as 5-fluorouracil (5-FU) are preferentially used by neoplastic tissue, making 5-FU particularly attractive targeting to neoplastic cells. In preferred embodiments, the dose of 5-FU ranges from about 3 to 15 mg/kg/day, although other doses are possible with considerable variation according to various factors including stage of disease, amenability of the cells to the therapy, amount of resistance to the agents and the like.

In some embodiments, the therapeutic agent, drug, or prodrug is attached (e.g., conjugated) to a chemical address tag with a photocleavable linker. In this regard, Ottl et al. describes various heterobifunctional photocleavable linkers that find use with the present invention. (Ottl et al., Bioconjugate Chem., 9:143 [1998]). Suitable linkers are either water or organic soluble, and contain an activated ester that reacts with amines or alcohols and an epoxide that reacts with thiol groups. In between the ester and epoxide groups is a 3,4-dimethoxy6-nitrophenyl photoisomerization group. When the photoisomerization group is exposed to near-ultraviolet light (365 nm), the group releases the amine or alcohol in intact form. Thus, therapeutic agents when linked to the compositions of the present invention using such linkers, are released in a biologically active form upon exposure of the target area to near-ultraviolet light.

In an exemplary embodiment, the alcohol group of Taxol is reacted with the activated ester of the organic-soluble linker. This product in turn is reacted with the partially-thiolated surface of an appropriate dendrimer (the primary amines of the dendrimers can be partially converted to thiol-containing groups by reaction with a sub-stoichiometric amount of 2-iminothiolano). In the case of Cisplatin, the amino groups of the drug are reacted with the water-soluble form of the linker. If the amino groups are not reactive enough, a primary amino-containing active analog of Cisplatin, such as Pt(II) sulfadiazine dichloride can be used. (Pasani et al., Inorg. Chim. Acta; 80:99 [1983]; and Abel et al., Eur. J. Cancer, 9:4 [1973]). When the conjugate localizes within tumor cells it is exposed to laser light of the appropriate near-UV wavelength, causing the active drug to be released.

Similarly, in other embodiments of the present invention, the amino groups of Cisplatin (or an analog thereof) are linked to hydrophobic photocleavable protecting groups, such as the 2-nitrobenzyloxycarbonyl group. (See, Pillai, V. N. R. Synthesis: 1-26 [1980]). Exposing the conjugate to near-UV light (about 365 nm) cleaves the hydrophobic group leaving intact drug.

Enzyme cleavable linkers are an alternative to photocleavable linkers. Effective anti-tumor conjugates are prepared by attaching a therapeutic, such as Doxorubicin, to water-soluble polymers with appropriate short peptide linkers. (See e.g., Vasey et al, Clin. Cancer Res., 5:83 [1999]). The linkers are stable outside of the cell, but are cleaved by thiolproteases inside target cells; preferably, the chemical address tags then target the agent to specific subcellular locations. In a preferred embodiment, the conjugate PK1 is used. In some embodiments, enzyme-degradable linkers, such as Gly-Phe-Leu-Gly are used.

The present invention is not limited by the nature of the therapeutic technique. For example, other conjugates that find use with the present invention include, but are not limited to, using conjugated boron dusters for BNCT (Capala et al., Bioconjugate Chem., 7:7 [1996]), the use of radioisotopes, and conjugate comprising toxins such as ricin.

Various antimicrobial therapeutic agents are also suitable for targeting subcellular targeting using the compositions (chemical address tags) of the present invention. Any agent kills, inhibits, promotes stasis, or otherwise attenuates pathogenic (e.g., microbial) organisms are contemplated. Exemplary suitable antimicrobial agents include, but are not limited to, natural and synthetic antibiotics, antibodies, inhibitory proteins, antisense nucleic acids, membrane disruptive agents and the like, used alone or in combination. Indeed, any type of antibiotic may be used including, but not limited to, antibacterial agents, antiviral agents, antifungal agents, and the like.

Monoclonal and polyclonal antibodies also provide useful therapeutic agents in certain embodiments of the present invention. A well-studied antigen found on the surface of many cancers (including breast HER2 tumors) is glycoprotein p185, which is exclusively expressed in malignant cells (Press et al., Oncogene 5:953 [1990]). Recombinant humanized anti-HER2 monoclonal antibodies (rhuMabHER2) have even been shown to inhibit the growth of HER2 overexpressing breast cancer cells, and are being evaluated (in conjunction with conventional chemotherapeutics) in phase III clinical trials for the treatment of advanced breast cancer (Pegrarn et al., Proc. Am. Soc. Clin. Oncol., 14:106 [1995]). In additional embodiments, VEGF₁₂₁ and the anti-CD20 antibody C2B8 are also useful as therapeutic agents. The present invention is not limited to any particular antibody isotype; for example, certain embodiments of the present invention comprise IgG (e.g., IgG1, IgG2, IgG3, IgG4), IgM, IgA1, IgA2, IgA_{sec}, IgD, IgE, and the like.

In some embodiments of the present invention, the chemical address tag(s) and associated drugs, prodrugs, therapeutic agents, or non-therapeutic agents further comprise a multivalent molecule that binds, transports, and subsequently releases one or more molecules of aforementioned agent(s) at targeted cellular or subcellular site(s). For example, in some embodiments directed to delivering Doxorubicin to targeted cells and tissues, and more particularly to targeted subcellular locations (e.g., mitochondria), the compositions comprise a rotaxane or polyrotaxane molecule. However, the compositions of the present are limited to targeting Doxorubicin or to multivalent molecules such as polyrotaxane.

Polyrotaxanes are supermolecular assemblies of biocompatible and biodegradable molecular components. (See e.g., T. Ooya and N. Yui, Crit. Rev. Ther. Drug Carrier Syst., 16:289-330 [1999]). The “rotaxane” portion of the name comes from the Latin words for wheel and axel thus the term “polyrotaxane” refers to a molecular assembly of many cyclic molecules (e.g., cyclodextrin) threaded onto a linear polymer (e.g., PEG) chain. Bulky blocking groups (e.g., tyrosine) are often introduced at the ends to cap the polyrotaxane from dethreading. Typically, small drug molecules are linked to the abundant —OH groups on the cyclodextrin molecules by either hydrolysable (e.g., ester) or enzyme-cleavable (e.g., disulfide) bonds to allow for sustained release of the attached drugs.

There are two main types of polyrotaxanes, linear polyrotaxanes and comb-like or side-chain polyrotaxanes. There are numerous methods for producing linear and side-chain polyrotaxanes. Side chain polyrotaxanes may be produced by such methods as grafting in the presence of macrocyclic species, radical polymerization of preformed semi-rotaxanes, and threading grafted polymers and capping with end groups.

Polyrotaxanes are characterized by the mechanical bonding by which a plurality of component molecules interlocked such that the interlocked structure cannot fragment into component pieces without the breaking several covalent bonds. In some embodiments, polyrotaxane end caps are linked to the polyrotaxane core with cleavable linkages thus permitting the controlled dethreading of the polyrotaxane into its cyclodextrin and PEG constituents, both of which are biocompatible and can be cleared from the body assuming low molecular weight (e.g., about 3-5 kDa) PEG is used in the core of the polyrotaxane. (See e.g., T. Ooya supra; and J. Watanabe et al., J. Biomater. Sci. Edn., 10:1275-1288 [1999]).

In still further embodiments, PR-based compositions and methods of the present invention provide substantial EPR-induced accumulation and localization of small drugs at target cells and tissues (e.g., tumor sites).

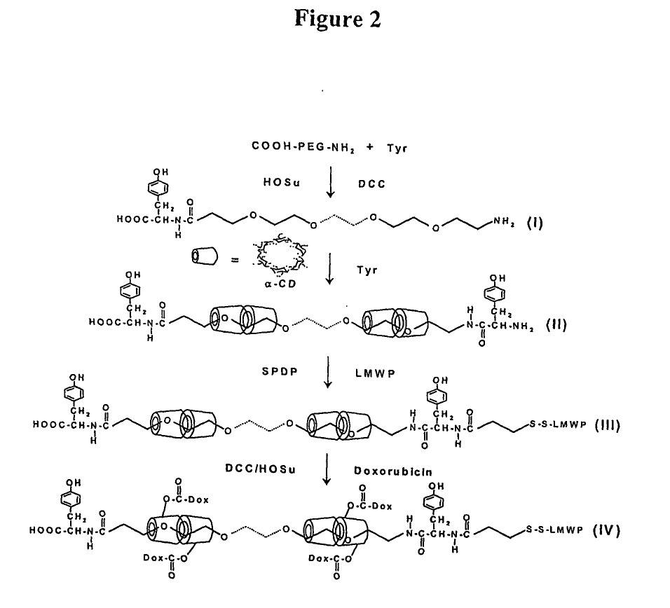

FIG. 2 provides a schematic illustration of the synthesis of one contemplated polyrotaxane containing hydrolysable doxorubicin drug delivery composition. First, the carboxyl terminal of heterofunctional PEG (H₂N-PEG-COOH; MW: 3,400 Da) is activated by N-hydroxy-succinimide (HOSu) to induce coupling with the —NH₂ group of tyrosine (Tyr; the bulky blocking end). The —NH₂ group of H₂N-PEG-COOH is blocked by di-tert-butyl carbonate (Boc) prior to the activation of the —COOH group to prevent PEG from intramolecular crosslinking. This terminal Boc is later removed by the addition of trifluroacetic acid (TFA). To the prepared PEG with the terminal Tyrosine bulky end (Product (I)) α-cyclodextrin (α-CD) is added. After incubation of the reaction mixture at room temperature for 2 days, the NH₂ end of PEG is capped by using carboxyl-activated tyrosine to prevent dethreading of α-CD from the PEG chain (Product (II)). Thereafter, the tyrosine bulky end is thiolated using the SPDP activation method and conjugated with a LMWP peptide thiolated at the N-terminal by using the same SPDP activation as described herein via a disulfide linkage (Product (III)). To incorporate doxorubicin onto polyrotaxane, the α-CD residues are activated using succinic anhydride and pyridine, and doxorubicin is linked to the activated α-CD via hydrolysable ester linkages (Product (IV)).

IV. Pharmaceutical Compositions and Administration Routes

The present invention provides novel compositions and methods comprising at least one chemical address tag or a portion thereof, and at least one drug, prodrug or therapeutic agent for treating a number of diseases in animals, preferably in mammalians, and even more preferably in humans. The present invention also provides novel compositions and methods comprising at least one drug, prodrug or therapeutic agent modified to incorporate at least one chemical address tag or a portion thereof. In this sense, the present invention is considered as providing pharmaceutical compositions (formulations), or drug delivery compositions.

In some embodiments, the pharmaceutical compositions of the present invention comprise pharmaceutical carriers including, but not limited to, any sterile biocompatible pharmaceutical carrier such as saline, buffered saline, dextrose, water, and the like. Accordingly, in some embodiments, the methods of the present invention comprise administering to a subject a pharmaceutical composition of the present invention in a suitable pharmaceutical carrier. In some embodiments, particular pharmaceutical compositions or therapies comprise a mixture of two or more different species of pharmaceutical composition.

In still further embodiments, the pharmaceutical compositions comprise a plurality of compositions administered to a subject under one or more of the following conditions: at different periodicities, different durations, different concentrations, or by different administration routes and the like.

In some preferred embodiments, the pharmaceutical compositions and methods of the present invention find use in treating diseases or altered physiological states characterized by pathogenic infection. However, the present invention is not limited to ameliorating (e.g., treating) any particular disease or infection. Indeed, various embodiments of the present invention are provided for treating (including prophylaxis) a range of physiological symptoms and disease etiologies in subjects including but limited to, those characterized by aberrant cellular growth or proliferation (e.g., cancer), autoimmunity (e.g., rheumatoid arthritis), and other aberrant biochemical, genetic, and physiological symptoms. Depending on the condition being treated, the pharmaceutical compositions are formulated and administered systemically or locally. Techniques for pharmaceutical formulation and administration are generally found in the latest edition of “Remington's Pharmaceutical Sciences” (Mack Publishing Co, Easton Pa.). Accordingly, the present invention contemplates administration of the pharmaceutical compositions in accordance with acceptable pharmaceutical delivery methods and preparation techniques.

In some embodiments of the present invention, pharmaceutical compositions are administered to a subject (patient) alone or in combination with one or more other drugs or therapies (e.g., antibiotics and antiviral agents, etc) or in compositions where they are mixed with excipients or other pharmaceutically acceptable carriers.

Generally, the pharmaceutical compositions of the present invention may be delivered via any suitable method, including, but not limited to, orally, intravenously, subcutaneously, intratumorally, intraperitoneally, or topically (e.g., to mucosal surfaces) agents that have undergone extensive testing and are readily available.

In some preferred embodiments, the pharmaceutical compositions of the present invention are formulated for parenteral administration, including intravenous, subcutaneous, intramuscular, and intraperitoneal. Some of these embodiments comprise a pharmaceutically acceptable carrier such as physiological saline. For injection, the pharmaceutical compositions are typically formulated in aqueous solution, preferably in physiologically compatible buffers (e.g., Hanks' solution, Ringer's solution, or physiologically buffered saline). For tissue or cellular administration, penetrants appropriate to the particular barrier to be permeated are also preferable. Such penetrants are well known in the art. Other embodiments use standard intracellular delivery (e.g., delivery via liposomes) techniques. Intracellular delivery methods are well known in the art. Administration of some agents to a patient's bone marrow may necessitate delivery in a manner different from intravenous injections. The therapeutic administration of some pharmaceutical compositions can also be done using gene therapy techniques described herein and commonly known in the art.

In other embodiments, active pharmaceutical compositions are prepared as oily injection suspensions. Suitable lipophilic solvents or vehicles include fatty oils such as sesame oil, or synthetic fatty acid esters, such as ethyl oleate or triglycerides, or liposomes. Aqueous injectable suspensions may additionally comprise substances that increase the viscosity of the suspension, such as sodium carboxymethyl cellulose, sorbitol, and dextran. Optionally, the injectable suspension may also comprise suitable stabilizers and agents that increase or prolong the solubility of the compounds thus allowing preparation of highly concentrated solutions.

In other embodiments, the present pharmaceutical compositions are formulated using pharmaceutically acceptable carriers in suitable dosages for oral administration. Suitable carriers enable the compositions to be formulated as tablets, pills, capsules, dragees, liquids, gels, syrups, slurries, suspensions and the like, for oral or nasal ingestion by a subject.

In some embodiments, pharmaceutical compositions for oral use are made by combining the active compounds (e.g., chemical address tag-therapeutic agent conjugates) with a solid excipient, optionally grinding the resulting mixture, and processing the mixture of granules, after adding suitable auxiliaries, if desired, so as to obtain tablets or dragee cores. Suitable excipients include, but are not limited: carbohydrate fillers such as sugars, including, lactose, sucrose, mannitol, or sorbitol; starch from corn, wheat, rice, potato; cellulose such as methyl cellulose, hydroxypropylmethyl-cellulose, or sodium carboxymethylcellulose; gums including arabic and tragacanth; and proteins such as gelatin and collagen. If desired, disintegrating or solubilizing agents may be added, such as cross-linked polyvinyl pyrrolidone, agar, alginic acid or a salt thereof such as sodium alginate.

Ingestible formulations of the present pharmaceutical compositions may further comprise any material approved by the United States Department of Agriculture (or other similar international agency) for inclusion in foodstuffs and substances that are generally recognized as safe (GRAS) such as, food additives, flavorings, colorings, vitamins, minerals, and phytonutrients. The term “phytonutrients” as used herein, refers to organic compounds isolated from plants that have a biological affect, and include, but are not limited to, compounds of the following classes: isoflavonoids, oligomeric proanthoyanidins, indol-3-carbinol, sulforaphone, fibrous ligands, plant phytosterols, ferulic acid, anthocyanocides, triterpenes, omega 3/6 fatty acids, polyacetylene, quinones, terpenes, catechins, gallates, and quercitin.

Preferably, dragee cores are provided with suitable coatings such as concentrated sugar solutions, which may contain gum arabic, talc, polyvinylpyrrolidone, carbopol gel, polyethylene glycol, titanium dioxide, lacquer solutions, and suitable organic solvents or solvent mixtures. Dyestuffs or pigments may be added to tablets or dragee coatings for product identification or to characterize the quantity of active compound, (i.e., dosage).

Orally formulated compositions of the present invention include, but are not limited to, push-fit capsules (e.g., those made of gelatin), and soft sealed capsules (e.g., those made of gelatin) optionally having a coating such as glycerol or sorbitol. Push-fit capsules may contain active ingredients mixed with fillers or binders such as lactose or starches, lubricants such as talc or magnesium stearate, and, optionally, stabilizers. In soft capsules, the active compounds may be dissolved or suspended in suitable liquids, such as fatty oils, liquid paraffin, or liquid polyethylene glycol, with or without stabilizers. In preferred embodiments, the pharmaceutically acceptable carriers are preferably pharmaceutically inert.

In preferred embodiments, the pharmaceutical compositions used in the methods of the present invention are manufactured according to well-known and standard pharmaceutical manufacturing techniques (e.g., by means of conventional mixing, dissolving, granulating, dragee-making, levigating, emulsifying, encapsulating, entrapping or lyophilizing processes).

Pharmaceutical compositions suitable for use in the present invention further include compositions wherein the active ingredient(s) is/are contained in an effective amount to achieve the intended purpose. A therapeutically effective dose refers to that amount of composition(s) that ameliorate symptoms of the disease state. For example, an effective amount of therapeutic compound(s) may be that amount that destroys or disables pathogens as compared to a control.

Preferred therapeutic agents, prodrugs, and drugs used in the pharmaceutical compositions of the present invention are those that retain their biological activity when associated, or coadministered, with the chemical address tags of the.

Dosing is dependent on severity and responsiveness of the disease state to be treated, with the course of treatment lasting from several days to several months, or until a cure is effected or a diminution of the disease state is achieved. Guidance as to particular dosing considerations and methods of delivery are provided in the literature (See, U.S. Pat. No. 4,657,760; 5,206,344; or 5,225,212, all of which are herein incorporated by reference in their entireties). Optimal dosing schedules are calculated from measurements of composition accumulation in the subject's body. The administering physician can easily determine optimum dosages, dosing methodologies and repetition rates. Optimum dosages may vary depending on the relative potency of compositions and can generally be estimated based on the EC₅₀ values found to be effective in in vitro and in vivo animal models. Additional factors that may be taken into account include, but are not limited to, the severity of the disease state the subject's age, weight, and gender; the subject's diet; the time and frequency of administration; combination(s) or agents or compositions; possible reaction sensitivities or allergies; and the subject's tolerance/response to prior treatments. In general, dosage is from 0.001 μg to 100 g per kg of body weight, and may be given once or more daily, weekly, monthly or yearly. The treating physician preferably estimates dosing repetition rates based on measured residence times and concentrations of the agents/drugs in the subject's fluids or tissues. Following successful treatment, it may be desirable to have the subject undergo maintenance therapy to prevent the recurrence of the disease state, wherein the therapeutic agent is administered in maintenance doses, ranging from 0.001 μg to 100 g per kg of body weight, once or more daily, weekly, or other period.

For any pharmaceutical composition used in the methods of the invention, the therapeutically effective dose can be estimated initially from cell culture assays. Then, preferably, dosage can be formulated in animal models (e.g., murine or rat models) to achieve a desirable circulating concentration range that results in increased PKA activity in cells/tissues characterized by undesirable cell migration, angiogenesis, cell migration, cell adhesion, or cell survival, and the like.

Toxicity and therapeutic efficacy of administered pharmaceutical compositions can be determined by standard pharmaceutical procedures in cell cultures or experimental animals, e.g., for determining the LD₅₀ (the dose lethal to 50% of the population) and the ED₅₀ (the dose therapeutically effective in 50% of the population). The dose ratio between toxic and therapeutic effects is the therapeutic index, and it can be expressed as the ratio LD₅₀/ED₅₀. Compounds that exhibit large therapeutic indices are preferred. The data obtained from cell culture assays and additional animal studies can be used in formulating a range of dosage, for example, mammalian use (e.g., humans). The dosage of such compounds lies preferably, however the present invention is not limited to this range, within a range of circulating concentrations that include the ED₅₀ with little or no toxicity.

### DETAILED DESCRIPTION OF THE INVENTION

The composition and methods of the present invention relate to the field of supertargeted chemistry. “Supertargeting” is a term coined by one of the inventors in a paper entitled “Supertargeted Chemistry: identifying relationships between molecular structures and their subcellular distribution.” (G. Rosania, Cur. Top. Med. Chem., 3:1-9 [1993]). The term refers to the study of the cellular and subcellular localization of molecules, and methods to direct these molecules to, or to exclude them from, specific subcellular compartments in living cells (e.g., in vivo and in vitro). More particularly, as used herein, the term refers to the compositions and methods to localize or exclude specific molecules (e.g., drugs, prodrugs, and other therapeutic agents) from specific organs, tissues, cells, or subcellular compartments, by modifying the molecule through association (e.g., conjugation) with at least a portion of chemical address tag, or through reengineering existing molecules (e.g., drugs, prodrugs, and other therapeutic agents) to incorporate at least a portion of chemical address tag. In some embodiments, the present invention uses techniques known in the fields of chemical engineering, organic and inorganic chemistry, and biochemistry to reengineer (e.g., rearrange bonds, add or subtract atoms, etc) existing molecules to incorporate chemical address tags.

The present invention provides bioinformational and experimental approaches for identifying chemical address tags and for predicting a compound's subcellular distribution. In some embodiments, the present invention provides methods based on QSLR analysis for determining a compound's cellular and subcellular localization characteristics and other pharmacological properties.

Libraries containing chemical address tags can be referred to as “supertargeted libraries”: collections of chemical entities (e.g., small molecule libraries) that are designed to accumulate in, or to be excluded from, specific organs, tissues, cells, and organelles within the cell. Libraries of supertargeted molecules are contemplated as being able to target cellular functions associated with any particular cellular subcompartment or location.

In preferred embodiments, a combinatorial library is used to identify and populate a database of chemical address tags by screening large combinations of chemical groups for specific functionalities that confer organelle-selective localization in the context of different molecular combinations. With combinatorial chemistry, very large collections of compounds are synthesized around a common chemical scaffold (e.g., fluorescent molecules such as styryl compounds), by incorporating different combinations of functional groups around such scaffold.

Because the localization of compounds within cells, and in particular at subcellular locations, are often difficult to determine, the analysis of the distribution characteristics of chemical address tagged molecules is not trivial. To overcome the difficulties associated with the analysis of the subcellular distribution characteristics of molecules, test compounds (e.g., chemical address tags or molecules conjugated to chemical address tags) are themselves conjugated to fluorescent molecules (fluorescent molecular scaffold), or are otherwise detectably labeled, such that the distribution of the test compounds inside the cell can be determined using imaging methods familiar to those skilled in the art.

The detectable label (fluorescent scaffold) may impart its own supertargeting characteristics on the test compound. Accordingly, the present invention contemplates that certain detectable labels and labeling methods are better suited for supertargeting studies. Thus, in preferred embodiments, for supertargeting purposes, a combinatorial library is ideally synthesized around a detectable molecular scaffold that allows easy determination of the cellular and subcellular distribution of test compounds thus providing an indication of compound's performance as a chemical address tag. In particularly preferred embodiments, the molecular scaffolds are selected to accommodate a variety of chemical functionalities.

In preferred embodiments, fluorescent supertargeted libraries are screened using high-content screening (HCS) techniques to determine their subcellular distribution characteristics. HCS techniques were originally developed to gather detailed information about the temporal-spatial dynamics of cell constituents and processes. HCS techniques currently play an important role in cell-based screening experiments for the identification and validation of drug candidates. HCS techniques are used to automate the extraction of fluorescence intensity and localization information derived from specific fluorescence-based reagents incorporated into cells attached to a substrate. (See e.g., K. A. Giuliano and D. L. Taylor, Curr. Opin. Cell Biol. 7(1):4-12 [1995]; K. A. Giuliano et al., Ann. Rev. Biophys. Biomol. Struct., 24:405-434 [1995]). In preferred embodiments, cells are analyzed using an imaging system that measures spatial as well as temporal dynamics. (See e.g., D. L. Farkas et al., Ann. Rev. Physiol. 55:785-817 [1993]; K. A. Giuliano et al., In Optical Microscopy for Biology. B. Herman and K. Jacobson (eds.), pp. 543-557, Wiley-Liss, New York, N.Y. [1990]; K. Hahn et al., Nature, 359(6397):736-738 [1992]; and A. Waggoner et al., Hum. Pathol. 27(5):494-502 [1996]). The present invention contemplates treating each cell as a test entity containing spatial and temporal information on the activities of labeled constituents therein.

HCS techniques can be performed on either fixed cells, using fluorescently labeled antibodies, biological ligands, or nucleic acid hybridization probes, and the like, or on live cells using such techniques as multicolor fluorescent indicators and biosensors. The choice of fixed or live cell screens depends on the specific cell-based assay required. The types of biochemical and molecular information available through fluorescence-based reagents applied to cells include ion concentrations, membrane potential, specific translocations, enzyme activities, gene expression as well as the information on the presence, amount, and pattern of metabolites, proteins, lipids, carbohydrates, and nucleic acid sequences. (WO 98/38490, incorporated herein by reference in its entirety; R. L. DeBiasio et al., Mol. Biol. Cell, 7(8):1259-1282 [1996]; K. A. Giuliano et al., Ann. Rev. Biophys. Biomol. Struct., 24:405-434 [1995]; and R. Heim and R. Y Tsien, Curr. Biol., 6(2):178-182 [1996]).

In one preferred embodiment, the present invention provides suitable fluorescent scaffolds based on styryl molecules. Styryl compounds normally have a lipophilic pyridinium or quinolinium cation molecule (A) linked to an aromatic functionality (B) via a 2-4, or more, carbon polymethine bridge. The electron structure of the aromatic systems at the ends of the molecule are conjugated through the bridge via the π-orbitals of carbon-carbon double bonds, thus making the molecule fluorescent. By studying the effects of combining different quinolinium or pyridinium derivatives with different aldehyde derivatives (e.g., A1, A2, A3 . . . A(n)×B1, B2, B3 . . . B(n)), a number of different aldehyde and pyridinium/quinolinium functionalities have been identified as chemical address tags. In preferred embodiments, the present invention provides chemical address tag identified using the methods of the present invention that promote or inhibit the accumulation of associated molecules in specific subcellular locations including, but not limited to, the endoplasmic reticulum, vesicles, cytoplasm, nuclei and nucleoli, or that enhance selective accumulation in a particular organelle by promoting exclusion from the other locations. The present invention also provides specific combinatorial libraries of styryl dyes that target specific subcellular locations, and in particular, that target mitochondria.

Additional exemplary embodiments of the present invention are set forth in more detail in the following sections: I. Preparation and evaluation of a combinatorial library of fluorescent styryl molecules; II. Exemplary combinatorial library of styryl molecules and analyses; and III. Preparation and evaluation of a combinatorial library of fluorescent styryl cell-permeable DNA sensitive dye molecules.

I. Preparation and Evaluation of a Combinatorial Library of Fluorescent Styryl Molecules

In preferred embodiments, the present invention provides supertargeted libraries of styryl dye compounds. Styryl dyes are a class of fluorescent lipophilic cations that provide mitochondria labeling agents and membrane voltage-sensitive probes of cellular structure and function. Because of the electrochemical potential across the mitochondrial inner membrane, lipophilic cationic styryl dyes accumulate in mitochondria according to the Nernst equation.

Microscopic imaging and flow cytometry applications often require fluorescent compounds that excite or emit in specific color ranges. However, the spectral properties and potential applications of existing combinatorial fluorescent libraries are limited. The present invention provides powerful combinatorial approaches for developing fluorescent libraries, and styryl libraries in particular, despite the difficulties associated with rationally designing compounds with specific emission wavelengths and high quantum yields. Particularly preferred embodiments of the present invention provide combinatorial wide-color range fluorescent toolboxes useful as organelle-specific probes. The present invention is not limited however to fluorescent chemical address tag compositions or to methods of determining the subcellular distribution of fluorescent chemical moieties.

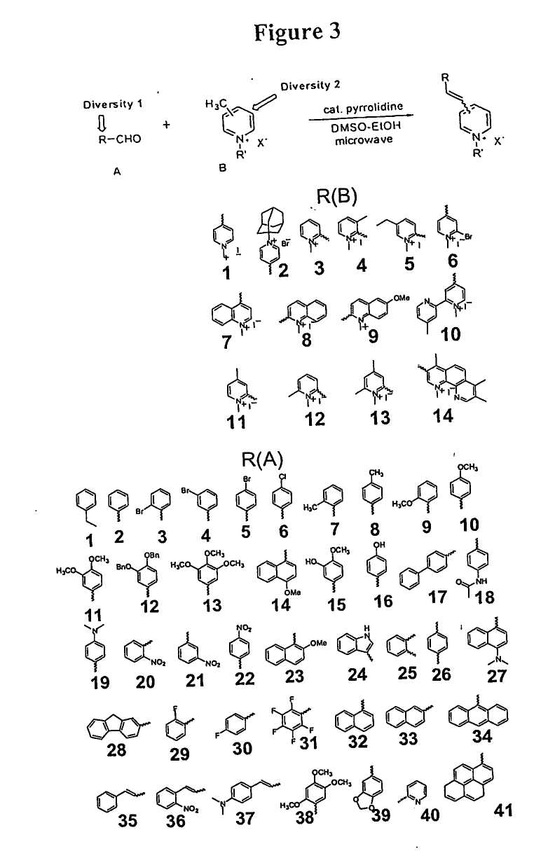

In one embodiment, a fluorescent combinatorial library is based on the styryl scaffold synthesized by the condensation of 41 aldehydes (A) and 14 pyridinium (2- or 4-methyl) salts (13) as described in Scheme 1. (FIG. 3). Example 1 provides additional information on the fabrication and evaluation of combinatorial libraries of fluorescent styryl molecules. The present invention is not limited to providing libraries of fluorescent styryl molecules, nor to constructing styryl libraries from the compounds disclosed in Scheme 1. In additional embodiments, various additional aldehyde and pyridinium/quinolinium molecules are contemplated for constructing additional styryl libraries. In still other embodiments, the present invention provides non-styryl based fluorescent libraries constructed from other molecules. The present invention contemplates that a wide variety of commercially available aldehyde and pyridinium/quinolinium molecules are suitable for constructing the styryl libraries of the present invention. For example, in one preferred embodiment, the present invention provides commercially available aldehydes (A) containing functionalities of various sizes, conjugation lengths, and electron-donating or -withdrawing capabilities; while the N-methylpyridinium iodide compounds (B) were synthesized by the methylation of commercially available 2- or 4-methylpyridine derivatives using methyl iodide. (See, D. J. Brown and N. W. Jacobsen, J. Chem. Soc., 3770-3778 [1965]).

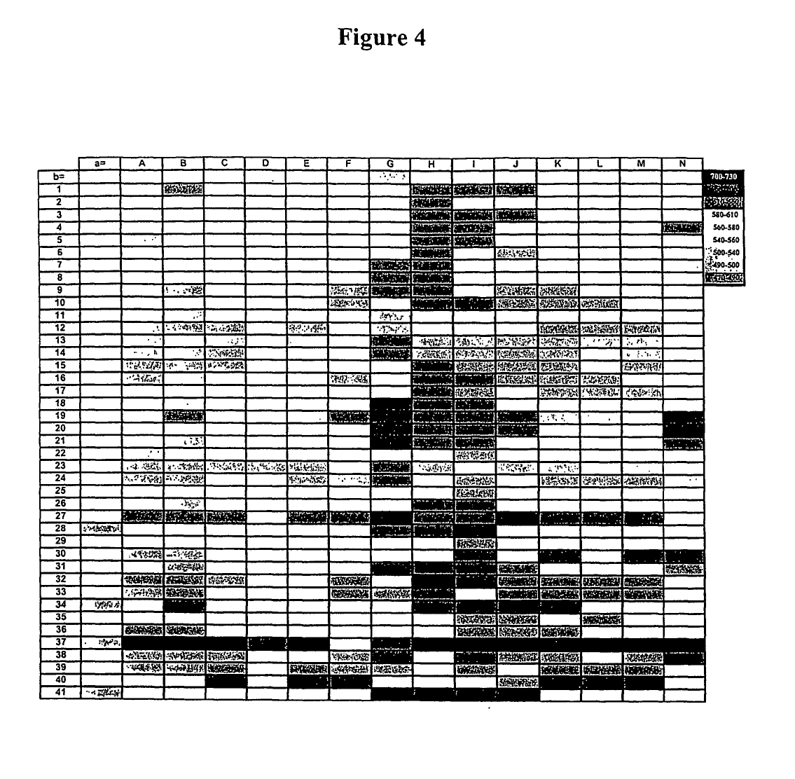

In one preferred embodiment, the condensation of A and B with a secondary amine catalysts was performed in 96-well plates, and the dehydration reaction was accelerated by microwave irradiation for 5 min to give 10-90% conversion. The resulting library was analyzed by LC-MS equipped with diode array and fluorescence detectors, and a fluorescence plate-reader to determine the absorption and emission maximum (ₑₓ and ₑₘ), and the emission colors are summarized in (FIG. 4). FIG. 4 shows the emission colors of the fluorescent compounds from the styryl dye library ([A] Components represent Building Block A; [B] Components represent Building Block B; row a is aldehyde only).

It can be easily visualized that this styryl dye library covers a broad range of colors from blue to long red, representing practically all the visible colors. The large range of colors represented in the styryl library is in part attributed to the structural diversity of the building blocks (A/B) of the styryl molecules. In preferred embodiments, further purification of the styryl molecules is not required for primary analysis, as the fluorescent properties of the products are easily distinguishable from those of left-over building blocks A and B (weak fluorescence or much shorter λₑₓ and λₑₘ).

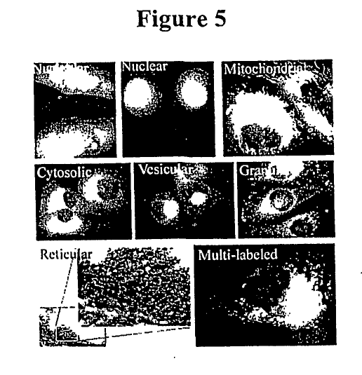

The synthesis was designed so that the reaction mixture can be used directly in biological screening; toxic catalysts (e.g., such as strong acids, bases, and metals) were avoided, and most of the low-boiling point solvents and catalysts (e.g., pyrrolidine) were removed during the microwave reaction, leaving only DMSO, a common solvent for biological sample preparation. In some embodiments, without further purification, the library compounds were incubated with live UACC-62 human melanoma cells growing on glass bottom 96-well plates, and the localizations of the different compounds in the cells were determined using an Axiovert (Carl Zeiss, Inc., Thornwood, N.Y.) microscope (λₑₓ=405, 490, and 570 nm; λₑₘ>510 nm) with a 100× Zeiss oil immersion objective. It was found that 119 out of 276 fluorescent compounds localized to specific subcellular compartments (e.g., mitochondria, ER [endoplasmic reticulum], vesicles, nucleoli, chromatin, cytoplasm, or granules, and in some cases combinations of two or more subcellular locations). The images in FIG. 5 show cells stained with selected fluorescent compounds. Briefly, FIG. 5 shows images of representative localizations (bar=10 μm); nucleolar (119); nuclear (H28); mitochondria (A12); cytosolic (137); vesicular (H12); granular (B41); reticular (J37); multilabeled: nucleolar (119, red), granular (34, blue), mitochondria (B24, green).

While the present invention is not limited to any particular mechanism, it is contemplated that since the compounds of the styryl library are positively charged, and since previous studies have established that there is large voltage between the inside of the mitochondria and the cytosol, and compounds with strong polarizability and charged compounds can interact strongly with the mitochondria membrane, it was expected that a number (e.g., 64 out of 119 selected compounds) of compounds localize specifically to mitochondria

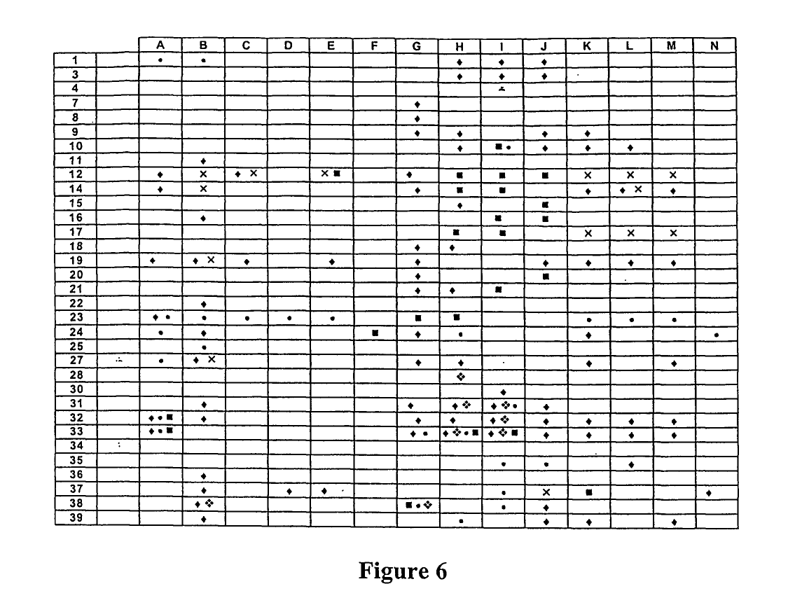

In some embodiments, the present invention provides compositions (e.g., chemical address tags) that localize in, or that are excluded from, targeted organelles other than mitochondria. Indeed, the present invention provides a general approach for selecting and testing a variety of compositions having encoded therein specific organelle and subcellular localization characteristics according to the diversity of the chemical structures used in the combinatorial approach. The present invention provides methods for creating molecules with encrypted structure-localization relationship (SLR) information, that provides for the rational design of molecular probes for cellular components with the ability for multicolor labeling (FIG. 6). FIG. 6 describes the localization distribution of the organelle specific styryl dyes ([#] Nuclear, [*] Nucleolar, [♦] Mitochondria, [●] Cytosolic, [x] Endoplasmic Reticular [ER], [▪] Vesicular, [▴] Granular; row a is aldehyde only).

Physical Models

According to some preferred embodiments of the present invention, a thermodynamic equilibrium binding model is applied to the quantitative analysis of structure-localization relationships obtained from the combinatorial library of molecules (e.g., styryl molecules) for quantitative analysis of structure-localization relationships. According to one model, a compound's localization to a particular organelle is determined independently through the binding interaction between both A and B moieties with one or more different cellular molecules localized to the organelle. With this analysis strategy, although the quinolinium or pyridinium moieties of styryl molecules may drive mitochondrial accumulation, selective accumulation in mitochondria appears to be determined by chemical groups that independently interact with mitochondria and are excluded from the other organelles.

While the present invention is not limited to any particular mechanism, and an understanding of particular mechanism is unnecessary to make and use the compositions and methods of the present invention, it is contemplated that thermodynamic considerations suggest several plausible mechanistic alternatives that might be able to account for the subcellular localization of the combinatorial library of compounds. According to an equilibrium binding model, localization of the dye is determined by the independent interactions of the different aldehyde and pyridinium/quinolinium functionalities with target molecule(s) localized to specific subcellular compartments. Based on this model, localization is determined according to the sum of the Gibb's free energy of the interaction between the aldehyde (B) and quinolinium/pyridinium group (A) and their corresponding target(s), such that:
ΔG(B(n):A(i))=ΔG(B(n))+ΔG(A(i)) (Equation 1)
Where B(n) refers to each aldehyde group represented in the library; A(i) refers to each pyridinium/quinolinium group; and B(n):A(i) refers to the specific styryl molecule resulting from the reaction of B(n) with A(i); G is the Gibbs free energy of the interaction between the indicated moiety or molecule and its subcellular target(s). Across the entire library, the simple thermodynamic model given by equation 1 applies if: 1) pyridinium/quinolinium groups do not affect the interaction of aldehyde group with its target and vice versa; and, 2) the interaction between the styryl molecules B(n):A(i) and the organelle is non-cooperative.

As an alternative, a mechanism whereby the localization of dye (B(n):A(i)) to a particular subcellular organelle is determined cooperatively can be considered. Cooperation may result if B and A bind to the same target (as in a multivalent interaction), or if engagement of B with its target facilitates the binding of A and vice versa. Yet another alternative model involves a direct interaction occurring between A and B, such that the chemical properties of B is influenced by A, or vice versa.

To relate the localization results to the thermodynamic model, it is contemplated that the localization of each styryl molecule (B(n):A(i)) to a particular organelle related to the Gibbs free energy of the interaction between the styryl molecule and the organelle, such that:
ΔG(B(n):A(i))=−RT ln P (Equation 2)
Where R is the gas constant, T is the absolute temperature, and P is a function that translates the difference in concentration of the dye between the organelle and its surroundings (as specified by the equilibrium constant K_{(B(n):A(i)))}) into a probability that the compound will be scored as being localized or not. Accordingly, if K is such that the compound is concentrated in a particular organelle relative to the rest of the cell:
P=f(K_{B(n):A(i)))}) (Equation 3)
Where K_{(B(n):A(i))} is the equilibrium constant given by the interaction of the styryl molecule with a localized target within the organelle. For a simple binding interaction between a styryl molecule (S) and a localized target T, the accumulation of the dye to a particular organelle is governed by the interaction:
S+T−>ST (Equation 4)
Such that K=[ST]/[S][T], or the equilibrium constant for the association. If the concentration of free dye [S] is constant, then P will be mostly a function of [ST] as determined by the amount concentration of the localized target [T] and the affinity between S and T.
Computational Methods

In some embodiments, the methods for quantitative structure localization relationship analysis are similar to the computational approaches used for rational drug design and for QSPR/QSAR studies. However, prior to the present invention, these approaches have not been applied to the localization of small molecules due to the lack of an appropriate theoretical and experimental strategy. In certain embodiments, according to QSAR-based compound optimization strategies of the present invention, compounds are screened on biochemical or cell based assays, and “hit” compound with the greatest “activity” are selected as starting point or “lead” for additional rounds of diversification and screening.

For organelle supertargeting, the screening of compounds offers an additional challenge in that the localization of compounds inside the cell may not be readily measurable. Thus, one must do without a truly quantitative biochemical assay to measure the localization of a compound to a specific cellular compartment, in the sense that one will not be able to find an IC₅₀ concentration (the concentration at which a compound effectively inhibits). Many times, localization can be quantified in a binary fashion wherein either the compound is localized to a particular subcellular compartment or not. Alternatively, a probability may be calculated that a particular compound is localized to a particular cellular compartment, based on multiple rounds of screening or localization of many cells in a population. Hence, one of the advantages of the present methods are their ability to analyze binary and probabilistic data obtained from a combinatorial library of compounds whose localization in the cells, tissues, or organs of an organism can be determined by semi-quantitative means.

Mitochondrial Localization Signals Encoded in the Chemical Structure of Small Molecules

While the study of subcellular targeting, transport, and translocation of proteins and other macromolecules is well-established, surprisingly little progress has been made in identifying relationships between the chemical structure of small molecules and their subcellular distribution. The present invention provides a quantitative structure-localization relationship (QSLR) strategy for discovering subcellular localization signals encoded in the chemical structures of small molecules. In applying the strategy to the localization of styryl molecules to mitochondria, it was found that intracellular localization is determined by independent additive affinities of the two chemical moieties bridged by the central carbon-carbon double bond of the styryl molecule. This discovery suggests the existence of localization signals encoded in the chemical structure of the different chemical moieties analyzed, and allows calculation of mitochondrial affinity values. The QSLR/library methods of the present invention provide fundamental experimental and analytical techniques for relating physicochemical properties of compounds to their subcellular distribution. The methods of the present invention complement functional genomic efforts aimed at establishing the relationships between protein localization and function, and enable the rational design of therapeutic agents with controlled, subcellular biodistribution properties.

In some embodiments, the present invention facilitates the quantitative study of structure localization relationships for small molecules, by pursuing an empirical strategy of fabrication of a combinatorial library of styryl molecules constructed by coupling two chemical building blocks (an A group and a B group) conjugated carbon bridge (FIG. 3). Although the building blocks themselves are not fluorescent, the styryl products often are fluorescent and cell permeable, hence their subcellular localization can be determined experimentally as described herein. It was reasoned that if building blocks Aᵢ and Bⱼ are observed in a sufficiently large set of pairs (Aᵢ,Bⱼ), and if the building blocks do not interact so as to influence each other's affinity for a particular subcellular compartment, a probabilistic deconvolution technique may be used to assign affinity levels to the individual moieties Aᵢ and Bⱼ based on experimental determination of the subcellular localization of the coupled pairs (Aᵢ,Bⱼ).

In some additional embodiments, a matrix, as shown in Table 1, is used to represent binary localizations of all (Aᵢ,Bⱼ) combinations as mitochondrial or non-mitochondrial.

TABLE 1

| | | 3 | 7 | 4 | 12 | 13 | 5 | 11 | 2 | 1 | 10 | 8 | 14 | 9 | 6 |
|---|---|---|---|---|---|---|---|---|---|---|---|---|---|---|---|
| | | 4.2 | 3.5 | 3.0 | 2.7 | 2.5 | 2.3 | 2.1 | 2.0 | 1.9 | 0.8 | 0.4 | 0.1 | −2.0 | −5.0 |
| 2 | 5.0 | 9.2 | 8.5 | 8.0 | 7.7 | 7.5 | 7.3 | 7.1 | 7.0 | 6.9 | 5.8 | 5.4 | 5.1 | 3.0 | 0.0 |
| 3 | 5.0 | 9.2 | 8.5 | 8.0 | 7.7 | 7.5 | 7.3 | 7.1 | 7.0 | 6.9 | 5.8 | 5.4 | 5.1 | 3.0 | 0.0 |
| 3 | 5.0 | 9.2 | 8.5 | 8.0 | 7.7 | 7.5 | 7.3 | 7.1 | 7.0 | 6.9 | 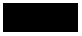 | 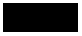 | 5.1 | 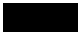 | 0.0 |
| 5 | 5.0 | 9.2 | 8.5 | 8.0 | 7.7 | 7.5 | 7.3 | 7.1 | 7.0 | 6.9 | 5.8 | 5.4 | 5.1 | 3.0 | 0.0 |
| 6 | 5.0 | 9.2 | 8.5 | 8.0 | 7.7 | 7.5 | 7.3 | 7.1 | 7.0 | 6.9 | 5.8 | 5.4 | 5.1 | 3.0 | 0.0 |
| 7 | 5.0 | 9.2 | 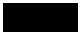 | 8.0 | 7.7 | 7.5 | 7.3 | 7.1 | 7.0 | 6.9 | 5.8 | 5.4 | 5.1 | 3.0 | 0.0 |
| 8 | 5.0 | 9.2 | 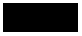 | 8.0 | 7.7 | 7.5 | 7.3 | 7.1 | 7.0 | 6.9 | 5.8 | 5.4 | 5.1 | 3.0 | 0.0 |
| 9 | 5.0 | 9.2 | 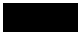 | 8.0 | 7.7 | 7.5 | 7.3 | 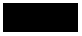 | 7.0 | 6.9 | 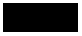 | 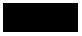 | 5.1 | 3.0 | 0.0 |
| 11 | 5.0 | 9.2 | 8.5 | 8.0 | 7.7 | 7.5 | 7.3 | 7.1 | 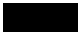 | 6.9 | 5.8 | 5.4 | 5.1 | 3.0 | 0.0 |
| 13 | 5.0 | 9.2 | 8.5 | 8.0 | 7.7 | 7.5 | 7.3 | 7.1 | 7.0 | 6.9 | 5.8 | 5.4 | 5.1 | 3.0 | 0.0 |
| 22 | 5.0 | 9.2 | 8.5 | 8.0 | 7.7 | 7.5 | 7.3 | 7.1 | 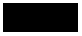 | 6.9 | 5.8 | 5.4 | 5.1 | 3.0 | 0.0 |
| 26 | 5.0 | 9.2 | 8.5 | 8.0 | 7.7 | 7.5 | 7.3 | 7.1 | 7.0 | 6.9 | 5.8 | 5.4 | 5.1 | 3.0 | 0.0 |
| 29 | 5.0 | 9.2 | 8.5 | 8.0 | 7.7 | 7.5 | 7.3 | 7.1 | 7.0 | 6.9 | 5.8 | 5.4 | 5.1 | 3.0 | 0.0 |
| 30 | 5.0 | 9.2 | 8.5 | 8.0 | 7.7 | 7.5 | 7.3 | 7.1 | 7.0 | 6.9 | 5.8 | 5.4 | 5.1 | 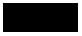 | 0.0 |
| 31 | 5.0 | 9.2 | 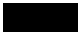 | 8.0 | 7.7 | 7.5 | 7.3 | 7.1 | 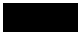 | 6.9 | 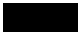 | 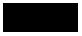 | 5.1 | 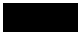 | 0.0 |
| 32 | 5.0 | 9.2 | 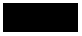 | 8.0 | 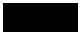 | 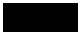 | 7.3 | 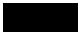 | 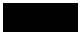 | 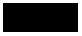 | 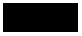 | 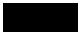 | 5.1 | 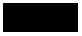 | 0.0 |
| 33 | 5.0 | 9.2 | 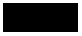 | 8.0 | 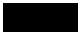 | 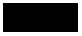 | 7.3 | 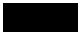 | 7.0 | 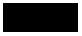 | 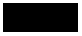 | 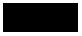 | 5.1 | 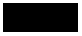 | 0.0 |
| 34 | 5.0 | 9.2 | 8.5 | 8.0 | 7.7 | 7.5 | 7.3 | 7.1 | 7.0 | 6.9 | 5.8 | 5.4 | 5.1 | 3.0 | 0.0 |
| 36 | 5.0 | 9.2 | 8.5 | 8.0 | 7.7 | 7.5 | 7.3 | 7.1 | 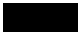 | 6.9 | 5.8 | 5.4 | 5.1 | 3.0 | 0.0 |
| 10 | 1.3 | 5.4 | 4.8 | 4.2 | 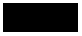 | 3.8 | 3.5 | 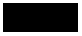 | 3.3 | 3.2 | 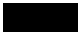 | 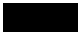 | 1.3 | −0.8o | −3.7 |
| 18 | 0.8 | 5.0 | 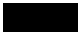 | 3.8 | 3.6 | 3.4 | 3.1 | 2.9 | 2.9 | 2.7 | 1.6 | 1.3m | 0.9 | −1.2o | −4.2 |
| 21 | 0.8 | 5.0 | 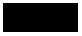 | 3.8 | 3.6 | 3.4 | 3.1 | 2.9 | 2.9 | 2.7 | 1.6 | 1.3m | 0.9 | −1.2o | −4.2 |
| 39 | 0.0 | 4.2 | 3.5 | 3.0 | 2.7 | 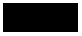 | 2.3 | 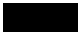 | 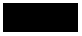 | 1.9 | 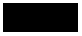 | 0.4o | 0.1 | −2.0 | −5.0 |
| 19 | −0.2 | 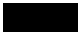 | 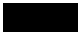 | 2.7 | 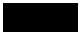 | 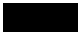 | 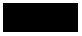 | 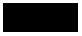 | 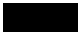 | 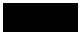 | 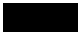 | 0.2o | −0.1o | 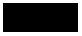 | −5.2 |
| 1 | −0.2 | 4.0 | 3.3 | 2.7 | 2.5 | 2.3 | 2.0 | 1.9 | 1.8o | 1.7o | 0.6m | 0.2m | −0.1 | −2.2m | −5.2 |
| 27 | −0.3 | 3.9 | 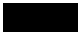 | 2.6 | 2.4 | 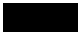 | 1.9 | 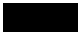 | 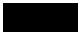 | 1.6o | 0.5 | 0.1m | −0.3 | 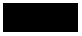 | −5.3 |
| 15 | −0.6 | 3.6 | 2.9 | 2.3 | 2.1 | 1.9 | 1.6 | 1.5 | 1.4 | 1.3 | 0.20 | −0.2m | −0.5 | −2.7 | −5.6 |
| 37 | −0.9 | 3.2 | 2.6 | 2.0m | 1.8 | 1.6 | 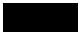 | 1.20 | 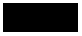 | 1.0 | −0.1o | −0.5 | −0.9m | 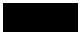 | −5.9 |
| 14 | −1.2 | 3.0 | 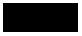 | 1.8 | 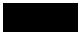 | 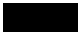 | 1.1 | 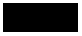 | 0.9o | 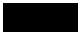 | −0.3 | 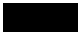 | −1.1 | 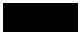 | −6.2 |
| 38 | −1.3 | 2.9 | 2.2o | 1.7 | 1.5 | 1.2 | 1.0 | 0.8 | 0.7m | 0.6 | −0.5m | −0.8 | −1.2 | 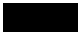 | −6.3 |
| 24 | −1.7 | 2.5 | 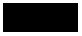 | 1.3 | 1.1 | 0.8 | 0.6 | 0.4m | 0.3m | 0.2o | −0.9 | 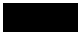 | 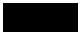 | −3.7 | 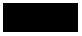 |
| 35 | −1.8 | 2.4 | 1.7 | 1.1 | 0.9m | 0.7 | 0.4 | 0.3 | 0.2 | 0.1 | −1.0o | −1.4 | −1.7 | 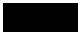 | −6.8 |
| 16 | −1.9 | 2.3 | 1.6 | 1.1 | 0.8 | 0.6 | 0.4 | 0.2 | 0.1m | 0.0 | 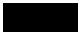 | 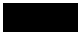 | −1.8 | 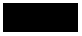 | −6.9 |
| 20 | −2.7 | 1.5 | 0.8m | 0.3 | 0.0 | −0.2 | −0.4 | −0.6 | −0.7 | −0.8 | 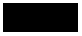 | 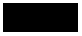 | 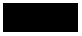 | 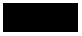 | −7.7 |
| 12 | −3.3 | 0.9m | 0.2m | −0.3 | −0.6o | −0.8o | −1.0o | 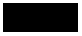 | 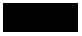 | −1.4m | 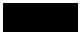 | 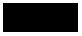 | −3.2 | 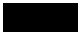 | −8.3 |
| 23 | −5.0 | −0.8o | 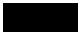 | −2.0o | 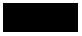 | 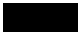 | 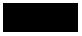 | 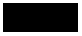 | 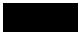 | −3.1m | −4.2 | 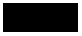 | −4.9 | −7.0 | −10.0 |
| 4 | −5.0 | −0.8 | −1.5 | −2.0 | −2.3 | −2.5 | −2.7 | −2.9 | −3.0 | −3.1 | −4.2 | −4.6 | −4.9 | 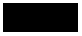 | −10.0 |
| 17 | −5.0 | −0.8 | −1.5 | −2.0 | 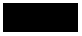 | 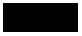 | −2.7 | 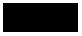 | −3.0 | −3.1 | −4.2 | 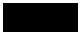 | −4.9 | 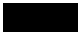 | −10.0 |
| 25 | −5.0 | −0.8 | −1.5 | −2.0 | −2.3 | −2.5 | −2.7 | −2.9 | 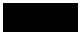 | −3.1 | −4.2 | −4.6 | −4.9 | −7.0 | −10.0 |
| 28 | −5.0 | −0.8 | −1.5 | −2.0 | −2.3 | −2.5 | −2.7 | −2.9 | −3.0 | −3.1 | −4.2 | 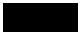 | −4.9 | 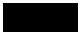 | −10.0 |

Table 1 shows raw localization data, estimated affinity coefficients, and the results of a prediction analysis. The first column and first row contain the A group and B group labels. The second column and second row contain the estimated A group and B group affinity coefficients (ai and bj respectively). The interior of the table contains the value sij=ai+bj for each compound (where positive values of sij indicate predicted localization to mitochondria, and negative values of sij indicate predicted localization to a non-mitochondrial compartment). The subscript m indicates experimentally determined mitochondrial localization. The subscript o indicates experimentally determined non-mitochondrial localization. The darkened boxes indicate correctly predicted mitochondrial localizations under cross-validation.

Based on this matrix, factorial logistic regression (See, A. Agresti, Categorical Data Analysis, Wiley [2002]) was used to calculate mitochondrial affinity coefficients (aᵢ and bⱼ) for each A and B moiety. (Table 1). Since it is not necessary to observe all possible pairings between A and B building blocks to estimate the affinity coefficients, the QSLR approach can predict localization of unmeasured styryl molecules based on a minimal set of experimentally-determined localizations (see Methods). The methods of the present invention allow assessment of predictivity using the cross-validation technique by holding out one compound and fitting the affinity coefficients using the remaining compounds, predictivity can be assessed by comparing the actual localization of the held-out compound to its predicted localization. Repeating this for every measured compound in the library yields an error rate for the procedure.

Cross-validation is useful for testing the ability of certain response variables to be predicted from one or more predictor variables because when a function for predicting a response variable Y from one or more predictor variables (e.g., A, B, C, . . . N) is obtained by mathematically fitting the predictor variables to experimental data, it generally fits the experimental data well because the model is mathematically “forced” to do so. However, the fit may be good even if there is no true predictive relationship between variables A, B, C, . . . N and the response variable Y. Thus, in preferred embodiments, the quality of prediction based on the performance of the model on the same data that was used to fit the model is tested by systematically leaving out each response variable (Y₁, Y₂, Y₃, . . . Yₙ) and determining whether the left-out response variable can be predicted with the model derived from the non-left-out response variables. This procedure is repeated for each response variable used to generate the model, such that the percentage of correctly predicted response variables yields the predictive accuracy of the model.

For mitochondrial localization, 106/147, or 72% of all compounds studied were correctly predicted. (Table 2). The probability of correctly predicting 106/147 compounds by guessing is smaller than 10⁻⁷ so this result is statistically significant. As library size increases, so does prediction accuracy.

TABLE 2

| | A & B | | A only | | B only | |
|---|---|---|---|---|---|---|
| | #correct/ | prop. | #correct/ | prop. | #correct/ | prop. |
| k | #total | correct | #total | correct | #total | correct |
| 0 | 104/145 | .72 | 95/145 | .66 | 82/147 | .57 |
| 2 | 95/136 | .70 | 87/136 | .64 | 75/136 | .55 |
| 4 | 86/115 | .75 | 79/115 | .69 | 67/115 | .58 |
| 6 | 52/66 | .79 | 47/66 | .71 | 41/66 | .62 |
| 8 | 43/50 | .86 | 42/50 | .84 | 31/50 | .62 |
| 10 | 14/16 | .88 | 13/16 | .81 | 7/16 | .44 |

Table 2 shows predictive performance based on all compounds such that the A group and B group are part of at least k compounds in the data set. The prediction is based either on an additive function of the A and B affinities (left), the A affinities only (middle), or the B affinities only (right).

In one embodiment, an analysis was carried out in which both the A group and the B group were considered in at least k (0-10) styryl compounds. In this way, the prediction error rates that would be obtained if a larger library or more complete localization data were available were estimated. Columns 1-3 of Table 2 show the results of this analysis. In particular, when an A group and a B group are observed in at least 10 compounds each, prediction of mitochondrial localization for the styryl molecule formed from A and B increases from 72% to 88%, which is well within the range of state-of-the-art, computational protein localization prediction. (See, R. D. King et al., Yeast, 17:283-93 [2000]; A Clare and R. D. King, Bioinformatics, 18:160-6 [2002]; R. Mott et al., Genome Res., 12:1168-74 [2002]; and H. Hishigaki et al., Yeast, 18:523-31 [2001]). While number and variation of proteins in the genome is limited, the size and diversity of combinatorial libraries of small molecules is largely unconstrained. The error rate decreasing with increasing library size suggests that independent, additive affinities for the Aᵢ and Bⱼ moieties for mitochondria accurately predict the localization of styryl compounds to that organelle, as long as the affinity coefficients are precisely estimated.

In some embodiments, the predictive accuracy of the QSLR model described herein was fit to the experimental data under four different sets of constraints: 1) all aᵢ, bⱼ free (differential effect for both the A and B groups); 2) all aᵢ=0 (no differential effect for the A groups); 3) all bⱼ=0 (no differential effects for the B groups); and 4) all aᵢ, bⱼ=c (pure interaction or random assignment). The results suggest that there is a high degree of differential influence among A groups relative to the B groups. In fact, prediction based on A and B is not significantly better than prediction based on A alone, while there is a significant improvement relative to prediction using B alone. Nevertheless, since the sample sizes are not large, statistical power is limited; and, since error rates based on A and B are lower than those based on A alone for every value of k, it is likely that B groups exert a small differential effect.

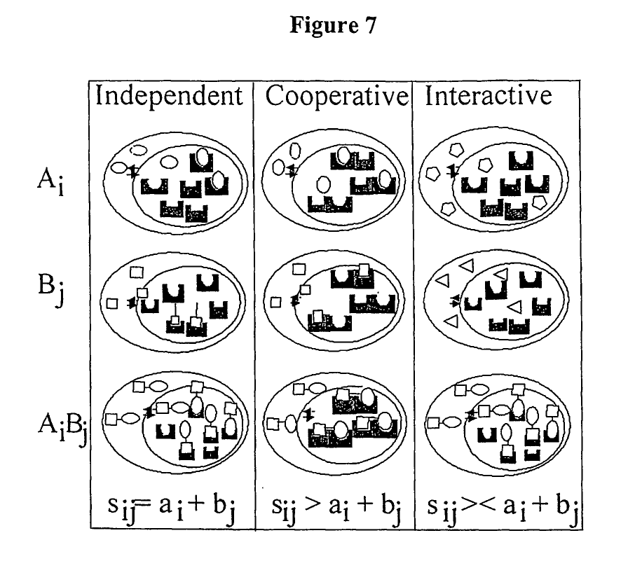

The data generated suggests that mitochondrial localization for the styryl library follows a non-interactive, independent binding model, where diversity in the A group strongly influences localization, and diversity in the B group exerts only a weak influence. The hypothesis that the affinity of the product styryl molecule is determined by the sum of the affinities of the individual components: sᵢⱼ=aᵢ+bⱼ is supported by the data. To assess the implications of this observation, one can consider two alternative, physical models that could account for mitochondrial localization (FIG. 7). Indeed, a hypothesis of independent, additive effects for A and B is not consistent with a situation where the A and B moieties influence each other's affinity for mitochondria. Rather, features responsible mitochondrial affinity of Aᵢ are not changed by conjugating Aᵢ to a specific Bⱼ moiety. Similarly, features responsible for mitochondrial affinity of Bⱼ are not changed by conjugating Bⱼ to a specific Aᵢ moiety. The results also do not support a cooperative binding/partitioning model, since cooperative interaction between Aᵢ, Bⱼ and mitochondria would not lead to an additive relationship.

The QSLR techniques of the present invention provide quantitative analysis of the relationship between chemical structures of small molecules and their subcellular distribution.

II. Exemplary Combinatorial Library of Styryl Molecules and Analyses

Preferred embodiments of the present invention provide fluorescent cell-permeable lipophilic cations for monitoring the structure and function of mitochondria in living cells. The methods and compositions of the present invention are not limited however to fluorescent cell-permeable lipophilic cations, or to method and compositions that selectively target mitochondria.

Probes of mitochondrial function include well-known fluorescent dyes like rhodamine 1, 2, and 3 (See e.g., L. B. Chen, Annu. Rev. Cell Biol., 4:155-181 [1988]; T. J. Lampidis et al., Agents Actions, 14:751-757 [1984]; L. V. Johnson et al., Proc. Natl. Acad. Sci. USA, 77:990-994 [1980]; and L. V. Johnson et al., J. Cell Biol., 88:526-535 [1981]), JC-1 (See e.g., S. T. Smiley et al., Proc. Natl. Acad. Sci. USA, 88:3671-3675 [1991]) as well as cell-permanent fluorescent dyes of the styryl family. (See e.g., H. W. Mewes and J. Rafael, FEBS Lett, 131:7-10 [1981]; J. Bereiter-Hahn, Biochim. Biophys. Acta, 423:1-14 [1976] J. Bereiter-Hahn et al., Cell Biochem. Funct., 1:147-155 [1983]; and D. S. Snyder and P. L. Small, J. Immunol. Methods, 257:35-40 [2001]). The accumulation of lipophilic cations inside the mitochondrial inner matrix has been one of the best-studied, organelle-targeting mechanisms to date. (See e.g., J. R. Bunting et al., Biophys. J., 56:979-993 [1989]; M. Zoratti et al., Biochim. Biophys. Acta, 767:231-239 [1984]; and D. Nicholls and S. Ferguson, Bioenergetics 2; Academic Press: London, 1992).

In the process of oxidative phosphorylation, oxidation of NADH and FADH₂ to NAD+ and FADH is coupled to the pumping of protons across the mitochondrial inner membrane by a series of multienzyme complexes. This pumping mechanism generates a steady state electrochemical potential across the inner mitochondrial membrane, composed of a pH gradient and a transmembrane voltage. Lipophilic cations accumulate in mitochondria as a function of the transmembrane electrical potential across the mitochondrial inner membrane, in a manner governed by the proton-pumping mechanism, and predicted by the Nernst equation. (See e.g., J. S. Modica-Napolitano and J. R. Aprille, Adv. Drug Deliv. Rev., 49:63-70 [2001]). Dissipation of the membrane potential is followed by leakage of the probes from the organelle. (See e.g., H. Zhang et al., Anal. Biochem., 298:170-180 [2001]; and P. W. Reed, Methods Enzymol, 55:435-454 [1979]). The localization of lipophilic cationic probes to mitochondria constitutes one of the best-studied supertargeting mechanisms known to date. However, lipophilicity and positive charge are not the only determinants of mitochondrial localization.

The ability to synthesize supertargeted libraries of fluorescent molecules with controlled subcellular localization properties is key to developing biosensors for cell biological studies, in vivo imaging, and pharmaceutical screening applications. Understanding the relationship between chemical structure, subcellular distribution and optical properties is therefore of considerable interest to chemists and biologists.

Preferred methods of the present invention provide methods for determining whether the chemical structure-property relationships of chemical components of address tags contribute independently or additively to the physicochemical properties of the chemical address tag molecule. In certain embodiments, the present invention provides methods of statistical regression analysis to study the localization and spectral properties of the chemical address tags comprised of the individual building blocks (e.g., A=aldehyde; and B=pyridinium/quinolinium) used to construct the library.

In the styryl library described in one preferred embodiment, the analytical methods of the present invention indicate that non-additive interactions between A and B moieties across the central double bond have a minimal effect on localization and spectral properties of the styryl molecule. Thus, each individual A or B moiety promotes or inhibits the localization of a particular molecule to mitochondria, or contributes to a higher or lower excitation and emission wavelength, by a constant amount, in an additive fashion, and independently from the rest of the molecule. The numerical contribution of each building block to excitation and emission peaks shows some correlation. However, the small correlation between spectral and localization properties permits the construction of subcellular location specific (e.g., mitochondrion-targeted) chemical address tag libraries (e.g., styryl libraries) which span the entire excitation and emission spectrum.

Analysis of Fluorescence Excitation and Emission

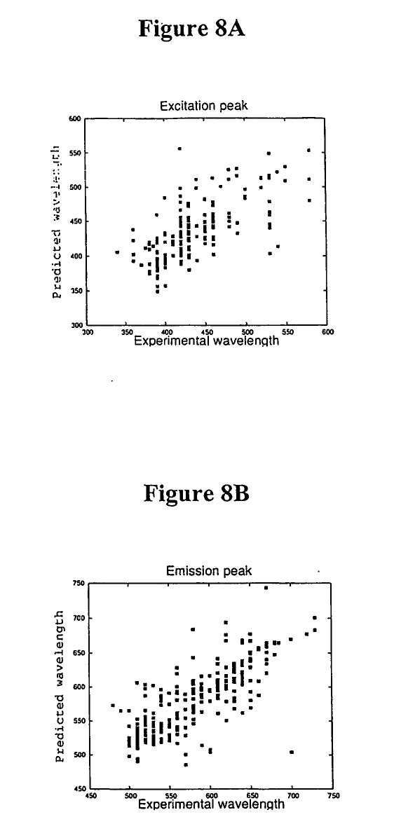

The chemical structure of the styryl library is illustrated in FIG. 3. Briefly, FIG. 3 shows the structure of the representative styryl library, comprised of all possible pair-wise combinations of A and B groups. Initial analysis focused on measurements of peak emission and excitation wavelength obtained for all styryl products showing a single, localized peak (there were 256 such compounds for emission wavelength, and 193 compounds for excitation wavelength). Peak emission and excitation wavelengths were found to vary over almost the entire visible range. The wavelength for the styryl compound formed by joining A group i with B group j is denoted as λᵢⱼ (or more specifically, λᵢⱼ^{ex} for excitation wavelength and λᵢⱼ^{em} for emission wavelength). The additive model λᵢⱼ=aᵢ+βⱼ+εᵢⱼ was fit to the data using least squares yielding parameters αᵢ^{ex}, αᵢ^{em}, βⱼ^{ex}, and βⱼ^{em} that quantify the influence of each A and B group on the spectrum of the styryl product. The resulting fitted values λᵢⱼ^{ex}=αᵢ^{ex}+βⱼ^{ex}+εᵢⱼ^{ex} and λᵢⱼ^{em}=aᵢ^{em}+βⱼ^{em}+βᵢⱼ^{em} showed good correlation with the true values. (FIGS. 8A-8B). FIGS. 8A-8B shows the predicted versus experimentally-determined values for peak excitation (FIG. 8A) and emission (FIG. 8B) wavelengths in the styryl library. The predictions were made ignoring interactions between the two functional moieties in the styryl compound. The predicted values were obtained without bias, by holding out the data point to be predicted when training the model.

In preferred embodiments, using the cross-validation approach disclosed herein, each compound was held out in sequence, the model was trained using the remaining compounds, then the wavelength value for the held-out compound was predicted based on the resulting fitted model. This process produced correlations between measured and predicted values of ρ^{em}=0.78 (emission) and ρ^{ex}=0.69 (excitation).

The degree of correlation between predicted and experimental peak wavelengths was highly statistically significant for both excitation and emission values. Randomizing the compounds 1,000 times yielded a null distribution of correlation coefficients with 95th percentile 0.12 and maximum value 0.23—far smaller thane the observed values of both spectra (0.78 and 0.69) given above. The present invention also determined whether the spectral properties of the styryl product vary according to the identity of both the A and B group, or whether only one of the two groups has a differential influence. To assess this, the model described above was reworked while holding either αᵢⱼ=0 (allowing no differential effect of the A group on peak wavelength) or βᵢⱼ=0 (allowing no differential effect of the B group on peak wavelength). The resulting fitted values showed much lower correlation with the true values, compared to the additive model that allows differential effects for both groups. For emission wavelengths, the correlation between predicted and observed values based on the identities of both the A and B group were 22% higher than the correlation based only on the A group identity, and were 95% higher than the correlation based only on the B group identity. For excitation wavelengths, the corresponding values are 73% and 53%.

Based on this analysis, the contribution of the A and B functional groups to the fluorescence of the styryl product is quantified using the fitted coefficients αᵢ^{ex}, βⱼ^{ex}, βᵢ^{em}, and βⱼ^{em}. Since these coefficients are on a scale without origin, in some embodiments, the invention uses the first A group and B group as a baseline, so α1^{ex}=, β1^{ex}=0, and so on. Table 3 contains the model coefficients of all A and B groups for peak excitation and emission wavelength.

TABLE 3

| A groups | | | | B groups | | | |
|---|---|---|---|---|---|---|---|
| | αᵢ^{ex} | αᵢ^{em} | αᵢ^{mito} | | βⱼ^{ex} | βⱼ^{em} | βⱼ^{mito} |
| 1 | 0.0 | 0.0 | −0.2 | 1 | 0.0 | 0.0 | 1.9 |
| 2 | — | — | 5.0 | 2 | 4.9 | 4.3 | 2.0 |
| 3 | 35.7 | 46.3 | 5.0 | 3 | −12.7 | −2.7 | 4.2 |
| 4 | −34.0 | 23.5 | −5.0 | 4 | −32.3 | −23.2 | 3.0 |
| 5 | −32.3 | 26.7 | 5.0 | 5 | −1.6 | −7.6 | 2.2 |
| 6 | 4.9 | −9.5 | 5.0 | 6 | 27.7 | 3.5 | −5.0 |
| 7 | −44.1 | 38.5 | 5.0 | 7 | 29.6 | 63.7 | 3.5 |
| 8 | 10.9 | 38.5 | 5.0 | 8 | 53.0 | 64.8 | 0.4 |
| 9 | −36.7 | −17.6 | 5.0 | 9 | −0.1 | 35.0 | −2.0 |
| 10 | 8.1 | −23.7 | 1.3 | 10 | 1.6 | 19.8 | 0.8 |
| 11 | −14.3 | −26.7 | 5.0 | 11 | −4.2 | −4.1 | 2.1 |
| 12 | −36.7 | −22.7 | −3.3 | 12 | −10.2 | −1.7 | 2.7 |
| 13 | −44.2 | 0.2 | 5.0 | 13 | −1.1 | −1.8 | 2.5 |
| 14 | −1.6 | 0.3 | −1.2 | 14 | 100.6 | 57.9 | 0.0 |
| 15 | −46.9 | −33.1 | −0.6 | | | | |
| 16 | −36.3 | −24.8 | −1.9 | | | | |
| 17 | −14.3 | −46.6 | −5.0 | | | | |
| 18 | −24.3 | 51.2 | 0.8 | | | | |
| 19 | 26.0 | 49.6 | −0.2 | | | | |
| 20 | 6.5 | 44.5 | −2.7 | | | | |
| 21 | −68.0 | 21.6 | 0.8 | | | | |
| 22 | −52.8 | −10.3 | 5.0 | | | | |
| 23 | 6.1 | −10.3 | −5.0 | | | | |
| 24 | −7.2 | −24.2 | −1.7 | | | | |
| 25 | −5.3 | −21.9 | −5.0 | | | | |
| 26 | 13.2 | 24.7 | 5.0 | | | | |
| 27 | 11.1 | 72.0 | −0.3 | | | | |
| 28 | 2.4 | 44.9 | −5.0 | | | | |
| 29 | — | −8.0 | 5.0 | | | | |
| 30 | 7.4 | 50.1 | 5.0 | | | | |
| 31 | −22.4 | 6.9 | 5.0 | | | | |
| 32 | −36.1 | −15.0 | 5.0 | | | | |
| 33 | — | −26.5 | 5.0 | | | | |
| 34 | 14.1 | 58.8 | −5.0 | | | | |
| 35 | 0.0 | −8.3 | −1.8 | | | | |
| 36 | −25.3 | 3.8 | 5.0 | | | | |
| 37 | 82.9 | 122.1 | −0.9 | | | | |
| 38 | −15.6 | 22.2 | −1.3 | | | | |
| 39 | −28.3 | −25.3 | 0.0 | | | | |
| 40 | −18.1 | 64.8 | — | | | | |
| 41 | 26.1 | 46.9 | — | | | | |

Table 3 shows the influence of A and B groups on peak excitation and emission wavelengths, and on subcellular localization, inferred from measurements on styryl molecules. Greater values of αᵢ^{ex}, αᵢ^{em}, βⱼ^{ex}, and βⱼ^{em} indicate greater peak wavelength. Greater values of αᵢ^{mito} and βⱼ^{em} indicate stronger mitochondrial localization. A groups 40 and 41 were not screened for localization. A groups 2, 29, and 33 only formed fluorescent products with a single B group, so were not included in the spectral analysis.

Positive coefficients indicate that the corresponding A or B group reddens the peak wavelength, with a greater magnitude indicating a greater degree of reddening. The range for the A group coefficients is around 150 nm for both excitation and emission peak wavelength, which means that by changing the identity of the A group in the styryl compound, one can systematically shift the peak wavelength by around half the width of the visible spectrum. For example, changing the A group from 37 to 12 is associated with roughly a 140 nm shift in peak emission wavelength, across a diverse range of B groups. Although shifts greater than 140 nm may be seen in specific pairs of compounds, the 140 nm shift is notable in that it is seen consistently in a diversity of compounds where only the A group varies. Changes in the B group also lead to sizable, though smaller changes. For example, changing the B group from 8 to 5 is associated with roughly a 70 nm shift across a diverse range of A groups. In preferred embodiments, changing both/either of the A and B groups at the same time, allows for creation of fluorescent molecules that cover the entire visible spectrum.

Analysis of Complex Spectra

One possible application of the additive model for peak wavelengths is to make inferences about styryl products whose spectral properties deviate from the norm. These styryl products may represent failed synthesis, reactions that yield multiple fluorescent products, or formation of dye aggregates with complex optical properties. More interestingly, they may also represent products with conformation-dependent or environmentally-sensitive optical properties that could be exploited for biosensing applications. For the initial fitting and testing of the model, spectra of compounds exhibiting multiple peaks or poorly-defined peaks were ignored. Thus, using the model fit to the compounds with simple spectra, the peak wavelength can be predicted for compounds with complex spectra, and compared to the measured spectra. (FIGS. 9A-9B). Briefly, FIGS. 9A-9B show the experimental and predicted peak emission (FIG. 9A) and excitation (FIG. 9B) wavelengths for compounds with complex spectra along with the experimentally determined peak wavelengths (each vertical band represents a single compound, the experimental data are shown as either a vertical error bar for a poorly-defined broad peak, or as multiple empty squares for several localized peaks). Each vertical band corresponds to a single such compound, empty squares represent measured excitation or emission peak values, and filled squares indicates the predicted peak wavelength according to the additive model. Multiple localized peaks in the experimentally determined spectra are shown as multiple unfilled squares, and a single broad peak is shown as a vertical error bar.

In FIGS. 9A-9B, for the 38 products with broad peaks, it is seen that 29/38 of the predicted values fall somewhere within the peak, suggesting that in most cases, products with complex spectra also follow the additive relationship observed for products with single excitation or emission peaks. This result was statistically significant at p<0.0001 (See, Example 5).

For simulation, one embodiments of the present invention established the probability that the predicted excitation/emission values would fall within the measured complex values base on chance. For this purpose, the predicted values where randomly assigned to the 38 complex spectra. The number of times that the predicted and measured spectra would overlap was scored, and the entire procedure was iterated >10⁴ times. Based on this simulation, for 38 broad peaks randomly assigned to the corresponding 38 predicted values, on average only 19 of the predicted values are covered (with 95^{th} percentile point 23, and maximum value of 28 in 10⁴ random assignments). In addition, for a number of the compounds with multiple peaks (e.g., the leftmost two in the emission data), the predicted peak is much closer to one of the experimental peaks compared to the others, suggesting that the complex spectra may be due to the presence of multiple fluorescent products, and that at least one of these products corresponds to the expected product.

Analysis of Mitochondrial Localization

In preferred embodiments, localization analysis focused on how A and B groups are able to discriminate non-mitochondrial from mitochondrial localization (indiscriminately of whether mitochondrial localization is specific), by calculating the proportion of all compounds that are correctly predicted as localizing to mitochondrial or non-mitochondrial structures. As was the case for the compounds fluorescence properties, this analysis determined whether A and B groups localize in an independent additive fashion, with each A and B group contributing towards localization by a constant amount and independent of the rest of the molecule. Measurements of subcellular localization were made for 147 of the styryl compounds, as previously described. Due to the cationic nature of the B groups, many of the styryl compounds were expected to accumulate in mitochondria. While this is true of roughly half of the compounds, many compounds localize to nucleus, nucleolus, cytosol, ER, and to cytoplasmic granules. Thus, the present invention provides methods of designing and fabricating molecules (e.g., chemical address tags) that localizes to specific intracellular and subcellular locations, including, but not limited to the mitochondria.

Unlike measurement of fluorescence excitation or emission peaks, localization to mitochondria is determined by visual inspection, and was scored in a binary fashion (reaction products localizing to mitochondria are given a value of 1 while those that do not are given a value of 0). To analyze this data, the inventors used a factorial logistic regression approach (Examples) to establish if A and B groups additively and independently contribute to localization. Briefly, this technique assigns quantitative scores to each A group (αᵢ^{mito}) and to each B group (βⱼ^{mito}), in such a way that αᵢ^{mito}+βⱼ^{mito} is positive for compounds with mitochondrial localization, and is negative for compounds lacking mitochondrial localization. Good predictive performance suggests that A and B groups contribute to localization in an additive independent fashion. In additional embodiments, same analysis can be applied to organelles other than mitochondria, provided there are a sufficient number of localizations to specific non-mitochondrial organelles in the combinatorial library of interest for reliable statistical calculations.

In certain embodiments, the predictive performance of the above method was assessed using a cross-validation approach by calculating the proportion of all compounds that are correctly predicted. For cross-validation, each styryl product was set aside in sequence, and the factorial logistic model was fit to the remaining data. Then the resulting A and B scores for the held-out compound were summed. If the sum was positive, the held-out compound was predicted to be mitochondrial, while if the sum was negative, the held-out compound was predicted to be non-mitochondrial. Table 3 gives the fitted model coefficients αᵢ^{mito} and βⱼ^{mito} for mitochondrial localization. Positive values of these coefficients suggest that the corresponding A or B group confers mitochondrial localization to compounds of which it is a part (the numbers ±5 were used for groups that conferred mitochondrial localization in every case, or no case, respectively). The range in these coefficients is around 4.6 (excluding values fixed at ±5), indicating that by changing the identity of the A group, an odds ratio of around 100 can result (the odds ratio is the probability ratio of mitochondrial localization to non-mitochondrial localization). The baseline performance of the method scored 104 correct out of 145, or 72%. This number is highly statistically significant compared to random guessing (p-value ˜10⁻⁷). Thus, across the entire library, A and B moieties appear to contribute to localization in an independent, additive fashion.

Since the statistical power for assessing interactivity increases when a greater number of combinations are observed, the present invention also considered error rates for subsets of A and B groups where localization could be determined for a minimum of number of products (represented by the coefficient k). The percentage of correct predictions increases from 72% (k=0; comprising the entire dataset) to 88% (k=10; comprising those A and B groups that yielded the greatest number of localizable products; Table 4). This suggests that to a high degree, mitochondrial localization is determined by independent contributions from the A and B functional groups. The relatively higher overall error rate (28% for k=0), compared to the error rate for the subset of compounds comprised of groups observed in many distinct configurations (12% for k=10), can be attributed to training error in the coefficients αᵢ^{mito} and βⱼ^{mito}, which is reduced as k increases.

The differential influence of both A and B groups was also calculated for the localization properties, by a similar method used to determine the differential influence of A and B groups to spectral properties (as discussed in previous section). Unlike excitation or emission peaks, differential localization appears to be influenced mostly by contributions from the A group. Table 4 provides prediction performance based on cross-validation for mitochondrial localization in the styryl library, based on factorial logistic regression. Predictions were based on both the A and B group (columns 2-3), the A group only (columns 4-5), or the B group only (columns 6-7). Rates of correct prediction are given for the set of compounds in which the A and B group both belong to at least k compounds having localization data, for various values if k.

TABLE 4

| | A&B | | A only | | B only | |
|---|---|---|---|---|---|---|
| | #correct/ | prop. | #correct/ | prop. | #correct/ | prop. |
| k | #total | correct | #total | correct | #total | correct |
| 0 | 104/145 | .72 | 95/145 | .66 | 82/145 | .57 |
| 2 | 95/136 | .70 | 87/136 | .64 | 75/136 | .55 |
| 4 | 86/115 | .75 | 79/115 | .69 | 67/115 | .58 |
| 6 | 52/66 | .79 | 47/66 | .71 | 41/66 | .62 |
| 8 | 43/50 | .86 | 42/50 | .84 | 31/50 | .62 |
| 10 | 14/16 | .88 | 13/16 | .81 | 7/16 | .44 |

Table 4 further shows the prediction performance for mitochondrial localization based on the identity of the A group alone (columns 4-5), and based on the B group alone (6-7). The latter prediction is not significantly better than chance, while the former is nearly comparable to prediction based on both groups. This suggests that localization varies consistently with the identity of the A group, while the B groups are more or less interchangeable. While the present invention is not limited to any particular mechanism, and an understanding of particular mechanism is unnecessary to make and use the compositions and methods of the present invention, it is contemplated that one explanation for this may be that the positive charge in the B moiety draws the compound toward mitochondria (equally for all 14 B groups), while certain A groups are drawn toward other organelles or otherwise prevent accumulation of the molecule to mitochondria. Thus, in one embodiment, for this group of compounds, the A group ultimately determines whether accumulation is mostly in the mitochondria, or mostly in other non-mitochondrial organelles.

Data Clustering and Visualization

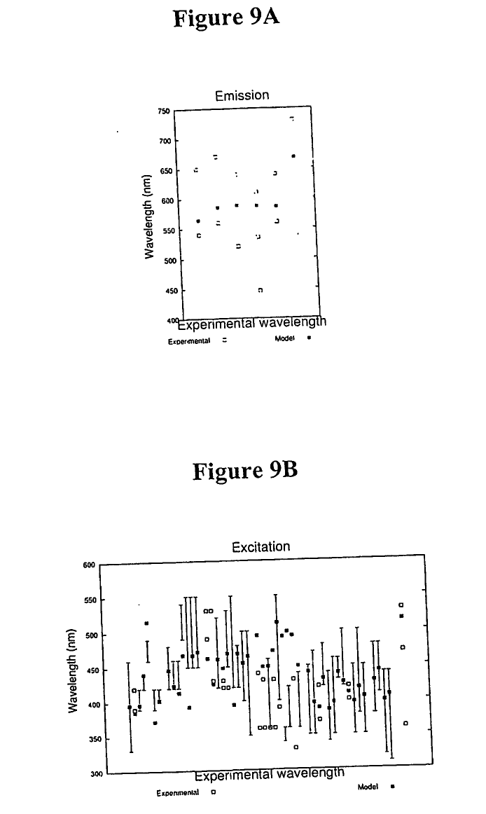

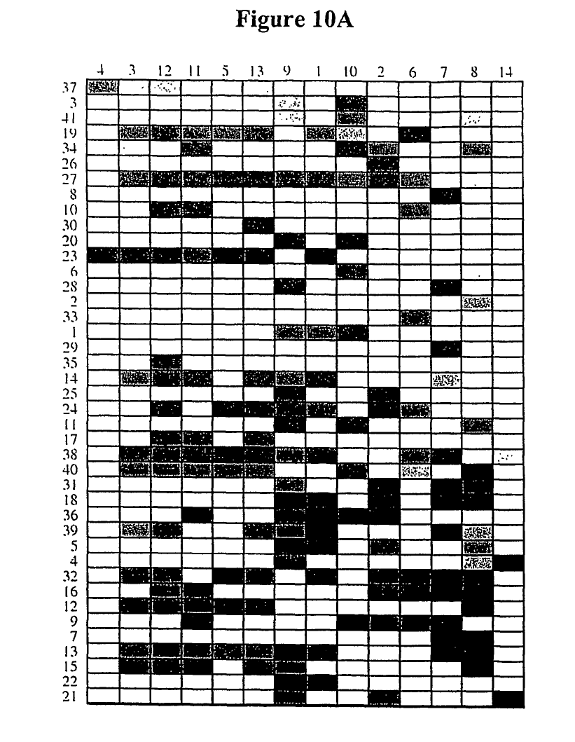

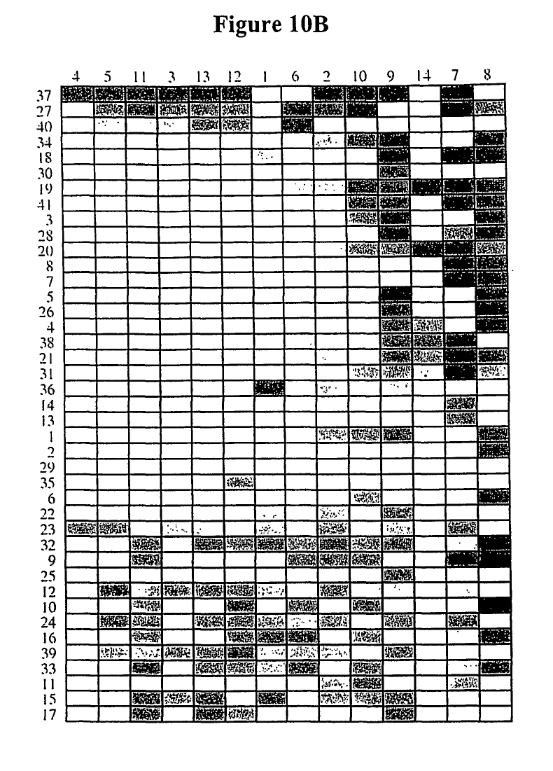

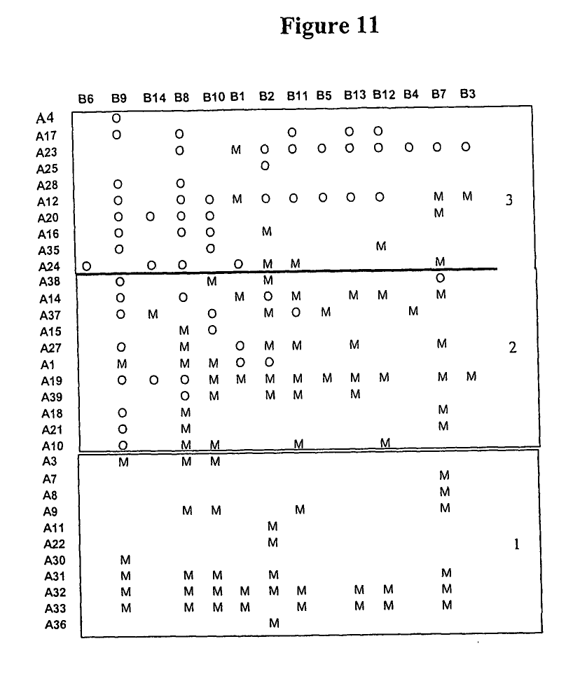

Preferred embodiments of the present invention provide logical and intuitive ways of visualizing clustered data and for clustering data. FIGS. 10A-10B show the clustered peak experimental wavelengths for peak excitation (FIG. 10A) and emission (FIG. 10B), respectively, while FIG. 11 shows the clustered localizations, as determined empirically, and based on the sorted αᵢ^{mito} and βⱼ^{mito}. More particularly, FIG. 11 shows clustered mitochondrial (M) and non-mitochondrial (O) localizations. Three groups are indicated, highlighting relative differences in mitochondrial affinity: group 1 is predominantly mitochondrial; 2 is both mitochondrial and non-mitochondrial; 3 is predominantly non-mitochondrial.

In preferred embodiments, the data tables are generated by applying the additive decomposition analysis, sorting rows and columns of the data matrix so that the alpha coefficients increase from bottom to top and the beta coefficients increase from left to right. According to the additive model, compounds formed from the A and B group having the largest αᵢ^{ex} and βⱼ^{ex} (or αᵢ^{em} and βⱼ^{em}) will have the greatest wavelength at the top right corner of the matrix, and the wavelength will decrease as either αᵢ or βⱼ decreases. Thus, the color will shift from red to blue while moving vertically from top to bottom, or horizontally from right to left in the reordered table. The color will move more rapidly from red to blue while moving along the diagonal from the top right to the lower left of the table. The rate at which the color varies can be determined by consulting the reordered table. A continuous rate of change indicates that all colors are roughly equally represented, while skew or sudden changes indicate that certain bands of the spectrum predominate, and others are under-represented.

As with the spectral data, the localization data can also be clustered and visualized by the additive decomposition method. (FIG. 11). In preferred embodiments, to generate the localization table, the additive decomposition analysis is applied, and rows and columns of the data matrix are sorted so that the alpha coefficients increase from bottom to top, and the beta coefficients increase from left to right. According to the additive model, compounds formed from the A and B group having the largest αᵢ^{mito} and βⱼ^{mito} will have the greatest probability of being localized to mitochondria at the bottom right corner of the matrix, and the probability of finding a mitochondrial-localized product will decrease as αᵢ^{mito} and βⱼ^{mito} decrease. The localizations shift from O to M while moving vertically from top to bottom, or horizontally from left to right in the reordered table. For the clustered localizations, the differential influence of A and B groups on mitochondrial versus non-mitochondrial localization is readily visualized. (FIG. 11). It is evident that for every B, there are both mitochondrial (M) and non-mitochondrial (O) styryl products. This is consistent with the B group exerting a minimal differential influence on localization. Conversely, for the A groups, three different clusters can be observed: cluster 1, 2 and 3 corresponds to A groups exclusively associated with M, M/O, or with O, in the respective order.

Certain embodiments of the present invention compared the results based on the additive decomposition to results of more conventional clustering methods, including two-way hierarchical clustering, and a Monte Carlo search procedure that maximizes the local similarity within a neighborhood of wavelengths. Since it has already been established by the methods of the present invention that the additive model fits the data reasonably well, it is not surprising that the additive decomposition produced clustering results surpassing other methods, at least from a subjective, visualization viewpoint (the other methods produced rearrangements with several isolated clusters of high or low frequency compounds, rather than the global gradient produced by the additive model).

While the present invention is not limited to any particular mechanism, and an understanding of particular mechanism is unnecessary to make and use the compositions and methods of the present invention, it is contemplated that the reason for this result may be that other clustering algorithms (e.g., implementations of hierarchical or agglomerative clustering) change the arrangement in a sequence of small steps, wherein each step is influenced only by local features of the cluster quality. The additive model, on the other hand, is a global method, since all coefficients are sensitive to changes in any other coefficient, through the least squares fitting process.

Another advantage of additive decomposition methods of the present invention for clustering is that they provide a unique solution with fixed reference points; wherein in preferred embodiments, the upper right corner is always the reddest part of the table, and the lower left corner is always the bluest part of the table. In contrast, other methods do not provide unique solution, and there are many transformations, such as vertical or horizontal flips that return a distinct, but equally valid solution. Another advantage of the additive decomposition methods of the present invention is that they easily handle missing information (e.g., compounds lacking experimental data), since it is only necessary to observe a limited number of compounds to identify and estimate the additive coefficients. The ability of the additive decomposition methods to effectively cluster and visualize data reflects the goodness of the additive fit that has already been found to characterize the data set under study. If the effect of chemical groups A and B on the wavelength and localization of the styryl molecules were not additive, it would be impossible to reorder the rows and columns so that a gradient is obtained. Nevertheless, for analysis of the styryl compounds, clustering by additive decomposition clearly yields the best visualization results.

Analysis of Multiparameter Labeling

Multiparameter labeling refers methods of using different fluorescent probes to simultaneously monitor different cellular organelles in a single living cell. In some preferred embodiments, it is important not only to have selected probes localize to different organelles, but also to have their fluorescence excitation and emission spectra not overlap. In other words, the optical properties of the probes should allow discriminating (e.g. using optical filters) one probe from the other within a single living cell or cell population. To determine whether a combinatorial library of potential chemical address tag molecules (e.g., styryl molecules) provides a toolbox suitable for multiparameter labeling, it is also important to design a library of molecules exhibiting a broad range of fluorescence excitation and emission wavelengths for each localization site of interest (e.g., mitochondrial vs. non-mitochondrial).

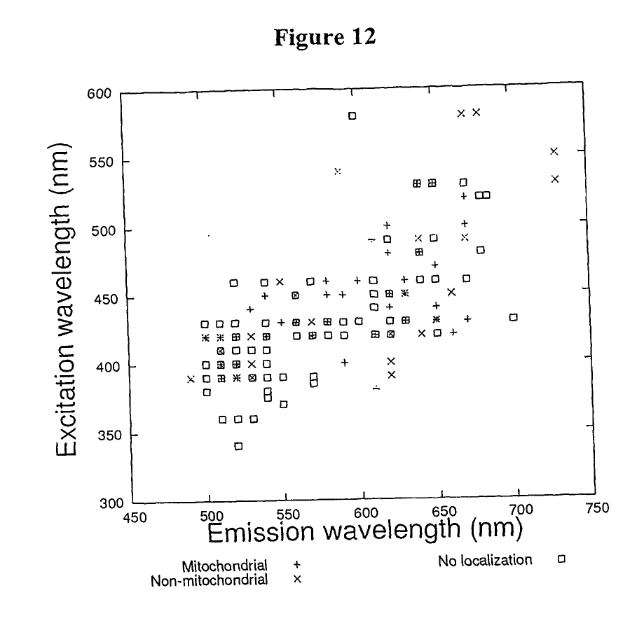

For this purpose, in certain embodiments, a joint analysis of fluorescence and localization properties was carried out. Initially, a bivariate excitation versus emission plot was used to compare the fluorescence properties of mitochondrial and non-mitochondrial compounds, together with the fluorescence properties of compounds that do not localize to any cellular compartments. (FIG. 12). Briefly, FIG. 12 provides a bivariate plot of excitation and emission peak wavelength distribution of styryl products, indicating different localizations.

In one embodiment, styryl library products that localized to the mitochondrial localization exhibit excitation wavelengths between 380 to 540 nm and emission wavelengths between 500 to 660 nm. Products that do not show mitochondrial localization or that do not localize altogether excite from 340 to 580 nm, and emit anywhere from 480 to 730. Thus, in preferred embodiments, mitochondrial-targeting styryl dyes show a broad spectral range, however, non-mitochondrial targeting dyes show an even broader range.

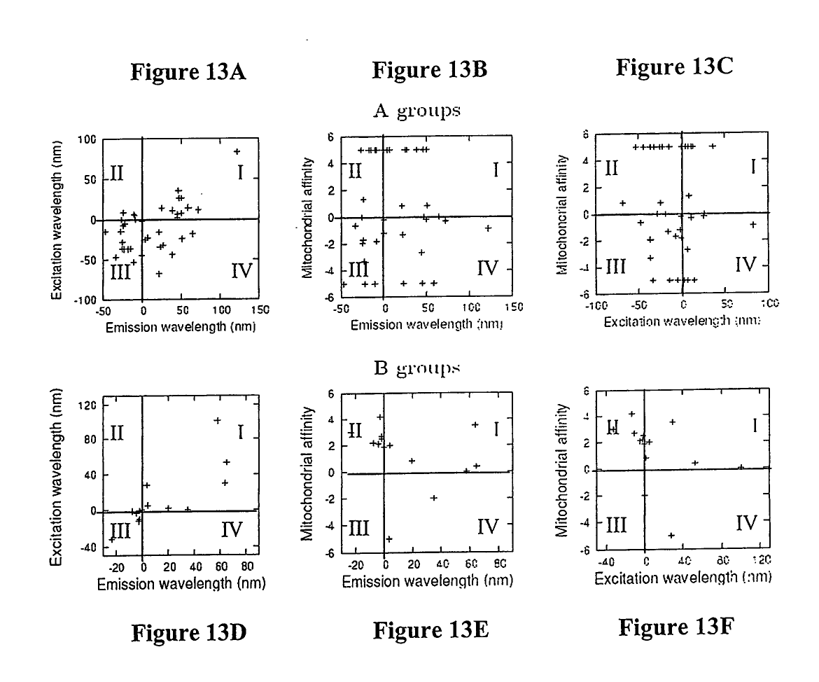

In another embodiment, the contribution of A and B moieties to this trend was determined by analyzing bivariate plots of A and B moieties looking for correlations between excitation-localization or emission-localization contributions. (FIGS. 13A-13F). FIGS. 13A-13F provide bivariate plots of excitation/emission (FIGS. 13A and 13D), mitochondrial affinity/emission (FIGS. 13B and 13E), and mitochondrial affinity/excitation (FIGS. 13C and 13F) for the individual A (FIGS. 13A-13C) and B (FIGS. 13D-13F) groups. For clarity, each quadrant in the plot is indicated with roman numerals.

As a positive control, the invention started by analyzing the excitation-emission contribution, which should show correlation based on the Stokes shift which provides, according to the principles of quantum mechanics, that a molecule's emission wavelength is higher than it's excitation wavelength. Accordingly, the plot reveals most of the data points lying in quadrants I, III and IV, indicating that A or B moieties that are red shifted in the excitation are unlikely to be blue shifted in the emission. Referring to the localization/emission plots for the A group molecules, the equal distribution of data points on quadrants I, II, III and IV indicates that localization and fluorescence contributions are not correlated. On the other hand, for the B group molecules, data points fall on quadrants I, II and IV, but not on III. While this may suggest a certain correlation between fluorescence and mitochondrial contributions for the B groups, B groups do not exert a differential influence on mitochondrial localization indicating that this result is not statistically significant.

In preferred embodiments, directed to microscopy and live cell applications, dyes that excite and fluoresce at 480 nm or higher are most desirable, as intracellular NADH and FADH leads to high background autofluorescence at lower wavelengths. Thus, by virtue of its mitochondrial localization/fluorescence properties, styryl libraries appear to be naturally biased towards finding good fluorescent reporters for mitochondrial visualization in the visible wavelengths. However, there is no strong association between model coefficients for peak wavelength (either emission or excitation) and mitochondrial localization. Therefore, the functional A and B groups used to build the styryl library appear to independently confer shifts in spectral and subcellular localization properties. For example, among the A groups, group 17 confers mitochondrial repulsion and a bluer λᵢⱼ^{em}; group 34 confers mitochondrial repulsion and a redder λᵢⱼ^{em}, group 33 confers mitochondrial attraction and a bluer λᵢⱼ^{em}, and group 30 confers mitochondrial attraction and a redder λᵢⱼ^{em}. This indicates that, in the case of styryl molecules, the localization and excitation/emission properties can be optimized independently from each other, and that finding mitochondrially-targeted molecules that fluoresce at wavelengths >580 nm is possible in larger styryl libraries.

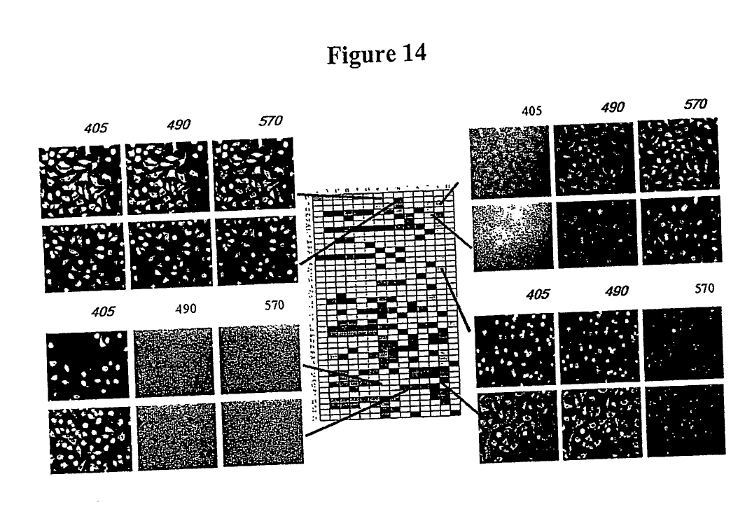

In one embodiment, to test how the measured spectral properties of the dyes in solution correspond to spectral properties of the dyes in living cells, UACC-62 melanoma cells were labeled with representative compounds in the library and visualized with an epifluorescence microscope. For excitation, filter sets were used to excite the dyes at three different wavelengths (405, 490, and 570 nm), and fluorescence was detected using a 500 nm dichroic and >510 long pass filter. Images were obtained from the cells at 200× magnification. (FIG. 14). FIG. 14 shows an epifluorescence microscopy analysis of selected styryl products selected from the excitation table (from FIGS. 10A-10B). Styryl products corresponding to A and B combinations yielding a range of peak emission wavelength were used to stain living cells and observed with various excitation filters (405, 490 and 570 nm), as indicated. Excitation wavelengths yielding the best fluorescence images are indicated in bolded letters.

As can be seen in various Figures, different dyes are optimally excited at different wavelengths, corresponding to the trends observed in the clustered, peak excitation plot. To illustrate this trend in the counterclockwise direction, the left bottom corner of the clustered emission graph corresponds to dyes that show the lowest excitation wavelength in the microscope images (405 nm). Continuing counterclockwise, the bottom right corner corresponds to dyes that excite at slightly higher wavelength (405/490 nm in the microscope images), while the upper right corresponds to dyes that excite at the highest wavelengths (490/570 nm in the microscope images). Continuing counterclockwise, as one moves towards the upper left, dyes begin to excite at slightly lower wavelength in the microscope images (405/490/570 nm), and so on all the way back down to the lower left corner where dyes only excite at the lowest wavelengths.

General Survey of Structure-Property Relationships

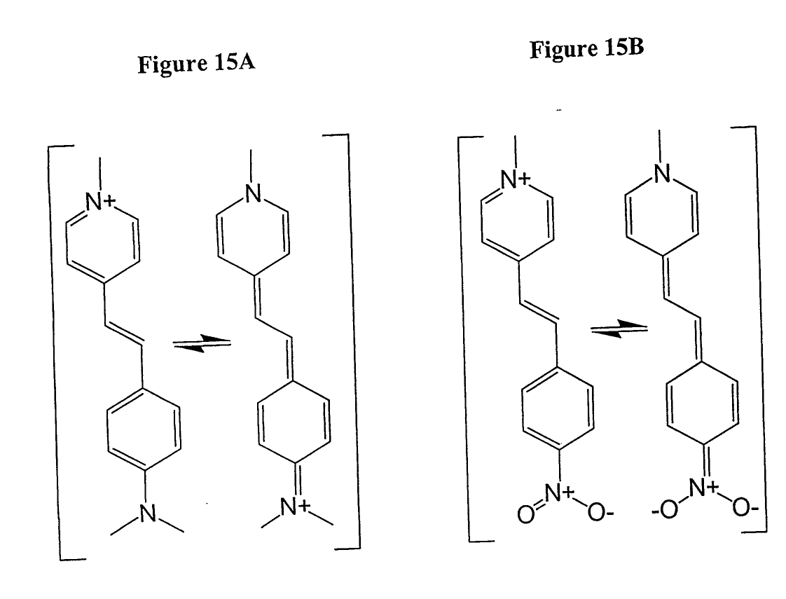

The overall trends in the data are consistent with expected relationships between the styryl molecules' spectral properties and chemical structure. For the B groups, for example, B7, B8, B9 and B14 groups possess conjugated aromatic systems that contribute the greatest number of π electrons. In the spectral excitation and emission data (FIG. 10A-10B), these groups strongly contribute towards the red end of the spectrum, which is expected based on quantum mechanical relationship between on the number of π electrons and the molecules higher excitation and emission. For the A groups, (N,N) dimethylaniline or an phenylamide substituent (A37, A27, A19, A18) contribute to increased resonance structures, as the partially pyramidal groups in aniline readily conjugate with the phenyl π system and lead to a delocalized positive charge spreading through the entire molecule. Briefly, FIGS. 15A and 15B show the resonance structure of (N,N) dimethylammonium phenyl FIG. 15A) and nitrophenyl (FIG. 15B) styryl derivatives, illustrating charge delocalization and interactions between A and B moieties resulting from the conjugated, π electron system. As expected in the excitation and emission data (FIGS. 10A-10B), these groups strongly contribute towards the red end of the spectrum, which is also expected based on quantum mechanical relationships based on the greater number of conjugated π electrons, and the greater degree of conjugation. In the case of nitrophenyl derivatives (A20, A21, A22, A36), the far red shift is not observed. This is expected because the oxygen groups are electron withdrawing (FIG. 15B), shifting fluorescence towards the blue.

In terms of the relationship between the chemical structure of styryl molecules and the localization properties, three alternative models can be proposed, for consideration. (See FIG. 7).

These models can be referred to as independent, cooperative and non-interactive. According to the independent model, the A and B groups contribute to localization by virtue of their independent, isolatable interaction with different localization determinants localized in the organelle. According to the cooperative model, A and B groups contribute to localization by interaction with the same localization determinant in the organelle. These interactions may be partly isolatable but the affinity is strongly dependent on both A and B being part of the same molecule. Lastly, according to the interactive model, A and B groups contribute to localization strictly as a result of how A and B interact when they are conjugated to each other, in a manner that A and B interaction with the organelle cannot be studied in isolation.

While the present invention is not limited to any particular mechanism, amongst these three models, the independent model best accounts for the localization data obtained with the styryl library. Accordingly, the affinity of group B for the mitochondria can be added to the affinity of A with mitochondria, to determine the total affinity of the styryl molecule for mitochondria. Nevertheless, the additive decomposition analysis does suggest that cooperative and interactive binding interactions do not play a significant role in determining mitochondrial localization, across the entire library of styryl compounds. This is not intuitive, because A and B moieties do interact at the chemical level within the individual molecules. For example, the resonance structures exhibited by the molecules (FIGS. 15A-15B) suggests that the electron distribution across the entire molecule is strongly dependent on functional groups associated with A and B.

Preferred embodiments of the present invention provide combinatorial libraries (e.g., of chemical address tags) of fluorescent compounds constructed by coupling various combinations of moieties to a common fluorescent scaffold. The present invention is not limited however to providing fluorescent chemical address tags, or to providing combinatorial libraries of styryl compounds comprising a part A and a part B.

In some embodiments, the chemical properties (e.g., peak emission or excitation wavelength) and biological properties (e.g., subcellular localization) of the resulting chemical address tags (e.g., styryl products) can be derive from characteristics already present in the individual building blocks that are used to synthesize the chemical address tags, or can emerge from complex physicochemical interactions observed only after the moieties are conjugated to each other. In still other preferred embodiments, because the individual building blocks are not fluorescent and the resulting product generally is, the resulting styryl compounds are readily detected and analyzed with a fluorometer.

In one embodiment, the present invention contemplates that the fluorescence and localization properties of the certain styryl chemical address tag products is additively encoded in the structure of the constituent moieties (building blocks) comprising the chemical address tag product. In these embodiments, the peak excitation and emission maxima, together with localization, are the sum of independent contributions of each of the two constituent moieties. In still further of these embodiments, most of the functional moieties are associated with a specific and consistent influence on biological and chemical properties of compounds of which they are a part. This influence is largely independent of the structure of the remainder of the compound. A given A group may consistently be associated with redder emission peaks, or with stronger mitochondrial localization, regardless of the B group to which it is joined, and vice versa.

Exemplary Compositions and Methods

The fluorescent biosensors of the present invention are useful experimental tools for cell biology, environmental monitoring, and pharmaceutical screening applications, and the like. There are general requirements in terms of what constitutes an ideal probe. For flow cytometry, for example, the present invention provides in some embodiments probes that are excited around 490 nm wavelength light, as flow cytometers commonly employ the 488 nm line of argon lasers as light source. For monitoring physiological function, a preferred embodiment of the present invention provides probes that are cell permeable, that associate with specific organelles, and that do not have a major effect on cell viability. For multiparameter cytometry, preferred embodiments of the present invention provide probes that emit in narrow fluorescence bands at a variety of different wavelengths, that show reduced phototoxicity or bleaching, and that localize to a specific organelle may be highly desirable.

The present invention contemplates that the simple additive interactions in large part determine the spectral and localization characteristics in the styryl dye compositions facilitates the design and synthesis of additional styryl compositions (e.g. chemical address tags) with ideal properties.

In additional embodiments, only a small fraction of the compounds in a proposed combinatorial library actually need to be synthesized and screened in order to attain accurate predictions of the localization and spectral properties throughout the library. Importantly, biased libraries that are optimally red and mitochondrial in localization or biased libraries that are optimally blue and non-mitochondrial in localization may be synthesized and screened, without having to synthesize and screen every possible styryl compound.

A major advantage of the present methods is the reduction of the amount of screening required to identify compounds in a library with optimal localization and spectral properties. In preferred embodiments, because the contribution of each of the two building blocks to localization and spectral properties are not interdependent, it is possible to synthesize combinatorial libraries (e.g., styryl derivatives) optimized for localization and that span the visible spectrum in terms of excitation and emission peaks.

With respect to analysis and visualization of the dataset, the present analysis methods allow for a reduction in the dimensionality of the data and provide a natural, robust way of clustering and visualizing the data.

In the past decade, the development of computational tools to handle massive amounts of data generated from high throughput screening experiments has been important to the widespread adoption of combinatorial chemistry in drug discovery. Automated, quantitative analysis of structure-activity relationships (QSAR), together with data visualization tools, is useful for dealing with huge numbers of compounds. As a clustering and visualization method, the analysis methods of the present invention are ideally suited for classifying fluorescent, organelle-targeted molecular probes, facilitating further synthesis, screening and analysis of larger combinatorial libraries of fluorescent styryl molecules, for biosensor applications.

Mechanistic Inferences

While the present invention is not limited to any particular mechanisms, and indeed and understanding of any particular underlying mechanism is not needed to make and use the present invention, the present invention contemplates that certain mechanistic inferences are possible. While the statistical models used herein are completely empirical, one can speculate as to the mechanistic nature of the molecular relationships. For example, for the spectral data, the additive relationship is plausible based on a “particle in a box” model, in which each of the two constituent moieties contributes a fixed number of π electrons to the styryl product. These π electrons resonate over the entire styryl structure via the conjugated bridge. Since the bridge is rigid, and the sizes of the moieties are roughly comparable, the “particle in a box” approximation explains the energy transitions in the product molecule as a non-interactive, additive function of characteristics (i.e., the number of π electrons and the physical dimensions of the space over which the electron resonates) contributed by each of the two moieties.

In another example, additivity in subcellular localization could be explained as the sum of the chemical potential of the interactions, independently contributed by each of the two constituent moieties towards localization to a particular organelle. For interactions between the cationic B moieties and mitochondria, the electrostatic potential may be the primary determinant of mitochondrial localization, explaining the observed lack of differential influence of chemical diversity of the pyridinium/quinolinium group on localization. For the interaction between the lipophilic A moieties and mitochondria, this interaction may be a function of chemical potential of the A moiety across the mitochondrial membrane.

Interestingly, both of these inferences on the fluorescence and localization properties of the styryl compounds suggest experimental hypothesis that are testable under well-defined conditions. In the case of localization properties, the response of styryl molecules to a transmembrane potential can be accurately determined using liposomes in the presence of an ionic gradient, and could be modeled using molecular dynamics simulations. In the case of spectral properties, quantum mechanical calculations may be used to independently establish how constituent building blocks of the styryl molecule contribute to the fluorescence properties of the resulting compounds.

III. Preparation and Evaluation of a Combinatorial Library of Fluorescent Styryl Cell-Permeable DNA Sensitive Dye Molecules

Certain embodiments, of the present invention provide novel DNA sensitive styryl dyes fabricated by an extended combinatorial synthesis and methods for cell-based screening and the fluorescence property measurements.

DNA-sensitive fluorescent probes have been widely used for cell imaging and DNA sequencing on gels. As most of the commonly used dyes, such as ethidium bromides and Sytox Green are not cell permeable, these cell imaging processes require damaging the cell's membrane or separating DNA from the cell in order to stain the nucleic acids. Only a few current cell permeable dyes, such as Hoechst 332585 and DAPI, are able to permeate the cell membrane and localize in the nuclei of living cells. The highly selective and sensitive DNA dyes of the present invention are thus of great importance.

While the present invention is not limited to any particular mechanism, and indeed and understanding of a mechanism is not important to making and using the present compositions, the present invention contemplates that the nuclear staining abilities of the present compositions may have two different mechanisms: 1) by binding to DNA or other nucleic targets with high affinity; or 2) by increasing their fluorescence intensity upon binding to DNA. It was envisioned that the latter case would provide novel DNA sensors.

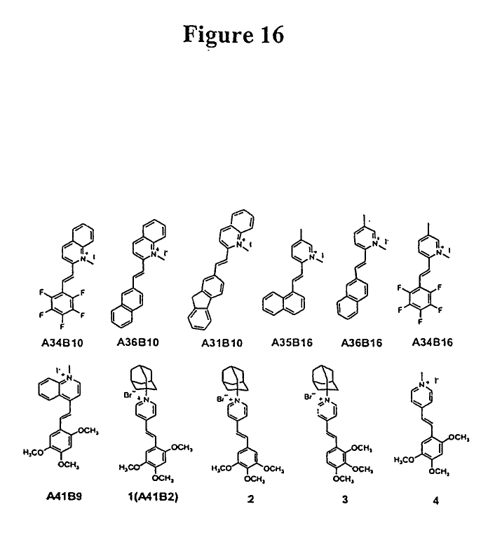

In one preferred embodiment, an extended styryl dye library, composed of 855 compounds, was synthesized (See, Example 7) and screened for the subcellular localization in live UACC-02 human melanoma cells on glass bottom 96-well plates by the combinatorial library synthesis methods disclosed herein. In one embodiments, 8 out of 855 compounds showed strong nuclear localization. The compounds were resynthesized on large scale for further study. (FIG. 16).

In some embodiments, the synthesis of compounds B was achieved by refusing with the pyridine derivatives and iodomethane for 2 hours, and compound B crystallized out in ethyl acetate. The condensation with aldehydes (A) and compound B was performed by refusing with piperidine for 2 hours in EtOH. After cooling to room temperature, the crystallized compounds were filtered and washed with ethyl acetate. With these purified compounds, the fluorescence intensity change upon addition of DNA was tested. Out of 8 nuclear localizing compounds, only compound 1 showed a strong fluorescence increase.

Compound 1 is an orange solid that exhibits an excitation wavelength of λ=413 nm and an emission wavelength of λ=583 nm. (Table 5). Table 5 shows the spectrophotometric properties of the styryl dyes.

TABLE 5

| | | | | | | Ø_{f}^{DNA}/ |
|---|---|---|---|---|---|---|
| Dye | ₘₐₓ/nm | ₑₘ^{free}/nm | ₑₘ^{DNA}/nm | Ø_{f}^{free} | Ø_{f}^{DNA} | Ø_{f}^{free} |
| 1 | 413 | 583 | 566 | 0.00024 | 0.0032 | 13.3 |
| 2 | 366 | 553 | 520 | 0.0051 | 0.022 | 4.3 |
| 3 | 370 | 491 | 592 | 0.0024 | 0.0037 | 1.5 |

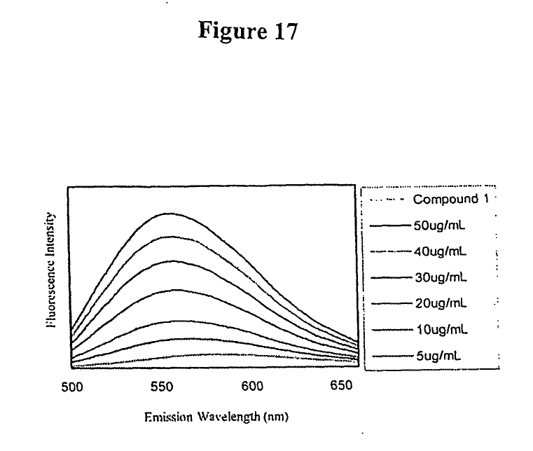

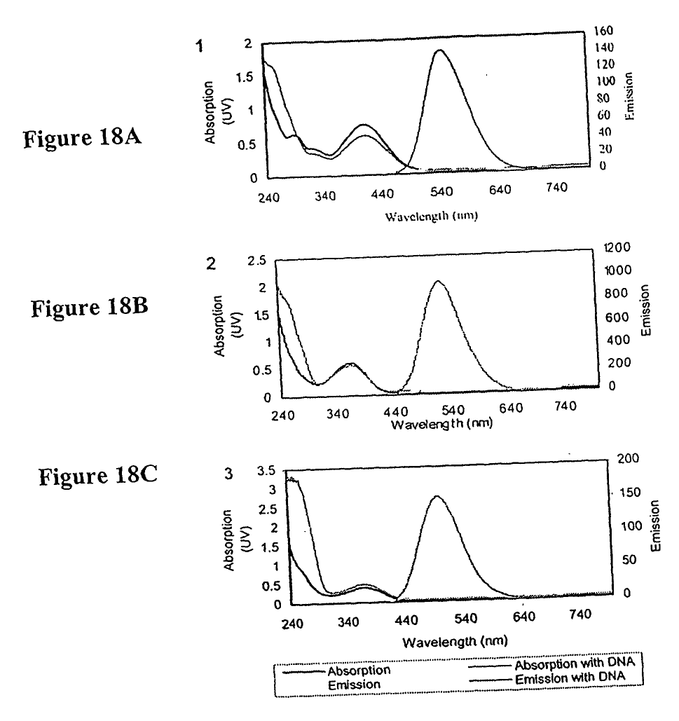

A linear fluorescence response was observed in the 0.05-100 μM range (in PBS: phosphate-buffered saline) without self-quenching or shifts in emission or excitation wavelengths. With a series of concentrations of dsDNA (double stranded DNA) added to compound 1, a linear increase in the fluorescence intensities was observed. (FIG. 17). FIG. 17 shows the fluorometric titration of compound 1 with dsDNA in a buffer solution (λₑₓ=394 nm, compound 1 [5 μM]). At the highest concentration of DNA tested (50 μg mL⁻¹), the fluorescence emission reached up to 13.3 times higher than that of the free compound. Briefly, FIGS. 18A-18C show the absorption and fluorescence spectra of compounds 1, 2, and 3 (Dye 1, 2, 3 [50 μM], dsDNA [50 μg mL⁻¹]). A blue shift of 17 nm in the emission wavelength upon DNA addition was observed, without a significant excitation wavelength shift. The structure of compound 1 includes a 2,4,5-trimethoxy group from the benzaldehyde moiety and a unique adamantyl pyridinium functionality.

Different trimethoxy isomers, 2 (3,4,5-trimethoxy) and 3 (2,3,4-trimethoxy), were synthesized to compare the positional effects of the methoxy groups in compound 1. (See FIG. 7). While the responses of compounds 2 and 3 to DNA treatment were similar to that of compound 1, the fluorescence emission increase was much smaller in 2 (4.3 fold) and 3 (1.5 fold). It is noteworthy that the intrinsic fluorescence intensities of compounds 2 and 3 arc higher than that of compound 1, but DNA treated samples showed comparable quantum yields. (Table 5). Compound 4 was also resynthesized and tested to study the structural importance of the adamantyl group in compound 1.

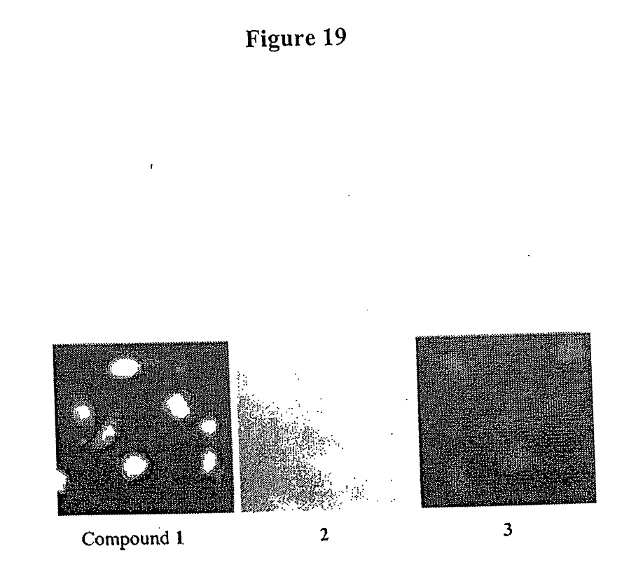

Interestingly, the simple exchange of the adamantyl with a methyl group significantly reduced the DNA response in compound 4. Therefore, both 2,4,5-trunethoxy groups and the adamantyl group are important in the specific interaction of compound 1 and DNA. The three related compounds 1, 2, and 3 were incubated in live UACC-62 human melanoma cells to compare their nuclear localization properties. (FIG. 19). FIG. 19 shows the nuclear staining of compounds 1, 2, and 3 (500 μM). In comparison to compound 1 in the same concentration, compounds 2 and 3 showed stronger fluorescence backgrounds and spread throughout the cytoplasm. However, compound 1 clearly stains the nucleus of live cells more selectively.

### EXAMPLES

The present invention provides the following non-limiting examples to further describe certain contemplated embodiments of the present invention.

### Example 1

### Creating and Validation of a Combinatorial Library of Organelle Specific Molecules

This example describes the synthesis and evaluation of a combinatorial library of fluorescent styryl compounds.

Materials and Methods

Unless otherwise noted in this example, the materials and solvents were obtained from commercial suppliers and were used without further purification. The plate reader used in this example was a Spectra Max Gemini XSF (Molecular Devices, Corp., Sunnyvale, Calif.). In preferred embodiments, for organelle-binding tests, UACC-62 melanoma cells were selected amongst a panel of 60 human cancer cell lines, because their well-spread morphology on glass made them ideally suited for imaging purposes as well as their relevance to biomedical research. (See e.g., R. H. Shoemaker et al., Development of human tumor cell line panels for use in disease oriented drug screening. In: Hall, T. ed., Prediction of Response to Anti-cancer Chemotherapy, New York N.Y.: Alan Liss, 265-286 [1988]).

In some of these embodiments, UACC-62 cells (obtained from the Developmental Therapeutics Program at the National Cancer Institute) were grown in RPMI medium supplemented with 10% fetal calf serum. For microscopy, cells were plated on 96 well tissue-culture plates (Falcon) overnight, in RPMI plus 10% fetal calf serum, at 37° C. in 5% CO₂/95% air. Cells were incubated with compounds at an approximate concentration of 50 μM for 1 hour.

A Zeiss Axiovert 135M (Carl Zeiss, Inc., Thornwood, N.Y.) inverted fluorescence microscope outfitted with a FITC/TRITC multipass filter cube (Chroma Technology, Corp., Rockingham, Vt.) was used for screening and routine cell biological fluorescence imaging applications. In some embodiments, epifluorescence microscopy was performed using a Zeiss Axiovert epifluorescence microscope equipped with a 20× objective.

General Procedure for Synthesis of Building Block B

The pyridine derivative (2.04 mmol) and iodomethane (2.14 mmol) in ethyl acetate were refluxed overnight. After it was cooled down to room temperature, the methylated product crystallized out. The crystals were filtered and washed with ethyl acetate three times, then dried. The purity was checked by IH-NMR. Yields range from 60% to 90%. B was purchased from Acros (Fisher Scientific, United Kingdom). 1H-NMR data of Building Block B:
A: (200 MHz, D₂0): σ=2.70 (s, 3H), 4.37 (s, 3H), 7.90-7.93 (d, J=6.4 Hz, 2H), 8.62-8.65 (d, J=6.64 Hz, 2H);
C: (200 MHz, D₂O): σ=2.83 (s, 3H), 4.27 (s, 3H), 7.82-7.96 (m, 2H), 8.36-8.40 (d, J=8 Hz, 1H), 8.70-8.73 (d, J=6.4 Hz, 1H);
D: (200 MHz, D₂0): σ=2.49 (s, 3H), 2.69 (s, 3H), 4.21 (s, 3H), 7.62-7.69 (dd, J=6.96, 7.04 Hz, 1H), 8.19-8.23 (d, J=7.68 Hz, 1H), 8.48-8.51 (d, J=5.94 Hz, 1H);
E: (200 MHz, D₂0): σ=1.20-1.28 (t, J=7.64 Hz, 3H), 2.71 (s, 3H), 2.71-2.84 (q, J=7.62, 2H), 4.17 (s, 3H), 7.74-7.78 (d, J=8.34 Hz, 1H), 8.19-8.23 (d, J=7.8 Hz, 1H), 8.52 (s, 1H);
F: (200 MHz, DMSO-d₆): σ=3.35 (s, 3H), 4.34 (s, 3H), 7.90-7.93 (d, J=6.38 Hz, 1H), 8.57 (s, 1H), 9.06-9.09 (d, J=6.42 Hz, 1H);
G: (200 MHz, D₂0): σ=2.94 (s, 3H), 4.90 (s, 3H);
H: (200 MHz, D₂0): σ=3.05 (s, 3H), 4.44 (s, 3H), 7.86-8.24 (m, 4H), 8.33-8.38 (d, J=8.88 Hz, 1H), 8.82-8.86 (d, J=8.42 Hz, 1H);
I: (200 MHz, D₂O): σ=3.00 (s, 3H), 3.99 (s, 3H), 4.40 (s, 3H), 7.59 (s, 1H), 7.72-7.77 (d, J=9,81, 1H), 7.80-7.84 (d, J=8.5 Hz, 1H), 8.25-8.80 (d, J=9.82 Hz, 1H), 8.69-8.73 (d, J=8.5 Hz, 1H);
J: (200 MHz, D₂O): σ=2.51 (s, 3H), 2.69 (s, 3H), 4.13 (s, 3H), 7.55-5.57 (d, J=4.37 Hz, 1H), 7.65 (s, 1H), 7.1-7.94 (d, J=6.24 Hz 1H), 7.94 (s, 1H), 8.59-8.62 (d, J=5.16 Hz, 1H), 8.69-8.72 (d, J=6.24, 1H);
K: (200 MHz, D₂O): σ=2.47 (s, 3H), 2.63 (s, 3H), 4.05 (s, 3H), 7.52-7.55 (d, J=6 Hz, 1H), 7.62 (s, 1H), 8.36-840 (d, J=8 Hz, 1H);
L: (200 MHz, D₂O): σ=2.72 (s, 6H), 4.00 (s, 3H), 7.62-7.66 (d, J=8.06 Hz, 2H), 8.06-8.14 (dd, J=7.86, 8.36 Hz, 1H);
M: (200 MHz, D₂O): σ=2.42 (s, 3H), 2.64 (s, 6H), 3.91 (s, 3H), 7.46 (s, 2H); and
N: (200 MHz, DMSO-d₆): σ=2.60 (s, 3H), 2.66 (s, 3H), 2.77 (s, 3H), 2.97 (s, 3H), 5.15 (s, 3H), 8.43-8.58 (dd, J=9.58, 10.64 Hz, 2H), 9.04 (s, 1H), 9.41 (s, 1H).
   General Procedure for Synthesis of the Combinatorial Styryl Library

Test reactions were carried out with representative aldehydes and methylated pyridine derivative to set up the best reaction conditions. Ethanol was found to be good solvent and pyrrolidine catalyst. (A. N. Kost et al., Zh. Obshch. Khim., 34:4046-4054 [1964]). Building blocks A and B were dissolved separately in absolute ethanol (100 mM) as stock solutions. In 96-well Gemini plates, 30 mM of each reactant (30 L), 40 L ethylene glycol, and 3 L pyrrolidine were added using a multi-pipette according to the library protocol. Pyrrolidine was added as a catalyst and ethylene glycol was added to make up for the evaporation of ethanol. In total, 12 plates were made to accommodate 1152 reactions. The condensation reaction was carried out in a short microwave, three minutes for each plate.

In another embodiment, the N-methylpyridinium iodide compounds (B) were synthesized by the methylation of commercially available 2- or 4-methylpyridine derivatives using methyl iodide. The condensation of A and B with a secondary amine catalyst was performed in 96 well plates, and the dehydration reaction was accelerated by microwave irradiation for five mins to give 10-90% conversion. The resulting library compounds were analyzed by LC-MS equipped with a diode array and fluorescence detectors, and fluorescence plate-readers to determine the absorption and emission maximum (λₑₓ and λₑₘ), and the emission colors.

Fluorescence Measurements Using a Plate Reader

After the microwave reaction, and without further purification, the library was examined by plate reader to get fluorescence data. The excitation wavelengths were set at 351 nm, 405 nm, 488 nm, 514 nm, and 570 nm. Emission wavelengths were fixed at 450 nm, 520 nm, 570 nm, 600 nm, 670 nm, and 730 nm to get the excitation spectrum. Both data were combined and analyzed to get excitation and emission wavelengths for the fluorescent compounds in the library. Because only a few compounds from the two building blocks are fluorescent, it is easy to tell whether the fluorescence is caused by the starting material or is the actual result of the products by comparing their spectrum. Random errors or systematic errors are minimized as much as possible by comparing the spectra for blank control, starting materials and the products. The data set is shown in Table 6 (see also FIG. 3).

TABLE 6

| | Peak | | | | |
|---|---|---|---|---|---|
| Compound | No. | EX(nm) | EM(nm) | LOC No. | Localization |
| 27 | 1 | 430 | 570 | 1 | GRANULE |
| 28 | 1 | 360 b | 560 | | |
| 34 | 1 | 360 | 420 | 1 | GRANULE |
| 37 | 1 | 390 | 480 | | |
| 41 | 1 | 420 | 450 | | |
| A1-B1 | 1 | 390 | 490 | 1 | CYTO |
| A5-B1 | 1 | 375 | 540 | | |
| A12-B1 | 1 | 330-460 | 540 | 1 | MITO |
| A13-B1 | 1 | 390 | 550 | | |
| A14-B1 | 1 | 430 b | 550 | 1 | MITO |
| A15-B1 | 1 | 390, 420 | 510 | | |
| A16-B1 | 1 | 390-420 | 510 | | |
| A18-B1 | 1 | 420 | 610 | | |
| A19-B1 | 1 | 460 | 600 | 1 | MITO |
| A19-B1 | | | | 2 | NUCLEOLI |
| A22-B1 | 1 | 400 | 540 | | |
| A23-B1 | 1 | 450 b | 540 | 1 | CYTO |
| A23-B1 | | | | 2 | MITO |
| A24-B1 | 1 | 400 | 530 | 1 | CYTO |
| A27-B1 | 1 | 450 | 640 | 1 | CYTO |
| A29-B1 | 1 | 400-420 | 560 | | |
| A30-B1 | 1 | 420-440 | 590 | | |
| A32-B1 | 1 | 400 | 510 | 1 | MITO |
| A32-B1 | | | | 2 | CYTO |
| A32-B1 | | | | 3 | VESICLE |
| A33-B1 | 1 | 360-420 | 600 | | |
| A36-B1 | 1 | 430 | 700 | | |
| A37-B1 | 1 | 460-490 | 580 | | |
| A38-B1 | 1 | 410 | 540 | | |
| A39-B1 | 1 | 430 | 540 | | |
| A1-B2 | 1 | 360-380 | 480 | 1 | CYTO |
| A5-B2 | 1 | 385 | 570 | | |
| A9-B2 | 1 | 390 | 500 | | |
| A11-B2 | 1 | 340-440 | 540 | 1 | MITO |
| A12-B2 | 1 | 340-444 | 530 | 1 | ER |
| A14-B2 | 1 | 360-450 | 550 | 1 | ER |
| A15-B2 | 1 | 390, 420 | 530 | | |
| A16-B2 | 1 | 400 | 590 | 1 | MITO |
| A18-B2 | 1 | 420 | 580 | | |
| A19-B2 | 1 | 380-540 | 610 | 1 | MITO |
| A19-B2 | | | | 2 | ER |
| A21-B2 | 1 | 390 | 540 | | |
| A22-B2 | 1 | 410-420 | 540 | | MITO |
| A23-B2 | 1 | 380-480 | 530 | 1 | CYTO |
| A24-B2 | 1 | 440 | 530 | 1 | MITO |
| A25-B2 | 1 | 430 | 570 | 1 | CYTO |
| A26-B2 | 1 | 420 | 540 | | |
| A27-B2 | 1 | 450 b | 630 | 1 | MITO |
| A27-B2 | | | | 2 | ER |
| A29-B2 | 1 | 400-420 | 560 | | |
| A30-B2 | 1 | 430, 450 | 590 | | |
| A31-B2 | 1 | 430 | 580 | 1 | MITO |
| A32-B2 | 1 | 400 | 510 | 1 | MITO |
| A33-B2 | 1 | 350-420 | 500 | 1 | MITO |
| A33-B2 | 2 | 360-400 | 580 | 2 | CYTO |
| A33-B2 | | | | 3 | VESICLE |
| A34-B2 | 1 | 460 | 610 | | |
| A36-B2 | 1 | 420 | 520 | 1 | MITO |
| A37-B2 | 1 | 490, 530 b | 700 | 1 | MITO |
| A38-B2 | 1 | 400-480 | 580 | 1 | NUCLEI |
| A38-B2 | | | | 2 | MITO |
| A39-B2 | 1 | 360-440 | 540 | 1 | MITO |
| A41-B2 | 1 | 470 b | 590 | 1 | GRANULE |
| A12-B3 | 1 | 390 b | 520 | 1 | MITO? |
| A12-B3 | | | | 2 | ER? |
| A13-B3 | 1 | 380 | 540 | | |
| A14-B3 | 1 | 390 | 530 | | |
| A15-B3 | 1 | 390 | 500 | | |
| A19-B3 | 1 | 460 b | 580 | 1 | MITO |
| A23-B3 | 1 | 420 | 530 | 1 | CYTO |
| A27-B3 | 1 | 450 | 620 | | |
| A32-B3 | 1 | 390 | 550 | | |
| A37-B3 | 1 | 520 | 680 | | |
| A38-B3 | 1 | 420 | 580 | | |
| A39-B3 | 1 | 340 | 520 | | |
| A40-B3 | 1 | 390 | 610 | | |
| A23-B4 | 1 | 420 b | 510 | 1 | CYTO |
| A37-B4 | 1 | 470 b | 650 | 1 | MITO |
| A12-B5 | 1 | 400 | 510 | 1 | VESICLE |
| A12-B5 | | | | 2 | ER |
| A13-B5 | 1 | 380 | 540 | | |
| A19-B5 | 1 | 460 b | 580 | 1 | MITO |
| A23-B5 | 1 | 420 b | 510 | 1 | CYTO |
| A24-B5 | 1 | 430 | 510 | | |
| A27-B5 | 1 | 430 | 620 | | |
| A32-B5 | 1 | 420 | 560 | | |
| A37-B5 | 1 | 520 | 670 | 1 | MITO |
| A37-B5 | | | | 2 | NUCLEOLI |
| A38-B5 | 1 | 430 | 560 | | |
| A39-B5 | 1 | 390-420b | 500 | | |
| A40-B5 | 1 | 390 | 610 | | |
| A9-B6 | 1 | 400 | 520 | | |
| A10-B6 | 1 | 460 | 520 | | |
| A16-B6 | 1 | 410 | 510 | | |
| A19-B6 | 1 | 440 b | 610 | | |
| A24-B6 | 1 | 460 | 550 | 1 | VESICLE |
| A27-B6 | 1 | 460 | 640 | | |
| A32-B6 | 1 | 410 | 530 | | |
| A33-B6 | 1 | 400 | 510 | | |
| A38-B6 | 1 | 460 | 540 | | |
| A39-B6 | 1 | 400-420 | 540 | | |
| A40-B6 | 1 | 540 | 640 | | |
| A7-B7 | 1 | 440 | 650 | 1 | MITO |
| A8-B7 | 1 | 440 | 650 | 1 | MITO |
| A9-B7 | 1 | 430 | 630 | 1 | MITO |
| A11-B7 | 1 | 420-480 | 600 | | |
| A12-B7 | 1 | 420-460 | 590 | 1 | MITO |
| A12-B7 | | | | 2 | NUCLEOLI |
| A13-B7 | 1 | 420 | 620 | | |
| A14-B7 | 1 | 480 b | 620 | 1 | MITO |
| A15-B7 | 1 | 420-460 | 560 | | |
| A16-B7 | 1 | 430 | 560 | | |
| A18-B7 | 1 | 430 | 670 | 1 | MITO |
| A19-B7 | 1 | 500 | 670 | 1 | MITO |
| A20-B7 | 1 | 490-540 | 670 | 1 | MITO |
| A21-B7 | 1 | 450-550 | 670 | 1 | MITO |
| A23-B7 | 1 | 450-500 | 610 | 1 | VESICLE |
| A24-B7 | 1 | 490 | 610 | 1 | MITO |
| A27-B7 | 1 | 450-550 b | 720 | 1 | MITO |
| A28-B7 | 1 | 450 | 620 | | |
| A29-B7 | 1 | 450 | 560 | | |
| A31-B7 | 1 | 430 | 650 | 1 | MITO |
| A31-B7 | | | | 2 | NUCLEOLI |
| A32-B7 | 1 | 430 | 560 | 1 | MITO |
| A33-B7 | 1 | 360-470 | 550 | 1 | MITO |
| A33-B7 | | | | 2 | CYTO |
| A37-B7 | 1 | 530 | 670 | | |
| A38-B7 | 1 | 420 | 640 | 1 | VESICLE |
| A38-B7 | | | | 2 | CYTO |
| A38-B7 | | | | 3 | NUCLEI |
| A39-B7 | 1 | 430 | 590 | | |
| A41-B7 | 1 | 500 | 660 | | |
| A1-B8 | 1 | 490, 530 | 640 | 1 | MITO |
| A2-B8 | 1 | 480 weak | 640 | | |
| A3-B8 | 1 | 530 | 640 | 1 | MITO |
| A4-B8 | 1 | 530 | 640 | | |
| A5-B8 | 1 | 480 | 640 | | |
| A6-B8 | 1 | 530 | 640 | | |
| A7-B8 | 1 | 420 | 650 | | |
| A8-B8 | 1 | 530 | 650 | | |
| A9-B8 | 1 | 430, 530 | 650 | 1 | MITO |
| A10-B8 | 1 | 530 | 650 | 1 | MITO |
| A11-B8 | 1 | 460 | 570 | | |
| A12-B8 | 1 | 430 | 560 | 1 | VESICLE |
| A13-B8 | 1 | 420 | 590 | | |
| A14-B8 | 1 | 420-520 | 590 | 1 | VESICLE |
| A15-B8 | 1 | 420 | 610-620 | 1 | MITO |
| A16-B8 | 1 | 450 | 630 | 1 | NUCLEOLI |
| A17-B8 | 1 | 430 | 650 | 1 | VESICLE |
| A17-B8 | 2 | 420 | 540 | 2 | NUCLEOLI |
| A18-B8 | 1 | 430 | 650 | 1 | MITO |
| A18-B8 | | | | 2 | NUCLEOLI |
| A19-B8 | 1 | 490 b | 640 | 1 | NUCLEOLI |
| A20-B8 | 1 | 420-530 | 620 | 1 | NUCLEOLI |
| A21-B8 | 1 | 420-550 | 630 | 1 | MITO |
| A21-B8 | | | | 2 | NUCLEOLI |
| A23-B8 | 1 | 420-480 | 580 | 1 | VESICLE |
| A23-B8 | | | | 2 | NUCLEOLI |
| A24-B8 | 1 | 400-500 | 560 | 1 | CYTO |
| A26-B8 | 1 | 530 | 650 | | |
| A27-B8 | 1 | 500 b | 620 | 1 | MITO |
| A28-B8 | 1 | 350-500 | 660 | 1 | NUCLEI |
| A31-B8 | 1 | 420 | 610 | 1 | MITO |
| A31-B8 | | | | 2 | NUCLEI |
| A32-B8 | 1 | 420 | 660 | 1 | MITO |
| A32-B8 | | | | 2 | NUCLEOLI |
| A33-B8 | 1 | 340-460 | 620 | 1 | MITO |
| A33-B8 | | | | 2 | NUCLEI |
| A33-B8 | | | | 3 | CYTO |
| A33-B8 | | | | 4 | VESICLE |
| A34-B8 | 1 | 460 | 650 | | |
| A39-B8 | 1 | 530 | 670 | | |
| A39-B8 | 1 | 430 b | 560 | 1 | CYTO |
| A41-B8 | 1 | 480 | 640 | | |
| A1-B9 | 1 | 460 | 630 | 1 | MITO |
| A3-B9 | 1 | 480 | 640 | 1 | MITO |
| A4-B9 | 1 | 400 b | 620 | 1 | GRANULE |
| A5-B9 | 1 | 420 | 650 | | |
| A10-B9 | 1 | 440, 360 | 520 | 1 | CYTO |
| A10-B9 | 2 | 440, 360 | 640 | 2 | VESICLE |
| A11-B9 | 1 | 430 | 560 | | |
| A12-B9 | 1 | 360, 430 | 560 | 1 | VESICLE |
| A13-B9 | 1 | 430 | 580 | | |
| A14-B9 | 1 | 460 | 580-590 | 1 | VESICLE |
| A15-B9 | 1 | 360 | 520 | | |
| A16-B9 | 1 | 360 | 530 | 1 | VESICLE |
| A16-B9 | 2 | 360-460 | 610 | 2 | NUCLEOLI |
| A17-B9 | 1 | 360, 430 | 510 | 1 | VESICLE |
| A18-B9 | 1 | 430 b | 650 | 1 | NUCLEOLI |
| A19-B9 | 1 | 390-550 | 630 | 1 | NUCLEOLI |
| A20-B9 | 1 | 420 b | 620 | 1 | NUCLEOLI |
| A21-B9 | 1 | 390 | 620 | 1 | VESICLE |
| A21-B9 | | | | 2 | NUCLEOLI |
| A22-B9 | 1 | 360 | 510 | | |
| A23-B9 | 1 | 340-360 | 550 | | |
| A24-B9 | 1 | 360 | 530 | | |
| A25-B9 | 1 | 430 | 520 | | |
| A26-B9 | 1 | 360-420 | 630 | | |
| A27-B9 | 1 | 420 | 630-660 | 1 | NUCLEOLI |
| A28-B9 | 1 | 450 b | 660 | 1 | NUCLEOLI |
| A29-B9 | 1 | 360, 420 | 580 | | |
| A30-B9 | 1 | 330, 430 | 630 | 1 | MITO |
| A31-B9 | 1 | 380 | 610 | 1 | MITO |
| A31-B9 | | | | 2 | NUCLEI |
| A31-B9 | | | | 3 | CYTO |
| A32-B9 | 1 | 360-440 | 610 | 1 | MITO |
| A32-B9 | | | | 2 | NUCLEI |
| A32-B9 | | | | 3 | NUCLEOLI |
| A33-B9 | 1 | 420 | 640 | 1 | VESICLE |
| A33-B9 | 2 | 320-460 | 560 | 2 | MITO |
| A33-B9 | | | | 3 | NUCLEI |
| A34-B9 | 1 | 490 | 650 | | |
| A35-B9 | 1 | 320-360 | 580 | 1 | CYTO |
| A36-B9 | 1 | 360 | 530 | | |
| A37-B9 | 1 | 530 | 700-730 | 1 | CYTO |
| A38-B9 | 1 | 390 | 620 | 1 | CYTO |
| A39-B9 | 1 | 380 | 500 | | |
| A41-B9 | 1 | 480 | 630 | | |
| A1-B10 | 1 | 450 | 620 | 1 | MITO |
| A3-B10 | 1 | 450 | 620 | 1 | MITO |
| A6-B10 | 1 | 400 | 520 | | |
| A9-B10 | 1 | 420 b | 520 | 1 | MITO |
| A10-B10 | 1 | 350-450 | 520 | 1 | MITO |
| A11-B10 | 1 | 420 | 560 | | |
| A12-B10 | 1 | 350-470 | 560 | 1 | VESICLE |
| A13-B10 | 1 | 370, 420 | 590 | | |
| A14-B10 | 1 | 420-480 | 580 | | |
| A15-B10 | 1 | 340-440 | 530 | 1 | VESICLE |
| A16-B10 | 1 | 350-460 | 530 | 1 | VESICLE |
| A19-B10 | 1 | 480 | 640 | 1 | MITO |
| A20-B10 | 1 | 420 | 620 | 1 | VESICLE |
| A23-B10 | 1 | 430-460 | 570 | | |
| A24-B10 | 1 | 420-500 | 560 | | |
| A27-B10 | 1 | 460 | 670 | | |
| A31-B10 | 1 | 400, 420 | 520 | 1 | MITO |
| A32-B10 | 1 | 350-450 | 530 | 1 | MITO |
| A33-B10 | 1 | 320-450 | 520 | 1 | MITO |
| A34-B10 | 1 | 430 | 630 | | |
| A35-B10 | 1 | 340-420 | 580 | 1 | CYTO |
| A36-B10 | 1 | 420 | 540 | | |
| A37-B10 | 1 | 550 b | 730 | 1 | ER |
| A38-B10 | 1 | 380-500 | 590 | 1 | MITO |
| A39-B10 | 1 | 350-450 | 560 | 1 | MITO |
| A40-B10 | 1 | 400 | 580 | | |
| A41-B10 | 1 | 460 | 630 | | |
| A9-B11 | 1 | 400 | 510 | 1 | MITO |
| A10-B11 | 1 | 420 | 500 | 1 | MITO |
| A12-B11 | 1 | 390 b | 530 | 1 | ER |
| A13-B11 | 1 | 370 | 550 | | |
| A14-B11 | 1 | 420 | 540 | 1 | MITO |
| A15-B11 | 1 | 390 | 510 | | |
| A16-B11 | 1 | 400 | 500 | | |
| A17-B11 | 1 | 410 b | 510 | 1 | ER |
| A19-B11 | 1 | 460 | 580 | 1 | MITO |
| A23-B11 | 1 | 460 | 550 | 1 | CYTO |
| A24-B11 | 1 | 380-480 | 520 | 1 | MITO |
| A27-B11 | 1 | 450 b | 630 | 1 | MITO |
| A30-B11 | 1 | 410-480 | 610 | | |
| A32-B11 | 1 | 320-440 | 510 | 1 | MITO |
| A33-B11 | 1 | 320-460 | 510 | 1 | MITO |
| A34-B11 | 1 | 450 | 610 | | |
| A36-B11 | 1 | 410 | 520 | | |
| A37-B11 | 1 | 490 b | 670 | 1 | VESICLE |
| A38-B11 | 1 | 430 b | 580 | | |
| A39-B11 | 1 | 390 | 530 | 1 | MITO |
| A40-B11 | 1 | 380 | 610 | | |
| A10-B12 | 1 | 420 | 510 | 1 | MITO |
| A12-B12 | 1 | 390 | 520 | 1 | ER |
| A13-B12 | 1 | 380 | 540 | | |
| A14-B12 | 1 | 420 b | 570 | 1 | MITO |
| A14-B12 | | | | 2 | ER |
| A15-B12 | 1 | 390 | 570 | | |
| A16-B12 | 1 | 390 | 500 | | |
| A17-B12 | 1 | 420 | 500 | 1 | ER |
| A19-B12 | 1 | 450 | 580 | 1 | MITO |
| A23-B12 | 1 | 420 | 570 | 1 | CYTO |
| A24-B12 | 1 | 430 | 500 | | |
| A27-B12 | 1 | 430 | 620 | | |
| A32-B12 | 1 | 400 b | 520 | 1 | MITO |
| A33-B12 | 1 | 360-470 | 500 | 1 | MITO |
| A35-B12 | 1 | 420 | 510 | 1 | MITO |
| A37-B12 | 1 | 480 | 680 | | |
| A38-B12 | 1 | 420 | 570 | | |
| A39-B12 | 1 | 390 | 510 | | |
| A40-B12 | 1 | 380 | 620 | | |
| A12-B13 | 1 | 400 | 520 | 1 | ER |
| A13-B13 | 1 | 380 | 540 | | |
| A14-B13 | 1 | 420 b | 540 | 1 | MITO |
| A15-B13 | 1 | 390 | 510 | | |
| A17-B13 | 1 | 410 | 510 | 1 | ER |
| A19-B13 | 1 | 450 | 590 | 1 | MITO |
| A23-B13 | 1 | 420 | 540 | 1 | CYTO |
| A24-B13 | 1 | 430 | 520 | | |
| A27-B13 | 1 | 440 b | 620 | 1 | MITO |
| A30-B13 | 1 | 430 | 600 | | |
| A32-B13 | 1 | 390 b | 510 | 1 | MITO |
| A33-B13 | 1 | 320-440 | 500 | 1 | MITO |
| A37-B13 | 1 | 520 | 685 | | |
| A38-B13 | 1 | 430 | 580 | | |
| A39-B13 | 1 | 390 | 520 | 1 | MITO |
| A40-B13 | 1 | 460 | 620 | | |
| A4-B14 | 1 | 420 | 610 | | |
| A19-B14 | 1 | 580 b | 680 | 1 | NUCLEOLI |
| A20-B14 | 1 | 580 b | 670 | 1 | NUCLEOLI |
| A21-B14 | 1 | 420 | 610 | | |
| A24-B14 | 1 | 540 | 590 | 1 | CYTO |
| A30-B14 | 1 | 550 | 590-700 | | |
| A31-B14 | 1 | 380 | 600 | | |
| A37-B14 | 1 | 470 | 540 | 1 | MITO |
| A37-B14 | 2 | 530, 360 | 730 | 2 | NUCLEOLI |
| A38-B14 | 1 | 490 | 620 | | |

Organelle-Binding Tests

The library compounds, without further purification, were incubated with live UACC-62 human melanoma cells growing on glass bottom 96-well plates (Sigma-Aldrich Corp., St. Louis, Mo.), and the localizations of the different compounds in the cells were determined by an inverted fluorescence microscope (λₑₓ=405, 490, and 570 nm; λₑₘ>510 nm) at 1000× magnification. Based on their morphology and subcellular distribution, the localizations were ascribed to mitochondria, ER (endoplasmic reticulum), nucleoli, nuclear, and cytoplasmic staining patterns such as diffuse (based on the homogenous staining appearance and exclusion from the nucleus), granular (punctate staining pattern, generally associated with the cell margins) or vesicular (heterogeneous staining pattern, generally associated with the nuclear periphery). Localization studies were performed without a priori information of the compounds' molecular structures. It was possible to ascribe the localization of the compounds to nucleus or cytoplasm, as these organelles are clearly discernible with phase contrast optics. Similarly, it was possible to ascribe localization to nucleoli, as these structures appeared as the most prominent, phase-dense structures within the nucleus. Localization to mitochondria was based on the elongated, characteristic shape of these organelles, which stain positive with established mitochondrial-specific fluorescent probes, like rhodamine 1,2,3 or JC-1. (L. B. Chen, Methods Cell Bio., 29:103-123 [1989]). Similarly, localization to the endoplasmic reticulum could be ascribed based on the characteristic, reticular morphology of this organelle. (M. Terasaki and T. S. Reese, J. Cell. Sci., 101(Pt. 2):315-322 [1992]). All the measurements were performed within an hour before any of the compound's toxicity appeared (normally several hours). The tested concentrations of the dyes are approximately 10-20 μM. The localization results are shown in Table 6. Together with the fluorescence data set, Table 7 demonstrates the labeling capability of the present fluorescent toolbox. Subcellular fractionation of different organelles using analytical centrifugation and biochemical analysis of the compound's affinity for these fractions is in progress as well as the studies of the relationship between chemical structure and localization.

TABLE 7

| COLOR- | | | | | | | |
|---|---|---|---|---|---|---|---|
| WAVELENGTH | MITO | GRAN | VESICLE | ER | NUCLEOLI | NUCLEI | CYTO |
| 700-750 | 2 | | | 1 | | | 1 |
| 660-700 | 4 | | 1 | | 3 | | |
| 610-660 | 20 | 1 | 2 | | 7 | 1 | 2 |
| 580-610 | 9 | 1 | 2 | | | | 3 |
| 560-580 | 2 | 1 | 3 | | | | 5 |
| 540-560 | 6 | | | 1 | | | 2 |
| 500-540 | 21 | | 3 | 7 | | | 5 |
| 490-500 | | | | | | | 1 |
| 420-490 | | 1 | | | | | 1 |
| TOTALS | 64 | 4 | 11 | 9 | 10 | 1 | 20 |

Purified Representative Compound Data

Compounds were purified by semi prep HPLC (Waters Delta 600) using a C 18 column (250×21.2 mm, Phenomenex, Inc., Torrance, Calif.) with a gradient of 5-95% CH₃CN—H₂0 as the eluant over 20 mins. Fractions were identified by their diode array detector signal and collected (Waters 996, Waters, Corp., Milford, Mass.). The purified compounds were characterized by LC-MS (Agilent HP 1100) using a C 18 column (20×4.0 mm) with a gradient of 5-95% CH₃CN—H₂0 (containing 1 acetic acid) as the eluant over 4 mins.

### Example 2

### Additive Decomposition for Emission and Excitation Spectra

In some embodiments, the wavelength values for peak excitation and emission were fit to the additive model λᵢⱼ=αᵢ+βⱼ+εᵢⱼ, where εᵢⱼ denotes error that is made as small as possible in the fitting process. Using least squares to minimize the function

$${\sum }_{ij} = {( {λ}_{ij} - {α}_{i} - {β}_{j} )}^{2} \qquad ( Equation 5 )$$

over all compounds having experimental data yields coefficient estimates αᵢ for each A group and βⱼ for each B group. One set of coefficient estimates is obtained for the excitation values and another set is obtained for the emission values. To predict the wavelength of a new compound formed from A and B groups i* and j* the sum α_{i*}+β_{j*} is used.

### Example 3

### Additive Decomposition for Subcellular Localization

In some embodiments, subcellular localization data were converted to binary (0/1) values by assigning a value Gᵢⱼ=1 if compound i,j localized to mitochondria (even if it localized to other compounds as well), and assigning Gᵢⱼ=0 if compound i,j localized exclusively to any non-mitochondrial cellular structure. Compounds with no localization were omitted from this part of the analysis. The αᵢ and βⱼ coefficients for A or B groups that are always observed to localize to mitochondria, or that never localize to mitochondria, were set to +/−5, respectively. The binary localization data were analyzed using factorial logistic regression. This method assigns scores αᵢ and βⱼ to each A and B group respectively, so that αᵢ+βⱼ>0 when compound i,j has a localization value of 1 (i.e. mitochondrial), and αᵢ+βⱼ<0 when compound i,j has a localization value of 0 (i.e. non-mitochondrial). Specifically, the method maximizes the following function:

$${\sum }_{ij \text{:} Gij = 1} {α}_{i} + {β}_{j} - \sum {log}_{ij} ( 1 + exp ( {α}_{i} + {β}_{j} ) ) \qquad ( Equation 6 )$$

To predict the localization of a new compound formed from A and B groups i* and j* the sum α_{i*}+β_{j*} is calculated, and the new compound is predicted to be mitochondrial if the sum is positive, and non-mitochondrial if the sum is negative. Larger magnitude values for this sum indicates a greater probability of mitochondrial localization.

### Example 4

### Cross-Validation

In some embodiments, for both the spectral and localization analysis, cross-validation was used to obtain unbiased estimates of the prediction performance. Each compound was held out in sequence, and the coefficients αᵢ and βⱼ were fit to the remaining compounds. These values were then used to form a prediction for the held out compound, then the predicted and experimental values were compared to obtain a measure of the accuracy of prediction. Since the wavelength values are on a continuous scale, the predicted values were compared to the experimental values using Pearson correlation coefficients. The localization values are dichotomous, so the proportion of matching predictions was used to compare predicted and experimental localization values.

### Example 5

### Statistical Significance Analysis

In some embodiments, the statistical significance of the prediction results was determined by comparing the actual prediction performance to the distribution of performances that would be obtained if the data were randomized. For the localization analysis, performance was measured using the proportion of correctly predicted compounds. The distribution of this proportion when the data are randomized follows the binomial distribution. Thus the p-value, which is the likelihood of getting better than the observed prediction results by chance, can be calculated using a table of the binomial distribution. For the spectral analysis, performance was measured using the correlation coefficient between predicted and experimental values. The distribution of these values under randomization can be determined empirically, by repeatedly randomizing the experimental values and repeating the analysis. The proportion of these randomized correlation coefficients that exceed the observed coefficient is reported as the p-value.

### Example 6

### Similarity Metrics and Cluster Analysis for Data Visualization

In some embodiments, the additive decomposition can be used to cluster the data by reordering the rows and columns of the data matrix so that the fitted ᵢ and ⱼ coefficients are non-decreasing. The relationship between different A and B functionalities was calculated using a variety of commonly-used similarity metrics (between groups, within groups, nearest neighbor, furthest neighbor, etc). The resulting relationships were then organized into categories using anyone of a variety of hierarchical clustering algorithms. None of the similarity metrics and hierarchical clustering algorithms tested yielded results that were as satisfactory as those obtained with the additive decomposition analysis, for reasons explained in the text.

### Example 7

### Cell-Permeable DNA Sensitive Dyes Using Combinatorial Synthesis and Cell-Based Screening

This example describes the synthesis of novel cell-permeable DNA sensitive dyes.

Materials and Methods

Unless otherwise noted, starting materials and solvents were purchased from commercial suppliers, and used without purification. Ethanol (EtOH) and ethyl acetate (EA) from Acros Organics (Fisher Scientific, UK) were used as the reaction solvents without any prior purification. Salmon testes solid dsDNA, and phosphate buffered saline (PBS) (NaCl 120 mM, KCl 2.7 mM, and phosphate buffer 10 mM, pH=7.4 at 24° C.) were purchased from Sigma-Aldrich and needed no further purification. Fluorescence intensities were measured by a Jobin Yvon Horiba FluoroMAX-3 fluorimeter (Horiba Group, Kyoto, Japan) with a quartz cuvette cell (10 mm×10 mm×4.5 cm; Starna (Atascadero, Calif.). ¹H-NMR (200 MHz) spectra were determined on Gemini 200 spectrometer (Varian, Inc., Palo Alto, Calif.). Chemical shifts were reported in parts per million (ppm) relative to the line of a singlet at 2.50 ppm for DMSO-d₆ and coupling constants (j) are in Hertz (Hz). The following abbreviations are used for spin multiplicity: s=singlet, d=doublet, t=triplet, m=multiplet, and b=broad. All dye products were identified by LC-MS from Agilent Technology (Palo Alto, Calif.), using a C18 column (20×4.0 mm), with 4 minutes elution using a gradient of 5-95% CH₃CN (containing 1% acetic acid)-H₂O (containing 1% acetic acid), with UV detector at %=400 nm and an electrospray ionization source.

### Preparation of 2-[4-[5-(trimethyoxy)phenyl]-ethenyl-1-adamantyl]-4-methylpyridinium bromide (1)

1-(1-adamantyl)-4-methylpyridinium bromide (20 mg, 0.06 mmol) and 2,4,5-trimethoxybenzaldehyde (30 mg, 0.15 mmol) were dissolved in ethanol (4 mL). piperidine (0.4 mL) was added to the reaction mixture. The reaction mixture was refluxed for 3 hours. After the reaction was completed, the mixture stood at 0° C. overnight. Orange solid was filtered and washed with EtOAc (10 mL) yielding 1 (23.4 mg, 80%) as yellow solid. LC-MS: RT=1.87 m/z: 406.2 [M]⁺; ¹H-NMR (DMSO-d₆): δ 1.75 (s, 6H), 2.24 (s 9H), 3.80 (s, 3H, OCH₃), 3.89 (s, 3HOCH₃), 3.9 (s, 3H, OCH₃) 6.78 (s, 1H), 7.39 (s, 1H), 7.44 (d, 1H, J=12 Hz), 8.1 (m, 3H), 9.1 (d, 2H, J=6 Hz).

### Preparation of 3-[4-[5-(trimethyoxy)phenyl]-ethenyl-1-adamantyl]-4-methylpyridinium bromide (2)

1-(1-adamantyl)-4-methylpyridinium bromide (30 mg, 0.1 mmol) and 3,4,5-trimethyoxybenzaldehyde (57.3 mg, 0.3 mmol) were dissolved in ethanol (5 mL). Piperidine (0.4 mL) was added to the reaction mixture. The reaction mixture was refluxed for 2 hours. After the reaction was completed, the mixture stood at 0° C. overnight. The yellow solid was filtered and washed with EtOAc (10 mL) yielding 2 (11.2 mg, 23%) as yellow solid. LC-MS: RT=1.809 m/z: 406.2 [M]⁺; ¹H-NMR (DMSO-d₆): δ 1.75 (s, 6H), 2.30 (s 9H), 3.74 (s, 3H, OCH₃), 3.89 (s, 6H, OCH₃), 7.15 (s, 2H), 7.60 (d, 1H, J=14 Hz), 8.07 (d, 1H, J=14 Hz), 8.2 (d, 3H, J=6 Hz), 9.2 (d, 2H, J=6 Hz).

### Preparation of 2-[3-[4-(trimethyoxy)phenyl]-ethenyl-1-adamantyl]-4-methylpyridinium bromide (3)

1-(1-adamantyl)-4-methylpyridinium bromide (30 mg, 0.1 mmol) and 2,3,4-trimethyoxybenzaldehyde (57.3 mg, 0.3 mmol) were dissolved in absolute ethanol (5 mL). Piperidine (0.2 mL) was added to the reaction mixture. The reaction mixture was refluxed for 2 hours. After the reaction was completed, the mixture stood at 0° C. overnight. Solid was filtered and washed with EtOAc (10 mL) yielding 3 as a yellow solid (14.9 mg, 30%). LC-MS: RT=1.833 m/z: 406.2 [M]⁺; ¹H-NMR (DMSO-d₆): δ1.75 (s, 6H), 2.28 (s 9H), 3.80 (s, 3H, OCH₃), 3.89 (s, 6H, OCH₃), 6.96 (d, 1H, J=6 Hz), 7.49 (d, 1H, J=14 Hz), 8.55 (d, 1H, J=6 Hz), 8.0 (d, 1H, J=14 Hz), 8.23 (d, 2H, J=6 Hz), 9.15 (d, 2H, J=6 Hz).

### Preparation of 1-Methyl-4[2-(2,4,5-trimethoxy-phenyl)-vinyl]pyridinium iodide (4)

1,4-dimethyl pyridinium iodide (20 mg, 0.085 mmol) and 2,4,5-trimethoxybenzaldehyde (49 mg, 0.25 mmol) were dissolved in absolute ethanol (5 mL). Piperidine (0.13 mL) was added to the reaction mixture. The reaction mixture was refluxed for 3 hours. After the reaction was completed, the mixture stood at 0° C. overnight. The solid was filtered and washed with EtOAc (10 mL) yielding 4 as a light yellow solid (6.2 mg, 17.7%). LC-MS: RT=1.56 m/z: 286.1 [M]⁺; ¹H-NMR (DMSO-d₆): δ3.80 (s, 3H, OCH₃), 3.89 (s, 3H, OCH₃), 3.89 (s, 3H, OCH₃), 4.20 (s, 3H, CH₃), 6.79 (s, 1H), 7.34 (s, 1H), 7.41 (d, 1H, J=14 Hz), 8.04 (d, 1H, J=14 Hz), 8.11 (d, 2H, J=6 Hz), 8.75 (d, 2H, J=6 Hz).

### Example 8

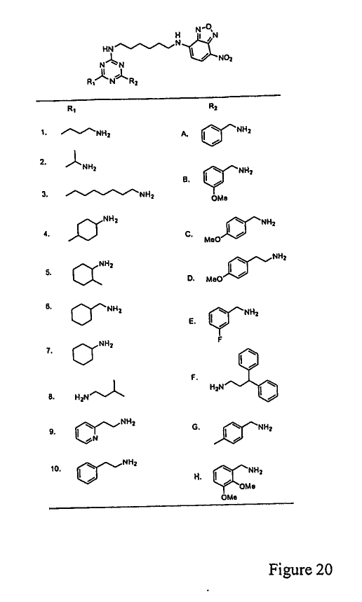

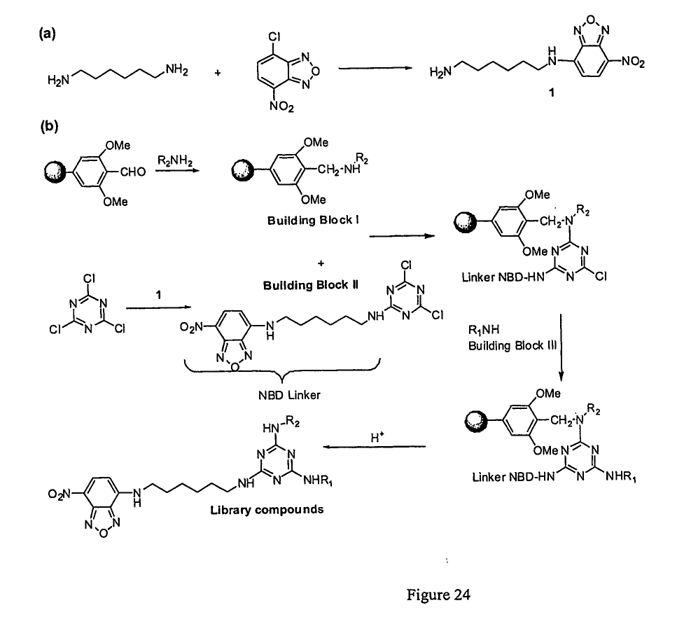

A tagged, fluorescent combinatorial library (see, e.g., S. M. Khersonsky et al., Journal of the American Chemical Society 125, 11804 (2003); H. S. Moon et al., Journal of the American Chemical Society 124, 11608 (2002); each herein incorporated by reference in their entireties) of NBD-triazine derivatives was synthesized to monitor the uptake and compartmentalization of a structurally varied group of molecules spanning a range of physicochemical properties (see, e.g., FIGS. 20 and 24).

An NBD moiety was attached to a six-carbon linker; and the resulting NBD linker was tethered to a triazine scaffold. The scaffold was diversified at the R₁ and R₂ positions resulting in 80 final compounds. The purity and identity of all the final products were monitored by LC-MS. Greater than 90% of the compounds demonstrated >90% purity. The present invention is not limited to a particular mechanism. Indeed, an understanding of the mechanism is not necessary to practice the present invention. Nonetheless, based upon the tagged, fluorescent combinatorial library developed during the course of the present invention, a fluorescent-tagged library approach allows for facile high-throughput organelle directed screening.

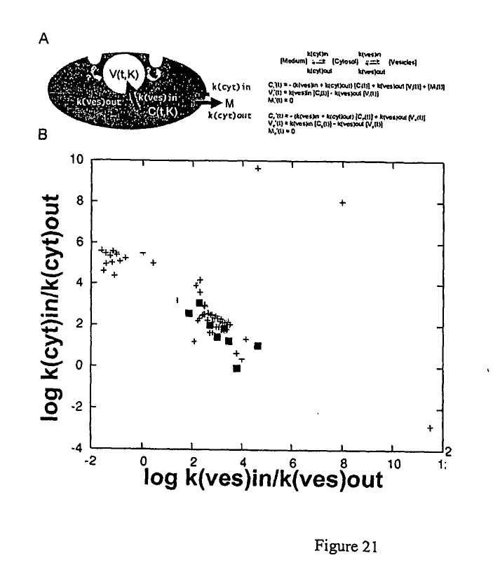

In living cells, image data was simultaneously acquired with an automated, high-content, kinetic screening instrument equipped with an environmental chamber (see, e.g., V. C. Abraham, D. L. Taylor and J. R. Haskins, Trends in Biotechnology 22, 15 (2004); herein incorporated by reference in its entirety), as cells were incubated with the fluorescent molecules and after removal of extracellular probe. Data was analyzed off line, using an image analysis algorithm to measure the statistical pixel intensity distribution associated with fluorescence probe sequestration in the perinuclear region (see, e.g., FIG. 21; see also, e.g., G. J. Ding et al., Journal of Biological Chemistry 273, 28897 (1998); herein incorporated by reference in its entirety). Data was parametrized with a nested, two-compartment, transport model (see, e.g., W. E. Evans, J. J. Schentag and W. J. Jusko., Applied Pharmacokinetics: Principles of Therapeutic Drug Monitoring (Lippincott Williams & Wilkins, Vancouver, W.A., 1992); herein incorporated by reference in its entirety), using a statistical link function to relate the kinetic coefficient of variation (CV) of pixel intensities in the images with the concentration of probe in vesicles and cytoplasm. Optimal kinetic parameters fitting the experimental data for each probe to the system described by the two-compartment model and statistical link function were determined using the simulated annealing technique (see, e.g., M. Pincus., Oper. Res. 18, 1225 (1979); herein incorporated by reference in its entirety). The present invention is not limited to a particular mechanism. Indeed, an understanding of the mechanism is not necessary to practice the present invention. Nonetheless, the results indicate that overall probe behavior conforms to a nested, two compartment dynamical system (FIGS. 21A and 26).

To assess how well the model accounts for all the different kinetic traces acquired, a “PVE” (proportion of variance explained) by the model was calculated. The PVE is one minus the ratio of the sum of squared differences between observed and fitted values to the sum of squared differences between observed values and their mean. PVE values close to one indicate good fit to the nested two-compartment model. The average PVE across the probes was 0.92, with >50% of the probes yielded PVE values ≧95. The present invention is not limited to a particular mechanism. Indeed, an understanding of the mechanism is not necessary to practice the present invention. Nonetheless, based upon the average PVE across the probes was 0.92, with >50% of the probes yielded PVE values ≧95, the results indicate an excellent fit to the data (Table 8).

Table 8 presents a tabular summary of optimization results from plots of the fits of the kinetic data for the fluorescence probes, in relation to the experimentally measured CV values, including the optimal PVE values calculated for each probe.

TABLE 8
Summary of Optimization Results

| | | median | min | max | median | min | max | median | | | max | optimal |
|---|---|---|---|---|---|---|---|---|---|---|---|---|
| Probe | PVE | Pap(ves) | Pap(ves) | Pap(ves) | Pap(cyto) | Pap(cyto) | Pap(cyto) | lambda(min, max) | median p | min p | p | solutions |
| D10 | 1 | 13.79( | 8.05, | 24.95) | 9.41( | 4.90, | 18.15) | 158.8(154.5, 162.9) | 0.67( | 0.57, | 0.73) | 67 |
| G9 | 0.99 | 0.20( | 0.20, | 0.20) | 267.03( | 267.03, | 267.03) | 103.2(103.2, 103.2) | 0.09( | 0.09, | 0.09) | 1 |
| H3 | 0.99 | 14.91( | 7.08, | 154.52) | 7.51( | 0.99, | 48.73) | 31.4(15.5, 70.1) | 0.67( | 0.60, | 0.93) | 61 |
| B8 | 0.99 | 23.66( | 19.56, | 37.76) | 9.79( | 5.84, | 12.46) | 98.2(94.3, 100.9) | 0.83( | 0.82, | 0.85) | 71 |
| H6 | 0.99 | 22.55( | 15.61, | 35.03) | 8.77( | 5.27, | 13.44) | 130.2(126.0, 134.2) | 0.82( | 0.80, | 0.85) | 62 |
| E4 | 0.99 | 16.46( | 5.17, | 85.71) | 11.91( | 2.12, | 43.47) | 69.1(59.1, 71.8) | 0.43( | 0.39, | 0.60) | 66 |
| B4 | 0.99 | 12.15( | 6.01, | 60.36) | 18.09( | 2.74, | 37.48) | 72.0(57.2, 74.0) | 0.38( | 0.34, | 0.49) | 67 |
| A4 | 0.99 | 29.83( | 17.76, | 138.61) | 7.72( | 1.42, | 16.80) | 79.9(76.5, 84.7) | 0.85( | 0.81, | 0.91) | 69 |
| A8 | 0.99 | 63.22( | 54.15, | 100.27) | 3.75( | 2.45, | 4.45) | 53.4(50.2, 56.0) | 0.95( | 0.94, | 0.96) | 64 |
| B7 | 0.99 | 11.80( | 0.79, | 25.61) | 12.22( | 4.59, | 122.73) | 112.1(103.9, 114.7) | 0.50( | 0.17, | 0.59) | 70 |
| G7 | 0.98 | 29.18( | 20.45, | 69.51) | 6.63( | 2.68, | 10.14) | 108.6(100.3, 112.4) | 0.87( | 0.84, | 0.89) | 69 |
| D8 | 0.98 | 0.24( | 0.16, | 0.32) | 236.99( | 182.15, | 291.84) | 103.1(96.5, 109.6) | 0.21( | 0.17, | 0.26) | 2 |
| C2 | 0.98 | 1.03( | 1.03, | 1.03) | 239.41( | 239.41, | 239.41) | 58.7(58.7, 58.7) | 0.02( | 0.02, | 0.02) | 1 |
| E8 | 0.98 | 11.21( | 0.06, | 21.93) | 12.09( | 5.59, | 136.93) | 109.4(85.5, 111.4) | 0.57( | 0.32, | 0.65) | 74 |
| E9 | 0.98 | 0.37( | 0.32, | 0.41) | 225.98( | 169.32, | 282.65) | 94.6(86.6, 102.6) | 0.10( | 0.07, | 0.12) | 2 |
| B10 | 0.98 | 27.03( | 20.14, | 35.10) | 8.21( | 5.40, | 11.55) | 123.2(88.3, 126.9) | 0.86( | 0.79, | 0.88) | 67 |
| G8 | 0.98 | 24.73( | 19.32, | 39.42) | 8.29( | 4.90, | 11.16) | 104.4(100.9, 108.7) | 0.83( | 0.82, | 0.85) | 73 |
| H1 | 0.98 | 0.42( | 0.42, | 0.42) | 161.46( | 161.46, | 161.46) | 67.2(67.2, 67.2) | 0.06( | 0.06, | 0.06) | 1 |
| B3 | 0.98 | 31.61( | 9.09, | 184.03) | 3.43( | 0.28, | 41.46) | 21.4(12.3, 103.8) | 0.74( | 0.64, | 0.95) | 72 |
| E7 | 0.98 | 16.57( | 0.10, | 36.34) | 8.70( | 2.80, | 99.07) | 77.8(58.0, 79.5) | 0.71( | 0.23, | 0.77) | 60 |
| C6 | 0.98 | 11.94( | 7.83, | 46.07) | 19.15( | 4.23, | 32.07) | 73.7(59.4, 75.0) | 0.43( | 0.39, | 0.57) | 67 |
| G6 | 0.97 | 10.12( | 4.83, | 40.22) | 35.66( | 8.73, | 78.98) | 50.0(44.2, 50.9) | 0.27( | 0.23, | 0.36) | 61 |
| A1 | 0.97 | 0.52( | 0.49, | 0.55) | 185.83( | 175.48, | 196.17) | 35.2(33.9, 36.5) | 0.02( | 0.01, | 0.02) | 2 |
| C1 | 0.97 | 22.06( | 17.20, | 26.36) | 10.25( | 8.23, | 13.94) | 102.7(100.5, 106.9) | 0.82( | 0.81, | 0.84) | 63 |
| C3 | 0.97 | 26.52( | 5.23, | 146.63) | 5.74( | 0.65, | 56.30) | 58.7(28.5, 98.5) | 0.53( | 0.50, | 0.90) | 67 |
| D4 | 0.97 | 0.22( | 0.22, | 0.22) | 99.03( | 99.03, | 99.03) | 62.0(62.0, 62.0) | 0.46( | 0.46, | 0.46) | 1 |
| A10 | 0.97 | 18.22( | 0.07, | 27.10) | 10.54( | 6.72, | 161.42) | 125.4(107.1, 129.1) | 0.78( | 0.34, | 0.81) | 58 |
| D6 | 0.97 | 0.24( | 0.24, | 0.24) | 141.76( | 141.76, | 141.76) | 76.4(76.4, 76.4) | 0.29( | 0.29, | 0.29) | 1 |
| A9 | 0.97 | 19.12( | 15.55, | 23.73) | 11.54( | 8.79, | 14.53) | 108.7(105.4, 111.7) | 0.77( | 0.76, | 0.79) | 64 |
| E3 | 0.96 | 19.86( | 4.15, | 142.67) | 4.14( | 0.55, | 62.44) | 18.0(13.0, 52.4) | 0.41( | 0.37, | 0.95) | 63 |
| A7 | 0.96 | 33.83( | 26.12, | 46.43) | 7.55( | 3.29, | 10.08) | 109.5(77.8, 114.2) | 0.90( | 0.84, | 0.92) | 63 |
| B6 | 0.96 | 0.36( | 0.36, | 0.36) | 242.54( | 242.54, | 242.54) | 91.5(91.5, 91.5) | 0.17( | 0.17, | 0.17) | 1 |
| C7 | 0.96 | 12.01( | 0.05, | 24.19) | 12.58( | 5.60, | 129.86) | 102.7(100.4, 105.8) | 0.56( | 0.38, | 0.64) | 61 |
| A3 | 0.96 | 6.45( | 5.48, | 9.41) | 12.96( | 6.27, | 50.86) | 4.5(3.7, 14.4) | 0.68( | 0.59, | 0.98) | 33 |
| F9 | 0.96 | 2940.20( | 0.93, | 5879.46) | 2989.27( | 224.91, | 5753.62) | 60.5(12.4, 108.6) | 0.01( | 0.00, | 0.03) | 2 |
| G5 | 0.96 | 8.94( | 4.71, | 42.59) | 57.45( | 9.01, | 104.70) | 58.7(57.2, 60.5) | 0.25( | 0.21, | 0.32) | 54 |
| G4 | 0.95 | 4.01( | 3.26, | 7.22) | 23.97( | 13.74, | 47.06) | 29.7(27.4, 37.3) | 0.85( | 0.37, | 0.90) | 9 |
| C8 | 0.95 | 31.04( | 26.19, | 39.61) | 8.56( | 6.43, | 10.56) | 101.2(97.5, 105.9) | 0.89( | 0.88, | 0.91) | 72 |
| C4 | 0.95 | 9.87( | 6.29, | 38.40) | 22.58( | 4.89, | 44.10) | 107.2(102.7, 110.0) | 0.33( | 0.28, | 0.37) | 60 |
| E6 | 0.95 | 20.28( | 8.80, | 63.67) | 10.29( | 3.05, | 26.42) | 61.8(60.0, 63.9) | 0.48( | 0.46, | 0.56) | 57 |
| A6 | 0.95 | 0.30( | 0.30, | 0.30) | 151.26( | 151.26, | 151.26) | 87.8(87.8, 87.8) | 0.10( | 0.10, | 0.10) | 1 |
| B1 | 0.94 | 0.31( | 0.31, | 0.31) | 262.28( | 262.28, | 262.28) | 117.7(117.7, 117.7) | 0.21( | 0.21, | 0.21) | 1 |
| D1 | 0.94 | 15.51( | 12.83, | 33.30) | 12.15( | 5.20, | 15.68) | 106.9(100.4, 109.1) | 0.67( | 0.64, | 0.69) | 63 |
| D2 | 0.94 | 1.53( | 1.53, | 1.53) | 149.28( | 149.28, | 149.28) | 179.0(179.0, 179.0) | 0.23( | 0.23, | 0.23) | 1 |
| G2 | 0.93 | 0.28( | 0.28, | 0.28) | 211.16( | 211.16, | 211.16) | 117.4(117.4, 117.4) | 0.14( | 0.14, | 0.14) | 1 |
| H8 | 0.93 | 15.10( | 11.69, | 30.09) | 12.95( | 4.92, | 17.47) | 125.9(104.9, 131.0) | 0.66( | 0.63, | 0.68) | 61 |
| B5 | 0.93 | 9.25( | 7.08, | 17.32) | 9.10( | 4.40, | 12.62) | 118.3(116.2, 120.5) | 0.60( | 0.56, | 0.64) | 64 |
| D3 | 0.92 | 101.21( | 51.85, | 271.54) | 2.75( | 0.72, | 6.29) | 93.3(77.6, 177.0) | 0.95( | 0.93, | 1.00) | 68 |
| E10 | 0.92 | 14.90( | 5.58, | 47.86) | 5.10( | 1.45, | 16.73) | 166.6(162.6, 174.5) | 0.60( | 0.32, | 0.80) | 62 |
| F3 | 0.92 | 9.79( | 9.79, | 9.79) | 21.91( | 21.91, | 21.91) | 81.1(81.1, 81.1) | 0.99( | 0.99, | 0.99) | 1 |
| A5 | 0.91 | 12.11( | 0.92, | 32.91) | 19.23( | 6.15, | 132.59) | 118.1(81.0, 122.0) | 0.41( | 0.11, | 0.45) | 64 |
| F5 | 0.91 | 21.53( | 1.13, | 506.28) | 6.71( | 0.17, | 109.02) | 38.9(37.7, 40.8) | 0.01( | 0.00, | 0.94) | 14 |
| F4 | 0.91 | 43.56( | 2.44, | 302.28) | 1.89( | 0.24, | 121.65) | 133.4(103.2, 182.5) | 0.34( | 0.21, | 0.99) | 54 |
| C5 | 0.91 | 9.72( | 7.20, | 17.64) | 10.01( | 4.93, | 14.41) | 118.1(109.8, 120.2) | 0.61( | 0.56, | 0.64) | 68 |
| E5 | 0.9 | 29.55( | 21.58, | 73.46) | 5.98( | 2.16, | 8.32) | 102.5(99.7, 108.1) | 0.89( | 0.88, | 0.91) | 67 |
| D5 | 0.89 | 13.58( | 5.81, | 43.15) | 9.15( | 2.64, | 27.66) | 132.6(128.3, 136.6) | 0.37( | 0.31, | 0.44) | 74 |
| C9 | 0.89 | 16.46( | 13.45, | 29.62) | 12.33( | 4.39, | 15.92) | 136.2(81.0, 140.4) | 0.71( | 0.69, | 0.73) | 67 |
| D7 | 0.89 | 28.56( | 21.17, | 63.97) | 8.37( | 3.27, | 12.25) | 132.1(118.6, 138.4) | 0.86( | 0.83, | 0.88) | 71 |
| B9 | 0.89 | 100.42( | 69.04, | 131.81) | 15351.10( | 5883.95, | 24818.24) | 5.3(5.3, 5.3) | 0.02( | 0.02, | 0.03) | 2 |
| G1 | 0.89 | 12.14( | 10.13, | 22.58) | 12.30( | 6.01, | 15.78) | 106.1(96.5, 108.8) | 0.64( | 0.61, | 0.68) | 64 |
| G3 | 0.88 | 43.97( | 8.76, | 386.51) | 0.95( | 0.11, | 8.97) | 28.3(24.4, 32.5) | 0.91( | 0.84, | 1.00) | 47 |
| H5 | 0.84 | 16.80( | 7.26, | 88.31) | 5.12( | 0.88, | 14.84) | 157.9(154.4, 161.1) | 0.71( | 0.63, | 0.88) | 52 |
| F10 | 0.83 | 53.44( | 1.84, | 155.93) | 1.44( | 0.37, | 155.02) | 105.0(99.8, 123.7) | 0.25( | 0.11, | 0.97) | 54 |
| E2 | 0.81 | 8.43( | 4.99, | 21.08) | 49.62( | 20.23, | 89.02) | 31.1(30.7, 31.4) | 0.25( | 0.21, | 0.31) | 53 |
| F8 | 0.81 | 10.07( | 2.97, | 94.78) | 65.86( | 6.41, | 209.07) | 66.7(63.4, 74.4) | 0.08( | 0.06, | 0.14) | 52 |
| F2 | 0.8 | 0.34( | 0.24, | 4.59) | 79.42( | 67.51, | 85.62) | 107.3(105.5, 125.0) | 0.54( | 0.10, | 0.56) | 5 |
| A2 | 0.79 | 13.98( | 11.43, | 470151.08) | 13.18( | 7.02, | 9948.61) | 112.7(2.7, 115.4) | 0.66( | 0.00, | 0.68) | 64 |
| B2 | 0.79 | 10.82( | 8.67, | 14.96) | 11.59( | 7.90, | 14.99) | 127.5(123.9, 131.2) | 0.62( | 0.60, | 0.64) | 54 |
| H2 | 0.76 | 9.91( | 7.54, | 24.25) | 10.30( | 3.25, | 14.52) | 146.8(126.3, 150.0) | 0.59( | 0.55, | 0.64) | 62 |
| D9 | 0.74 | 99497.01( | 1.00, | 3974199.85) | 0.06( | 0.01, | 256286.15) | 2.0(2.0, 2.4) | 0.00( | 0.00, | 0.00) | 11 |
| F6 | 0.7 | 19.41( | 18.06, | 20.77) | 6.76( | 5.64, | 7.88) | 62.7(61.5, 63.9) | 0.99( | 0.99, | 0.99) | 2 |
| F7 | 0.5 | 8.01( | 0.07, | 18.17) | 3.33( | 1.24, | 34.62) | 108.5(107.0, 110.5) | 0.64( | 0.51, | 0.93) | 40 |

The apparent partition coefficient between cytosol and intracellular vesicles (Pₐₚ(ves)=k(ves)ᵢₙ/k(ves)ₒᵤₜ₋) and the apparent partition coefficient between extracellular medium and cytosol (Pₐₚ(cyto)=k(cyto)ᵢₙ(cyto)ₒᵤₜ) were inversely related to each other, across compounds representing a variety of chemical structures (FIG. 21B). With the exception of three outliers (compounds D9, F9, and B9), log Pₐₚ(ves) and log Pₐₚ(cyto) values followed an approximately linear relationship (FIG. 21B). The outliers are all pyridine derivatives (pKₐ=(in the range of) 6.0). The present invention is not limited to a particular mechanism. Indeed, an understanding of the mechanism is not necessary to practice the present invention. Nonetheless, the Pₐₚ(ves) and Pₐₚ(cyto) values reflect increased sequestration due to accumulation of pyridinium ions in the acidic endolysosomal compartment. Including all the compounds in the calculation of the correlation coefficient, the correlation is −0.56. Excluding the three outliers, the correlation is −0.91.

The present invention is not limited to a particular mechanism. Indeed, an understanding of the mechanism is not necessary to practice the present invention. Nonetheless, the global trend suggests that intracellular vesicles in which probe is sequestered possess transport properties paralleling those of the plasma membrane. Consequently, small molecules that favor partitioning into the extracellular medium tend to be the ones that are most avidly sequestered intracellularly, and vice versa. Topologically, the lumen of the intracellular vesicles corresponds to the outside of the cell, which explains why the correlation between Pₐₚ(ves) and Pₐₚ(cyto) is negative, if both share similar transport mechanisms.

The present invention is not limited to a particular mechanism. Indeed, an understanding of the mechanism is not necessary to practice the present invention. Nonetheless, these results also suggest that probe sequestration could play an important role in modulating cytosolic probe concentrations. The log Pₐₚ(cyto) is positive for most probes (FIG. 21B), meaning that most probes tend to accumulate in the cytosol relative to the extracellular medium. Yet, because the log Pₐₚ(ves) is also positive for most of the probes, molecules in the cytosol tend to become sequestered in intracellular vesicles. The present invention is not limited to a particular mechanism. Indeed, an understanding of the mechanism is not necessary to practice the present invention. Nonetheless, altogether, these results indicate that active transport mechanisms at the plasma membrane are not driving the net efflux of probes up a concentration gradient from the cytosol to the extracellular medium. Yet, probes do accumulate up a concentration gradient, inside cytoplasmic vesicles. The present invention is not limited to a particular mechanism. Indeed, an understanding of the mechanism is not necessary to practice the present invention. Nonetheless, probe concentration in cytoplasmic vesicles appears to be greater than probe concentration in the cytosol, suggesting that probe affinity for intracellular vesicles serve as a buffer for cytosolic probe concentrations.

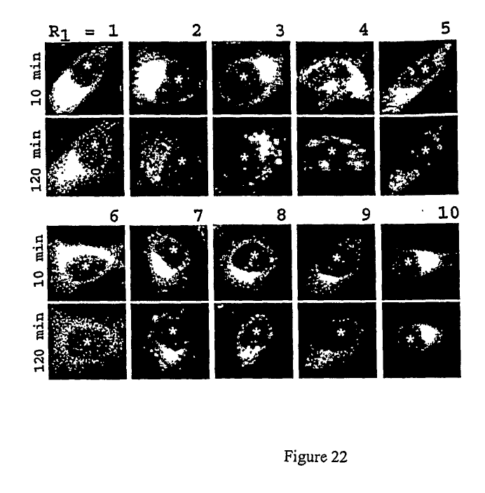

The present invention is not limited to a particular mechanism. Indeed, an understanding of the mechanism is not necessary to practice the present invention. Nonetheless, visual analysis of image data acquired under influx and steady state conditions confirms the extent of probe sequestration in cells (FIG. 22). Since the size of the fluorescent probes is well below the cutoff radius of the nuclear pores, the concentration of probe in the nuclear region can be regarded to be in equilibrium with the concentration of probe in the cytosol. In these images, less fluorescence can be observed in the nuclear relative to the cytoplasmic region, indicating that the majority of the molecules inside the cell are sequestered in association with cytoplasmic vesicles. Most probes reach steady state levels of probe sequestration as soon as 10 min after beginning of incubation (FIG. 22), consistent with measured values (see, e.g., Table 8). In more than half of the probes, the statistical imaging link function that at least 50% of all pixels in the perinuclear region of the images correspond to sites of probe sequestration (Table 8), consistent with visual inspection of the images. For probes with high Pₐₚ(ves) and low Pₐₚ(cyto) (for example, probes possessing the R₁=3 group; FIG. 21B) this indicates that most probe in the perinuclear region is actually sequestered. Confocal microscopy images of cells labeled with selected R₁=3 probes were consistent with these observations.

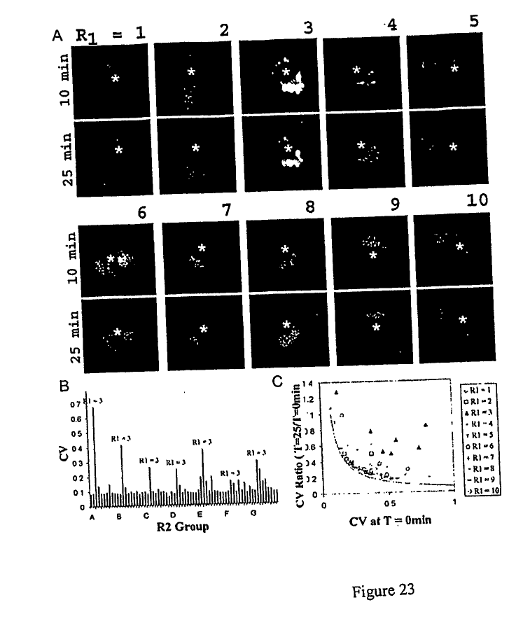

If probe is removed from the extracellular medium, there is a rapid efflux of probe from cells, down their concentration gradient (FIG. 23). In the set of tested compounds, only probes containing R₁=3 showed significant retention in cytoplasmic vesicles. The present invention is not limited to a particular mechanism. Indeed, an understanding of the mechanism is not necessary to practice the present invention. Nonetheless, since the R₁=3 group is the most hydrophobic, this result suggests that hydrophobicity exerts a significant influence on the partitioning of probes between the cytosol and cytoplasmic vesicles. Fixed endpoint analysis indicates that probes possessing the R₁=3 group are retained in intracellular vesicles (FIGS. 23B and 23C). Cells treated with probes containing R₁=3 exhibited CV values that were higher than other R₁ groups 25 min after probe removal from the extracellular medium, regardless of which R₂ group was present (FIG. 23B and Table 9), and independently of the starting amount of sequestered probe (FIG. 23C).

Table 9 presents a student t-test comparing the CV values of different R1 groups, 25 min. after removal of probe from extracellular medium. Note that probes derivatized with the R1=3 group shows significantly greater retention than all the other functional groups represented in the library.

TABLE 9

| | | | Cyto | | | | | | | | | |
|---|---|---|---|---|---|---|---|---|---|---|---|---|
| | | St. | Intensity p- | | | | | | | | | |
| R1 | Avg. | Dev. | 1 | 2 | 3 | 4 | 5 | 6 | 7 | 8 | 9 | 10 |
| 1 | 0.13 | 0.09 | | 0.83 | 7.2E−12* | 0.00 | 0.93 | 0.02 | 0.31 | 0.09 | 0.49 | 0.81 |
| 2 | 0.12 | 0.07 | 0.83 | | 3.3E−12* | 0.00 | 0.74 | 0.01 | 0.21 | 0.06 | 0.59 | 0.66 |
| 3 | 0.40 | 0.20 | 7.2E−12* | 3.3E−12* | | 7.0E−07* | 7.0E−12* | 2.0E−08* | 8.4E−10* | 2.8E−08* | 1.3E−12* | 3.8E−11* |
| 4 | 0.21 | 0.13 | 0.00 | 0.00 | 7.0E−07* | | 0.00 | 0.33 | 0.05 | 0.24 | 0.00 | 0.01 |
| 5 | 0.13 | 0.08 | 0.93 | 0.74 | 7.0E−12* | 0.00 | | 0.02 | 0.32 | 0.10 | 0.41 | 0.86 |
| 6 | 0.18 | 0.13 | 0.02 | 0.01 | 2.0E−08* | 0.33 | 0.02 | | 0.28 | 0.76 | 0.00 | 0.06 |
| 7 | 0.15 | 0.13 | 0.31 | 0.21 | 8.4E−10* | 0.05 | 0.32 | 0.28 | | 0.50 | 0.11 | 0.47 |
| 8 | 0.17 | 0.16 | 0.09 | 0.06 | 2.8E−08* | 0.24 | 0.10 | 0.76 | 0.50 | | 0.03 | 0.17 |
| 9 | 0.12 | 0.08 | 0.49 | 0.59 | 1.3E−12* | 0.00 | 0.41 | 0.00 | 0.11 | 0.03 | | 0.40 |
| 10 | 0.13 | 0.11 | 0.81 | 0.66 | 3.8E−11* | 0.01 | 0.86 | 0.06 | 0.47 | 0.17 | 0.40 | |

*statistically significant

The present invention is not limited to a particular mechanism. Indeed, an understanding of the mechanism is not necessary to practice the present invention. Nonetheless, irrespective of the actual transport mechanisms driving probe sequestration into intracellular vesicles, the results of the present invention question the extent to which the permeability of cells to drugs can be simply equated with plasma membrane permeability. Altogether, the partitioning of probes from the extracellular medium to the cytosol, and from cytosol to intracellular vesicles indicates that treating cells as a single-compartment system could lead to misinterpretations. Indeed, the cytoplasm is generally rich in endocytic or exocytic vesicles involved in plasma membrane recycling. Previous reports of active transporter molecules present in association with the membrane of cytoplasmic vesicles suggest that transport properties of intracellular vesicles and plasma membrane may be related (see, e.g., A. Rajagopal, S. M. Simon., Molecular Biology of the Cell 14, 3389 (2003); herein incorporated by reference in its entirety). The present invention is not limited to a particular mechanism. Indeed, an understanding of the mechanism is not necessary to practice the present invention. Nonetheless, recycling and fusion of intracellular vesicles with the plasma membrane could lead to exocytic recycling of sequestered molecules back to the extracellular medium, which could limit transcellular transport irrespective of the plasma membrane's permeability.

The present invention is not limited to a particular mechanism. Indeed, an understanding of the mechanism is not necessary to practice the present invention. Nonetheless, the ability parameterize the behavior of fluorescent probes in terms of kinetic and imaging variables enables a more detailed analysis of small molecule transport pathways in living cells. Using combinatorial libraries of fluorescently-tagged molecules (see, e.g., A. Rajagopal, S. M. Simon., Molecular Biology of the Cell 14, 3389 (2003); S. M. Khersonsky et al., Journal of the American Chemical Society 125, 11804 (2003); H. S. Moon et al., Journal of the American Chemical Society 124, 11608 (2002); each herein incorporated by reference in their entireties) permits analysis of the systems dynamics of subcellular transport, in relation to chemical structure and physicochemical properties. The present invention is not limited to a particular mechanism. Indeed, an understanding of the mechanism is not necessary to practice the present invention. Nonetheless, the systems approach is applicable for studying intracellular transport phenomena. The ability to calculate kinetic variables determining transport properties from image data ultimately allows detailed analysis of small molecule transport pathways, and their relationship to the expression and localization of transporter proteins at the plasma membrane and at the membrane of internal organelles. The present invention is not limited to a particular mechanism. Indeed, an understanding of the mechanism is not necessary to practice the present invention. Nonetheless, the present invention permits studying the effects of chemical structure on subcellular sequestration and transport, and increase the understanding and ability to model and predict the absorption, distribution, metabolism and excretion of small molecule drugs (see, e.g., M. Rowland, T. N. Tozer., Clinical Pharmacokinetics Concepts and Applications (Lippincott Williams & Wilkins, Philadelphia, P.A., 1995); herein incorporated by reference in its entirety) in the living organism. In cancer cells, for example, the present invention permits understanding of the accumulation of small molecules in tumor cells, targeted cytotoxicity and drug resistance (see, e.g., S. Davis, M. J. Weiss, S. R. Wong, T. J. Lampidis and L. B. Chen., Journal of Biological Chemistry 260, 13844 (1985); R. K. Jain., Journal of Controlled Release 74, 7 (2001); G. D. Leonard, T. Fojo and S. E. Bates., Oncologist 8, 411 (2003); each herein incorporated by reference in their entireties) and its potential relationship with membrane trafficking pathways involved in plasma membrane recycling and turnover (see, e.g., A. K. Larsen, A. E. Escargueil and A. Skladanowski., Pharmacology & Therapeutics 85, 217 (2000); herein incorporated by reference in its entirety).

### Example 9

Tagged NBD Library Synthesis. Procedure for Building Block I Synthesis (Scheme 2(b)). 8 amines (R₂=A-H) (0.44 mmole, 5 eq.) were added to a suspension of PALaldehyde resin (80 mg, 0.088 mmole) in anhydrous tetrahydrofuran (THF) (5 mL containing 2% of acetic acid) at room temperature. The reaction mixture was shaken for 1 hr at room temperature followed by addition of sodium triacetoxyborohydride (131 mg, 7 eq.). The reaction mixture was stirred for 12 hr and filtered. The resin was washed with DMF (5 times), alternatively with dichloromethane and methanol (5 times), and finally dichloromethane (5 times). The resin was dried in vacuum. %

Procedure for Synthesis of NBD Linker (Scheme 2(a)). To a solution of 1,6-hexanediamine (2.3 g, 20 mmol, 2 equiv.) in methanol (150 mL) cooled down to 0° C. and purged with nitrogen gas, was added a solution of 4-Chloro-7-nitrobenzofurazan (NBD chloride) (2 g, 10 mmol) in 100 mL of methanol dropwise over the period of 3 hours. The solution was allowed to stir for an additional hour and then the solvent was removed in vacuo. The product, 1, was purified by column chromatography (5:1 dichloromethane:methanol) to result in a yellow oil (1.9 g, 68% yield). The identity and purity of the final product was confirmed by LC-MS at 250 nm (Agilent 1100 model). ESIMS: (M+H)+ Calcd, 280.1; Found, 280.1.

Procedure for Building Block II Synthesis. NBD linker, 1, (1.7 g, 1.2 eq.) was added to a solution of cyanuric chloride (1 g, 5 mmole) in THF (20 mL) and N,N-diisopropylethylamine (DIEA) (4.7 mL, 5 eq.) at 0° C. The reaction mixture was stirred for 30 min at 0° C. After monitoring the reaction progress by TLC, the reaction mixture was filtered through a silica plug and solvent was removed in vacuo. The reaction mixture was purified by column chromatography (1:1 ethyl acetate:hexanes) to result in a yellow oil (1.1 g, 48% yield) Its purity and identity was confirmed by LC-MS at 250 nm (>99% purity). ESIMS: (M+H)+ Calcd, 426.1; Found, 426.1.

General Procedure for Coupling Building Block I and Building Block II. Building Block II (0.26 mmole) was added to a solution of Building Block I (0.088 mmole) in DEA (1 mL) and anhydrous THF (3 mL). The reaction mixture was heated to 60° C. for 3 hr and filtered. The resin was washed with DMF (5 times), alternatively with dichloromethane and methanol (5 times), and finally dichloromethane (5 times). The resin was dried in vacuum.

General Procedure for the Final Amination on the Resin and Product Cleavage Reaction. 10 Amines (R₁=1-10) (4 eq.) were added to the resin (each 10 mg), coupled with Building Block I and Building Block II, in DIEA (8 μL) and 1 mL of N-methyl-2-pyrrolidone (NMP). The reaction mixture was heated to 120° C. for 3 hr. The resins were washed with DMF (5 times), alternatively with dichloromethane and methanol (5 times), and finally dichloromethane (5 times). The resins were dried in vacuum. The product cleavage reaction was performed using 5% TFA in dichloromethane (1 mL) for 30 min at room temperature and washed with dichloromethane (0.5 mL). The products were characterized by LC-MS at 250 nm (Agilent 1100 model).

Cell culture. HeLa cells were grown in RPMI+10% FCS in a 5% CO₂ atmosphere at 37° C. and plated in 96-well plates at a density of 3000 cells/well 24 hours prior to the start of the experiment.

Kinetic Imaging. For influx experiments, cells on 96-well plates were switched to imaging media consisting of RPMI containing 1.0 mM Bromophenol Blue—a soluble, cell-impermeant chromophore used to suppress excitation and emission of extracellular (background) dye fluorescence-, 10 μM probe and 0.1 μM Hoescht 33258 to label the cell nuclei. Plates were then transferred to a KineticScan instrument (Cellomics, Inc., Pittsburgh, Pa.), which contains an environmentally controlled CO₂/temperature/humidity chamber, and data was acquired with a 20× objective lens. Images acquisition began approximately 10 min after dye addition, using the Hoescht channel to acquire nuclear images and FITC channel to acquire the NBD image. Plate-scanning mode was used for scanning, in which the instrument builds time-stacks of images by scanning the plate multiple times, returning to the same site of the plate at every scan. For efflux experiments, dye-containing media was removed from the wells of the plate. The wells were washed twice with fresh RPMI medium, imaging media was added, and image acquisition restarted 7 min after the dye-containing media was removed. The last time points of the influx experiment served as the first time point of the efflux experiment. Plates were scanned for approximately two hours in the influx experiment and six hours for the efflux experiment, with each well imaged on average every 7 minutes. Negative controls included unlabeled cells, yielding no data on either channel or Hoescht-only labeled cells yielding no data on the FITC channel. In addition, it was confirmed that photobleaching exerted a minimal effect (<<1%) change on fluorescent intensity, determined by exposing the cells with the same amount of light they were exposed for the entire duration of the experiment.

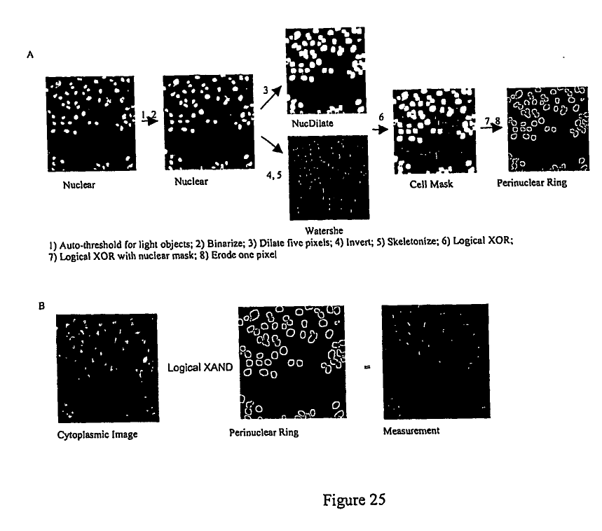

Image analysis. Image data was analyzed off-line, using Metamorph image analysis software (Molecular Devices, Inc). The entire image dataset was visually inspected for artifacts that would lead to changes in CV independent of probes sequestration, such as cell rounding, autofocus errors, lack of image register, lack of cells in image, instrument malfunction or some other experimental artifact. Approximately 20-40 cells were analyzed in each image. Because of instrument error at the edges of the plate, data was not successfully acquired for probes C10, D10, E10, G10, H4, H7, H9, and H10. An image analysis algorithm was programmed, so as to automatically analyze the intensity distribution of pixels in a perinuclear ring region of each cell in an image (FIG. 25). For this purpose, nuclear images were binarized and used to generate a perinuclear ring binary mask (FIG. 25A)) that was then utilized to determine the coefficient of variation (CV) of the FITC channel (NBD) image (FIG. 25B). The CV is the ratio of the standard deviation of the image intensity divided by the average intensity and effectively represents the heterogeneity of intracellular probe distribution, as visually determined by a naïve observer. To create the perinuclear ring masks, the nuclear image obtained through the Hoescht channel was auto-thresholded for light objects (see, e.g., J. F. Pritchard et al., Nature Reviews Drug Discovery 2, 542 (2003); herein incorporated by reference in its entirety; see also, e.g., FIG. 25A) and then binarized (see, e.g., D. Sun et al., Current Opinion in Drug Discovery and Development 7, 75 (2004); herein incorporated by reference in its entirety); see also, e.g., FIG. 25A) to create a nuclear mask. The nuclear mask was dilated five pixels to create a NucDilate mask (see, e.g., S. M. Simon, M. Schindler., Proceedings of the National Academy of Sciences of the United States of America 91, 3497 (1994); herein incorporated by reference in its entirety; see also, e.g., FIG. 25A). Independently, the nuclear mask was also inverted and skeletonized (see, e.g., M. M. Gottesman, T. Fojo and S. E. Bates., Nature Reviews Cancer 2,48 (2002); A. H. Schinkel, J. W. Jonker., Advanced Drug Delivery Reviews 55, 3 (2003); each herein incorporated by reference in their entireties; see also, e.g., FIG. 25A) to create a watershed image. Next, the dilated and inverted/skeletonized images were combined using the Logical XOR function yielding a cell mask (see, e.g., S. Meschini et al., International Journal of Cancer 87, 615 (2000); herein incorporated by reference in its entirety; see also, e.g., FIG. 25A). This cell mask was combined with the nuclear binary using the XOR function to create the perinuclear ring mask (see, e.g., S. J. Royle, R. D. Murrell-Lagnado., Bioessays 25, 39 (2003); herein incorporated by reference in its entirety; see also, e.g., FIG. 25A). The ring mask image was then eroded one pixel to remove the skeletons (see, e.g., S.D. Conner, S. L. Schmid., Nature 422, 37 (2002); herein incorporated by reference in its entirety; see also, e.g., FIG. 25A). Lastly, the cytoplasmic images obtained through the FITC channel were combined with the ring mask image using the Logical XAND function to create perinuclear ring mask images (FIG. 25B). The perinuclear ring mask images were then auto-thresholded for light objects, and the average intensity and standard deviation of each image in its entirety was used to calculate the CV.

Mathematical modeling. A 4-parameter compartmental model was specified for the underlying vesicular and cytoplasmic probe concentrations. This model specified three nested compartments linked by first order kinetics. The “medium” compartment is linked to the “cytoplasm” compartment via first order rate constants k(cyto)ᵢₙ and k(cyto)ₒᵤₜ, and the “cytoplasm” compartment is linked to the “vesicle” compartment via first order rate constants k(ves)ᵢₙ and k(ves)ₒᵤₜ. Probe concentration in the medium was fixed at 1 unit during influx and 0 units during efflux. For initial conditions, probe concentrations at time zero in both cytoplasm and vesicles were fixed at zero units, and concentration trajectories were constrained to be continuous over the boundary between influx and efflux conditions. For specified values of the four kinetic parameters k(cyto)ᵢₙ, k(cyto)ₒᵤₜ, k(ves)ᵢₙ, and k(ves)ₒᵤₜ, and for the initial conditions stated above, probe concentrations of an ideal probe in cytoplasm and vesicles are uniquely determined as a sum of exponential curves, which can be numerically calculated using standard methods for solving systems of ordinary differential equations. V(t;K) and C(t;K) are written to denote the solutions for vesicular and cytoplasmic concentrations at time t, where K is the four-dimensional vector of kinetic parameters.

Statistical analysis of kinetic data. Coefficient of variation (CV) trajectories from image data were analyzed in the context of the compartmental model described above. Since the compartmental concentrations are not measured directly, but rather the image CV are observed, it is also necessary to model the link between CV and compartmental concentrations. To develop this link a statistical model was considered in which fraction p of the perinuclear image pixels were in vesicles and fraction 1-p were not in vesicles. The present invention is not limited to a particular mechanism. Indeed, an understanding of the mechanism is not necessary to practice the present invention. Nonetheless, it is supposed that vesicle pixels had intensity proportional to V(t;K), and non-vesicle pixels had intensity proportional to C(t;k), as defined above. Further, it was supposed that the image was subject to independent Poisson noise at intensity ë. Under these assumptions, the standard deviation of the pixels is proportional to ((V(t;K)−C(t;K))₂p(1−p)+ë)_{1/2} and the mean of the pixels is proportional to pV(t;K)+(1−p)C(t;K)+ë. Thus the ideal coefficient of variation is CV_{mod}(t;K,p,ë)=((V(t;K)−C(t;K))₂p(1−p)+ë)_{1/2}/(pV(t;K)+(1−p)C(t;K)+ë), where the unknown constants of proportionality cancel in the ratio.

Experimental CV data were fit to the six parameter model (four kinetic parameters and the “system parameters” p and ë) based on the least squares principal. That is, the function Óₜ(CV_{obs}(t)−CV_{mod}(t;K,p,ë))₂ was minimized with respect to K, p, and ë for each probe. Optimization was carried out using simulated annealing (Pincus, 1970). Solutions in which cytoplasmic concentration exceeds vesicular concentration at the steady state were discarded and a new solution was generated.

Estimation of Probe Permeability and Assessment of Estimation Precision. Because of the mathematical function linking actual probe concentrations with the fluorescence intensity apparent in the images, the optimization process generally yielded several different kinetic solutions of similarly good fit to the data. To summarize variation in kinetic parameter estimates across the good solutions, the optimizer was ran 100 times for each probe. Focusing on the best fits, the solutions were selected that were within 5% of the best fit (Table 8). Within this selected set the logk(ves)ᵢₙ/k(ves)ₒᵤₜ and log k(cyto)ᵢₙ/k(cyto)ₒᵤₜ was plotted for each probe, and compared to the average trend observed for all the probes. Examining all the optimal solutions for each individual probe, the majority cluster around the optimal solution in each graph.

Most importantly, all possible solutions for any single probe closely follow the global trend observed across all the probes. Thus, the values of Pₐₚ(ves) and Pₐₚ(cyto) are robust estimates, and the overall relationship between Pₐₚ(ves) and Pₐₚ(cyto) is consistently supported by the data. The curve fits and observed relationship between Pₐₚ(ves) and Pₐₚ(cyto) were confirmed in an independent experiment.

All publications and patents mentioned in the above specification are herein incorporated by reference in their entireties. Various modifications and variations of the described compositions and methods of the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

1. A method of determining the contribution of chemical groups in a library of chemical agents to determine the subcellular distribution of said chemical agents, comprising:
a. providing a library of chemical agents said library comprising a first class of chemical moieties and a second class of chemical moieties;
b. contacting said library to cells under conditions such that said chemical agents of said library localize in said cells;
c. determining the localization of said chemical agents in said cells to generate localization data;
d. performing additive decomposition on the determined localization data to generate predictor values for each moiety in said first and said second classes of chemical moieties;
e. using said predictor values for said first and second class of chemical moieties to predict the contribution of said chemical moieties to the subcellular distribution of said chemical agents.

2. The method of claim 1, wherein step (c) comprises determining a relative contribution value for each chemical moiety in said first class of chemical moieties, and of each chemical moiety in said second class of chemical moieties.

3-127. (canceled)

128. The method of claim 2, wherein said determining comprises using said relative contribution values to predict the subcellular distribution of said chemical agents containing any of said chemical moieties in said first class of chemical moieties, and said chemical moieties in said second class of chemical moieties.

129. The method of claim 1, wherein said chemical agents of said library localize in one or more organelles of said cells.

130. The method of claim 1, wherein said first class of chemical moieties comprises lipophilic pyridinium or quinolinium cation molecule cationic molecules, and wherein said second class of chemical moieties comprises an aromatic molecule.

131. The method of claim 1, wherein said cells comprise human cells.

132. The method of claim 1, wherein said chemical agents are therapeutic.

133. The method of claim 1, wherein said organelles are selected from the group consisting of mitochondria, peroxisomes, golgi bodies, nuclei, nucleoli, endosomes, lysosomes, exosomes, secretory vesicles, endoplasmic reticulum, phagosomes, plasma membrane, nuclear envelope components, inner mitochondrial matrix components, inner mitochondrial membrane components, intermembrane spaces, outer mitochondrial membrane, microfilaments, microstubules, intermediate filaments, filopodia, ruffles, lamellipodia, sarcomeres, focal contacts, and podosomes.

134. The method of claim 1, wherein said library of chemical agents comprises a combinatorial library.

135. A composition comprising a chemical agent comprising a first chemical moiety connected by a linking group to a second chemical moiety, wherein said first chemical moiety is selected from the group consisting of A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, A36, A37, A38, A39, A40, and A41; wherein said second chemical moiety is selected from the group consisting of B1, B2, B3, B4, B5, B6, B7, B8, B9, B10, B11, B12, B13, and B14.

136. The composition of claim 135, wherein said linking group comprises a carbon polymethine bridge.

137. The composition of claim 135, wherein said chemical agent is linked to therapeutic molecule.

138. The composition of claim 135, wherein said chemical agent is selected from the group consisting of: A3-B9, A3-B8, A3-B10, A7-B7, A8-B7, A9-B8, A9-B10, A9-B11, A9-B7, A11-B2, A22-B2, A30-B9, A31-B9, A31-B8, A31-B10, A31-B2, A31-B7, A32-B9, A32-B8, A32-B10, A32-B1, A32-B2, A32-B11, A32-B13, A32-B12, A32-B7, A33-B9, A33-B8, A33-B10, A33-B1, A33-B11, A33-B13, A33-B12, A33-B7, A36-B2, A10-B8, A10-B10, A10-B11, A10-B12, A21-B8, A21-B7, A18-B8, A18-B7, A39-B10, A39-B2, A39-B11, A39-B13, A19-B10, A19-B1, A19-B2, A19-B11, A19-B5, A19-B13, A19-B12, A19-B7, A19-B3, A1-B9, A1-B8, A1-B10, A27-B8, A27-B2, A27-B11, A27-B13, A27-B7, A15-B8, A37-B14, A37-B2, A37-B5, A37-B4, A14-B1, A14-B11, A14-B13, A14-B12, A14-B7, A38-B10, A38-B2, A24-B2, A24-B11, A24-B7, A35-B12, A16-B2, A20-B7, A12-B1, A12-B7, A12-B3, and A23-B1, and wherein said chemical agent induces mitochondrial localization of said composition.

139. The composition of claim 135, wherein said chemical agent is selected from the group consisting of A1-B1, A23-B1, A27-B1, A32-B1, A1-B2, A23-B2, A24-B2, A33-B2, A23-B3, A23-B4, A23-B5, A33-B7, A38-B7, A24-B8, A33-B8, A39-B8, A10-B9, A31-B9, A35-B9, A37-B9, A38-B9, A35-B10, A23-B11, A23-B12, A23-B13, A24-B14, and wherein said chemical agent induces cytoplasmic localization of said composition.

140. The composition of claim 135, wherein said chemical agent is selected from the group consisting of A19-B1, A37-B5, A12-B7, A31-B7, A16-B8, A17-B8, A18-B8, A19-B8, A20-B8, A21-B8, A23-B8, A32-B8, A16-B9, A18-B9, A19-B9, A20-B9, A21-B9, A27-B9, A28-B9, A32-B9, A19-B14, A20-B14, A37-B14, and wherein said chemical agent induces nucleoli localization of said composition.

141. The composition of claim 135, wherein said chemical agent is selected from the group consisting of A32-B1, A33-B2, A12-B5, A24-B6, A23-B7, A38-B7, A12-B8, A14-B8, A17-B8, A23-B8, A10-B9, A12-B9, A14-B9, A17-B9, A21-B9, A33-B9, A12-B10, A15-B10, A16-B10, A20-B10, A37-B11, and wherein said chemical agent induces vesicular uptake of said composition.

142. The composition of claim 135, wherein said chemical agent is selected from the group consisting of A12-B2, A14-B2, A19-B2, A27-B2, A12-B5, A37-B10, A12-B11, A17-B11, A12-B12, A14-B12, A17-B12, A12-B13, A17-B13, and wherein said chemical agent induces endoplasmic reticulum localization of said composition.

143. The composition of claim 135, wherein said chemical agent is selected from the group consisting of A38-B2, A38-B7, A28-B8, A31-B8, A33-B8, A31-B9, A32-B9, A33-B9, wherein said chemical agent induces nuclear localization of said composition.
